(19) United States
(12) Patent Application Publication
(10) Pub. No.: US 2023/0097281 A1
(43) Pub. Date: Mar. 30, 2023

(54) ELECTROPHOTOGRAPHIC PHOTOSENSITIVE MEMBER, PROCESS CARTRIDGE, AND IMAGE FORMING APPARATUS

(71) Applicant: KYOCERA Document Solutions Inc., Osaka (JP)

(72) Inventors: Junichiro OTSUBO, Osaka-shi (JP); Kazunari HAMASAKI, Osaka-shi (JP); Katsuya TAKANO, Osaka-shi (JP); Kazuaki EZURE, Osaka-shi (JP)

(73) Assignee: KYOCERA Document Solutions Inc., Osaka (JP)

(21) Appl. No.: 17/815,537

(22) Filed: Jul. 27, 2022

(30) Foreign Application Priority Data
Jul. 29, 2021 (JP) 2021-124644

(51) Int. Cl. G03G 5/05; G03G 15/00

(52) U.S. Cl. CPC G03G 5/056; G03G 5/0564; G03G 15/75

(57) ABSTRACT

An electrophotographic photosensitive member includes a conductive substrate and an at-least-one-layer photosensitive layer including a specific photosensitive layer. The specific photosensitive layer contains a charge generating material, a binder resin, an electron transport material, and a hole transport material. The binder resin includes a polyarylate resin. The polyarylate resin includes repeating units (1), (2), (3), and (4).

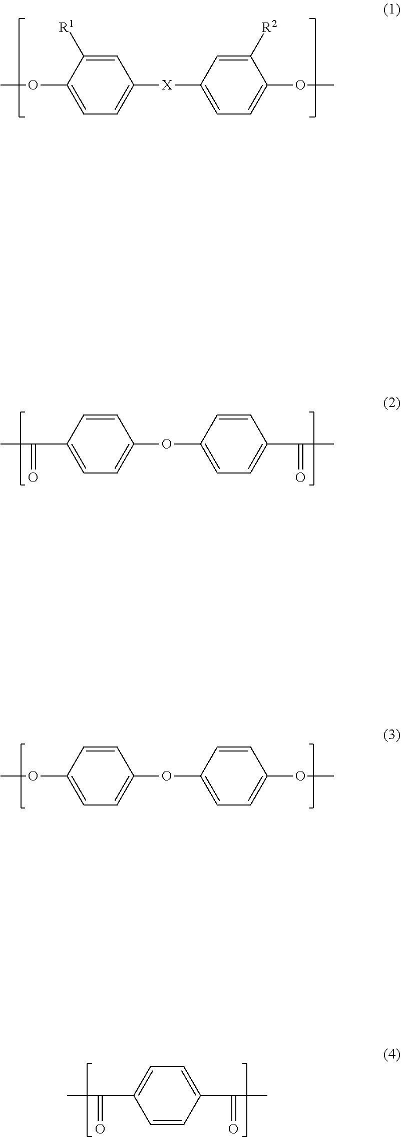

A percentage of the number of repeats of the repeating unit (3) relative to a total number of repeats of the repeating units (1) and (3) is greater than 0% and less than 50%. A percentage of the number of repeats of the repeating unit (4) relative to a total number of repeats of the repeating units (2) and (4) is at least 35% and less than 70%. The electron transport material includes a compound represented by formula (11), (12), (13), (14), (15), (16), or (17):

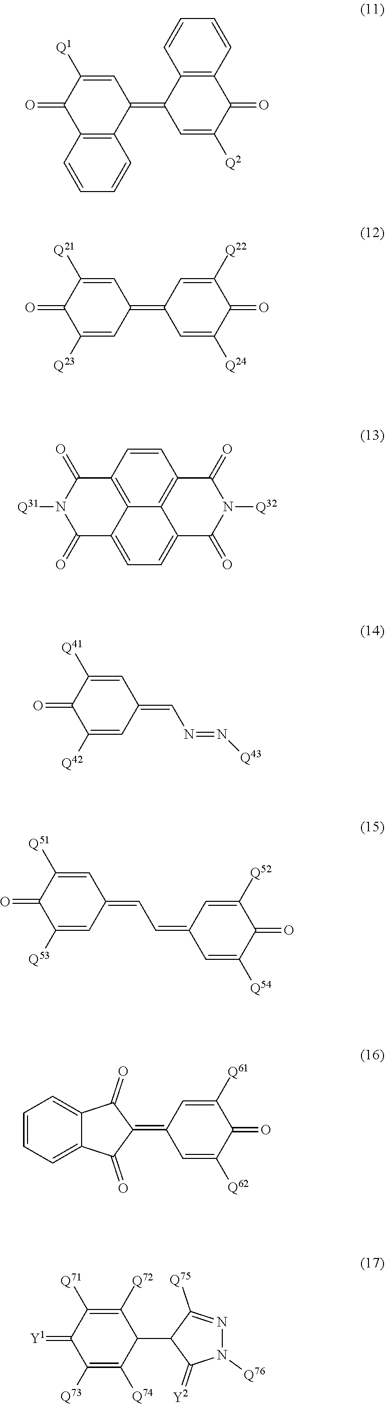

### INCORPORATION BY REFERENCE

The present application claims priority under 35 U.S.C. § 119 to Japanese Patent Application No. 2021-124644, filed on Jul. 29, 2021. The contents of this application are incorporated herein by reference in their entirety.

### BACKGROUND

The present disclosure relates to an electrophotographic photosensitive member, a process cartridge, and an image forming apparatus.

An electrophotographic image forming apparatus (e.g., a printer or a multifunction peripheral) includes an electrophotographic photosensitive member as an image bearing member. The electrophotographic photosensitive member includes a photosensitive layer. Examples of the electrophotographic photosensitive member includes a single-layer electrophotographic photosensitive member and a multi-layer electrophotographic photosensitive member. The single-layer electrophotographic photosensitive member includes a single-layer photosensitive layer having a charge generating function and a charge transporting function. The multi-layer electrophotographic photosensitive member includes a photosensitive layer including a charge generating layer having a charge generating function and a charge transport layer having a charge transporting function.

For example, an electrophotographic photosensitive member is known that includes a surface layer containing a polyarylate resin which is obtained from a divalent phenol component and a divalent carboxylic acid component represented by the following formula.

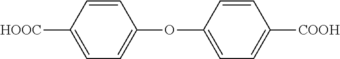 [SMILES: O=C(O)c1ccc(Oc2ccc(C(=O)O)cc2)cc1]

### SUMMARY

An electrophotographic photosensitive member according to an aspect of the present disclosure includes a conductive substrate and an at-least-one-layer photosensitive layer. The at-least-one-layer photosensitive layer includes a specific photosensitive layer. The specific photosensitive layer is disposed on an outermost side of the at-least-one-layer photosensitive layer. The specific photosensitive layer contains a charge generating material, a binder resin, an electron transport material, and a hole transport material. The binder resin includes a polyarylate resin. The polyarylate resin includes repeating units represented by formulas (1), (2), (3), and (4). A third percentage is greater than 0% and less than 50%. The third percentage is a percentage of the number of repeats of the repeating unit represented by the formula (3) relative to a total of the number of repeats of the repeating unit represented by the formula (1) and the number of repeats of the repeating unit represented by the formula (3). A fourth percentage is at least 35% and less than 70%. The fourth percentage is a percentage of the number of repeats of the repeating unit represented by the formula (4) relative to a total of the number of repeats of the repeating unit represented by the formula (2) and the number of repeats of the repeating unit represented by the formula (4). The electron transport material includes a compound represented by formula (11), (12), (13), (14), (15), (16), or (17).

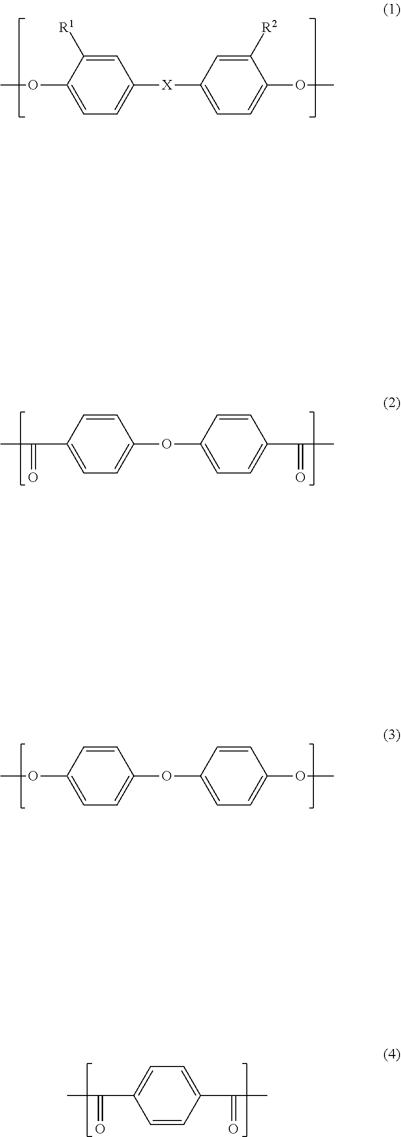

In the formula (1), R¹ and R² each represent a methyl group and X represents a divalent group represented by formula (X1). Alternatively, R¹ and R² each represent a hydrogen atom and X represents a divalent group represented by formula (X2).

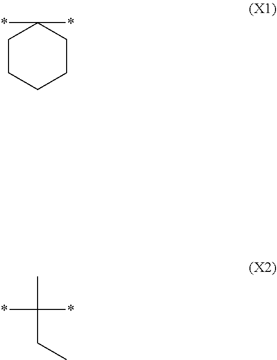

In the formulas (X1) and (X2). * represents a bond.

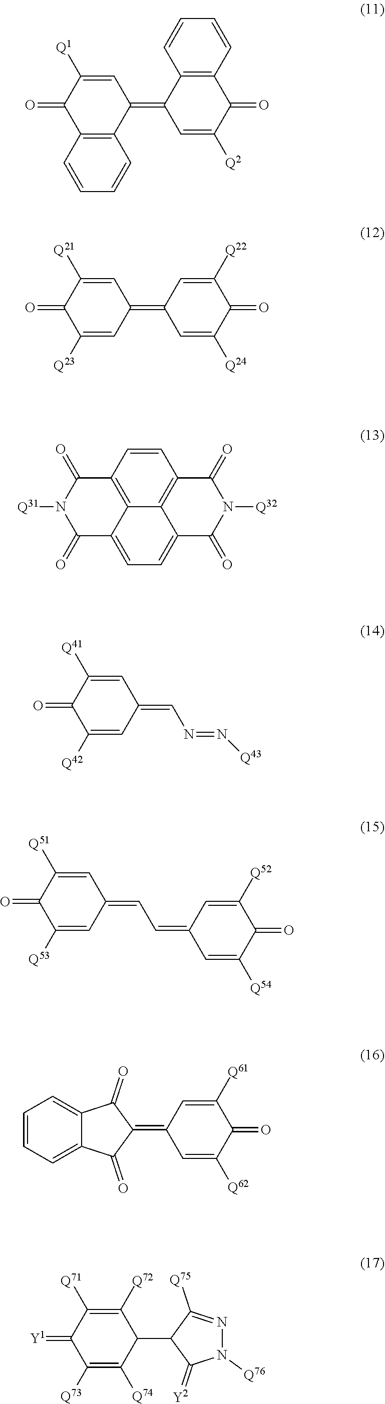

Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁵¹, Q⁵², Q⁵³, and Q⁵⁴ in the formula (15), Q⁶¹ and Q⁶² in the formula (16), and Q⁷¹, Q⁷², Q⁷³, Q⁷⁴, Q⁷⁵, and Q⁷⁶ in the formula (17) each represent, independently of one another, a hydrogen atom, a halogen atom, a cyano group, an alkyl group with a carbon number of at least 1 and no greater than 6, an alkenyl group with a carbon number of at least 2 and no greater than 6, an alkoxy group with a carbon number of at least 1 and no greater than 6, or an aryl group with a carbon number of at least 6 and no greater than 14 optionally substituted with at least one substituent selected from the group consisting of a halogen atom and an alkyl group with a carbon number of at least 1 and no greater than 6. In the formula (17), Y¹ and Y² each represent, independently of one another, an oxygen atom or a sulfur atom.

A process cartridge according to another aspect of the present disclosure includes the above-described electrophotographic photosensitive member and at least one selected from the group consisting of a charger, a light exposure device, a development device, and a transfer device.

An image forming apparatus according to still another aspect of the present disclosure includes an image bearing member, a charger that charges a surface of the image bearing member to a positive polarity, a light exposure device that exposes the charged surface of the image bearing member to light to form an electrostatic latent image on the surface of the image bearing member, a development device that develops the electrostatic latent image into a toner image by supplying toner to the surface of the image bearing member, and a transfer device that transfers the toner image from the image bearing member to a transfer target. The image bearing member is the electrophotographic photosensitive member described above.

### BRIEF DESCRIPTION OF THE DRAWINGS

FIG. 1 is a partial cross-sectional view of a single-layer electrophotographic photosensitive member that is an example of an electrophotographic photosensitive member according to a first embodiment of the present disclosure.

FIG. 2 is a partial cross-sectional view of a single-layer electrophotographic photosensitive member that is another example of the electrophotographic photosensitive member according to the first embodiment of the present disclosure.

FIG. 3 is a partial cross-sectional view of a single-layer electrophotographic photosensitive member that is still another example of the electrophotographic photosensitive member according to the first embodiment of the present disclosure.

FIG. 4 is a partial cross-sectional view of a positively chargeable multi-layer electrophotographic photosensitive member that is an example of the electrophotographic photosensitive member according to the first embodiment of the present disclosure.

FIG. 5 is a partial cross-sectional view of a positively chargeable multi-layer electrophotographic photosensitive member that is another example of the electrophotographic photosensitive member according to the first embodiment of the present disclosure.

FIG. 6 is a partial cross-sectional view of a positively chargeable multi-layer electrophotographic photosensitive member that is still another example of the electrophotographic photosensitive member according to the first embodiment of the present disclosure.

FIG. 7 is a diagram illustrating an example of an image forming apparatus according to a second embodiment of the present disclosure.

FIG. 8 is a ¹H-NMR spectrum of a polyarylate resin (R-1).

FIG. 9 is a diagram illustrating an example of the configuration of a scratching apparatus.

FIG. 10 is a cross-sectional view taken along a line X-X in FIG. 9.

FIG. 11 is a side view of a fixing table, a scratching stylus, and an electrophotographic photosensitive member illustrated in FIG. 9.

FIG. 12 is a diagram illustrating a scratch formed on the surface of a photosensitive layer.

### DETAILED DESCRIPTION

The following describes embodiments of the present disclosure in detail. However, the present disclosure is not limited to the following embodiments and can be practiced within a scope of objects of the present disclosure with alterations made as appropriate. In the following description, the term “-based” may be appended to the name of a chemical compound to form a generic name encompassing both the chemical compound itself and derivatives thereof. When the term “-based” is appended to the name of a chemical compound used in the name of a polymer, the term indicates that a repeating unit of the polymer originates from the chemical compound or a derivative thereof. Furthermore, “general formulas” and “chemical formulas” are each generally referred to as “formula”. The words “each represent, independently of one another” in description of formulas mean representing the same group as or different groups from one another. Any one type of each component described in the present specification may be used independently or any two or more types of the component may be used in combination unless otherwise stated.

The substituents used in the present specification will be described first. Examples of a halogen atom (halogen group) include fluorine atom (fluoro group), chlorine atom (chloro group), bromine atom (bromo group), and iodine atom (iodine group).

Unless otherwise stated, an alkyl group with a carbon number of at least 1 and no greater than 8, an alkyl group with a carbon number of at least 1 and no greater than 6, an alkyl group with a carbon number of at least 1 and no greater than 5, an alkyl group with a carbon number of at least 1 and no greater than 4, and an alkyl group with a carbon number of at least 1 and no greater than 3 each are an unsubstituted straight chain or branched chain alkyl group. Examples of the alkyl group with a carbon number of at least 1 and no greater than 8 include a methyl group, an ethyl group, an n-propyl group, an isopropyl group, an n-butyl group, a sec-butyl group, a tert-butyl group, an n-pentyl group, a 1-methylbutyl group, a 2-methylbutyl group, a 3-methylbutyl group, a 1-ethylpropyl group, a 2-ethylpropyl group, a 1,1-dimethylpropyl group, a 1,2-dimethylpropyl group, a 2,2-dimethylpropyl group, an n-hexyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 3,3-dimethylbutyl group, a 1,1,2-trimethylpropyl group, a 1,2,2-trimethylpropyl group, a 1-ethylbutyl group, a 2-ethylbutyl group, a 3-ethylbutyl group, a straight chain or branched chain heptyl group, and a straight chain or branched chain octyl group. Examples of the alkyl group with a carbon number of at least 1 and no greater than 6, the alkyl group with a carbon number of at least 1 and no greater than 5, the alkyl group with a carbon number of at least 1 and no greater than 4, and the alkyl group with a carbon number of at least 1 and no greater than 3 are groups with corresponding carbon numbers among the groups listed as the examples of the alkyl group with a carbon number of at least 1 and no greater than 8.

A perfluoroalkyl group with a carbon number of at least 1 and no greater than 10, a perfluoroalkyl group with a carbon number of at least 3 and no greater than 10, a perfluoroalkyl group with a carbon number of at least 5 and no greater than 7, and a perfluoroalkyl group with a carbon number of 6 each are an unsubstituted straight chain or branched chain perfluoroalkyl group unless otherwise stated. Examples of the perfluoroalkyl group with a carbon number of at least 1 and no greater than 10 include a trifluoromethyl group, a perfluoroethyl group, a perfluoro-n-propyl group, a perfluoroisopropyl group, a perfluoro-n-butyl group, a perfluoro-sec-butyl group, a perfluoro-tert-butyl group, a perfluoro-n-pentyl group, a perfluoro-1-methylbutyl group, a perfluoro-2-methylbutyl group, a perfluoro-3-methylbutyl group, a perfluoro-1-ethylpropyl group, a perfluoro-2-ethylpropyl group, a perfluoro-1,1-dimethylpropyl group, a perfluoro-1,2-dimethylpropyl group, a perfluoro-2,2-dimethylpropyl group, a perfluoro-n-hexyl group, a perfluoro-1-methylpentyl group, a perfluoro-2-methylpentyl group, a perfluoro-3-methylpentyl group, a perfluoro-4-methylpentyl group, a perfluoro-1,1-dimethylbutyl group, a perfluoro-1,2-dimethylbutyl group, a perfluoro-1,3-dimethylbutyl group, a perfluoro-2,2-dimethylbutyl group, a perfluoro-2,3-dimethylbutyl group, a perfluoro-3,3-dimethylbutyl group, a perfluoro-1,1,2-trimethylpropyl group, a perfluoro-1,2,2-trimethylpropyl group, a perfluoro-1-ethylbutyl group, a perfluoro-2-ethylbutyl group, a perfluoro-3-ethylbutyl group, a straight chain or branched chain perfluoroheptyl group, a straight chain or branched chain perfluorooctyl group, a straight chain or branched chain perfluorononyl group, and a straight chain or branched chain perfluorodecyl group. Examples of the perfluoroalkyl group with a carbon number of at least 3 and no greater than 10, the perfluoroalkyl group with a carbon number of at least 5 and no greater than 7, and the perfluoroalkyl group with a carbon number of 6 are groups with corresponding carbon numbers among the groups listed as the examples of the perfluoroalkyl group with a carbon number of at least 1 and no greater than 10.

An alkanediyl group with a carbon number of at least 1 and no greater than 6 and an alkanediyl group with a carbon number of at least 1 and no greater than 3 each are an unsubstituted straight chain or branched chain alkanediyl group unless otherwise stated. Examples of the alkanediyl group with a carbon number of at least 1 and no greater than 6 include a methanediyl group (methylene group), an ethanediyl group, an n-propanediyl group, an isopropanediyl group, an n-butanediyl group, a sec-butanediyl group, a tert-butanediyl group, an n-pentanediyl group, a 1-methylbutanediyl group, a 2-methylbutanediyl group, a 3-methylbutanediyl group, a 1-ethylpropanediyl group, a 2-ethylpropanediyl group, a 1,1-dimethylpropanediyl group, a 1,2-dimethylpropanediyl group, a 2,2-dimethylpropanediyl group, an n-hexanediyl group, a 1-methylpentanediyl group, a 2-methylpentanediyl group, a 3-methylpentanediyl group, a 4-methylpentanediyl group, a 1,1-dimethylbutanediyl group, a 1,2-dimethylbutanediyl group, a 1,3-dimethylbutanediyl group, a 2,2-dimethylbutanediyl group, a 2,3-dimethylbutanediyl group, a 3,3-dimethylbutanediyl group, a 1,1,2-trimethylpropanediyl group, a 1,2,2-trimethylpropanediyl group, a 1-ethylbutanediyl group, a 2-ethylbutanediyl group, and a 3-ethylbutandiyl group. Examples of the alkanediyl group with a carbon number of at least 1 and no greater than 3 are groups with a corresponding carbon number among the groups listed as the examples of the alkanediyl group with a carbon number of at least 1 and no greater than 6.

An alkoxy group with a carbon number of at least 1 and no greater than 8, an alkoxy group with a carbon number of at least 1 and no greater than 6, and an alkoxy group with a carbon number of at least 1 and no greater than 3, each are an unsubstituted straight chain or branched chain alkoxy group unless otherwise stated. Examples of the alkoxy group with a carbon number of at least 1 and no greater than 8 include a methoxy group, an ethoxy group, an n-propoxy group, an isopropoxy group, an n-butoxy group, a sec-butoxy group, a tert-butoxy group, an n-pentoxy group, a 1-methylbutoxy group, a 2-methylbutoxy group, a 3-methylbutoxy group, a 1-ethylpropoxy group, a 2-ethylpropoxy group, a 1,1-dimethylpropoxy group, a 1,2-dimethylpropoxy group, a 2,2-dimethylpropoxy group, an n-hexyloxy group, a 1-methylpentyloxy group, a 2-methylpentyloxy group, a 3-methylpentyloxy group, a 4-methylpentyloxy group, a 1,1-dimethylbutoxy group, a 1,2-dimethylbutoxy group, a 1,3-dimethylbutoxy group, a 2,2-dimethylbutoxy group, a 2,3-dimethylbutoxy group, a 3,3-dimethylbutoxy group, a 1,1,2-trimethylpropoxy group, a 1,2,2-trimethylpropoxy group, a 1-ethylbutoxy group, a 2-ethylbutoxy group, a 3-ethylbutoxy group, a straight chain or branched chain heptyloxy group, and a straight chain or branched chain octyloxy group. Examples of the alkoxy group with a carbon number of at least 1 and no greater than 6 and the alkoxy group with a carbon number of at least 1 and no greater than 3 are groups with corresponding carbon numbers among the groups listed as the examples of the alkoxy group with a carbon number of at least 1 and no greater than 8.

An alkenyl group with a carbon number of at least 2 and no greater than 6 is an unsubstituted straight chain or branched chain alkenyl group. The alkenyl group with a carbon number of at least 2 and no greater than 6 has at least 1 and no greater than 3 double bonds. Examples of the alkenyl group with a carbon number of at least 2 and no greater than 6 include an ethenyl group, a propenyl group, a butenyl group, a butadienyl group, a pentenyl group, a hexenyl group, a hexadienyl group, and a hexatrinyl group.

An aryl group with a carbon number of at least 6 and no greater than 14 and an aryl group with a carbon number of at least 6 and no greater than 10 each are an unsubstituted aryl group unless otherwise stated. Examples of the aryl group with a carbon number of at least 6 and no greater than 14 include a phenyl group, a naphthyl group, an indacenyl group, a biphenylenyl group, an acenaphthylenyl group, an anthryl group, and a phenanthryl group. Examples of the aryl group with a carbon number of at least 6 and no greater than 10 include a phenyl group and a naphthyl group. The substituents used in the present specification have been described so far.

### First Embodiment: Electrophotographic Photosensitive Member

A first embodiment of the present disclosure relates to an electrophotographic photosensitive member (also referred to below as a photosensitive member). The photosensitive member of the first embodiment includes a conductive substrate and an at-least-one-layer photosensitive layer. The at-least-one-layer photosensitive layer includes a first photosensitive layer (corresponding to a specific photosensitive layer). The first photosensitive layer is disposed on the outermost side of the at-least-one-layer photosensitive layer. The outermost side refers to the outer surface side (e.g., a surface side on which exposure light enters) of the photosensitive member and the side opposite to a side where the conductive substrate of the photosensitive member is provided.

The photosensitive member of the first embodiment is a single-layer electrophotographic photosensitive member (also referred to below as single-layer photosensitive member) or a positively chargeable multi-layer electrophotographic photosensitive member (also referred to below as positively chargeable multi-layer photosensitive member).

(Single-Layer Photosensitive Member)

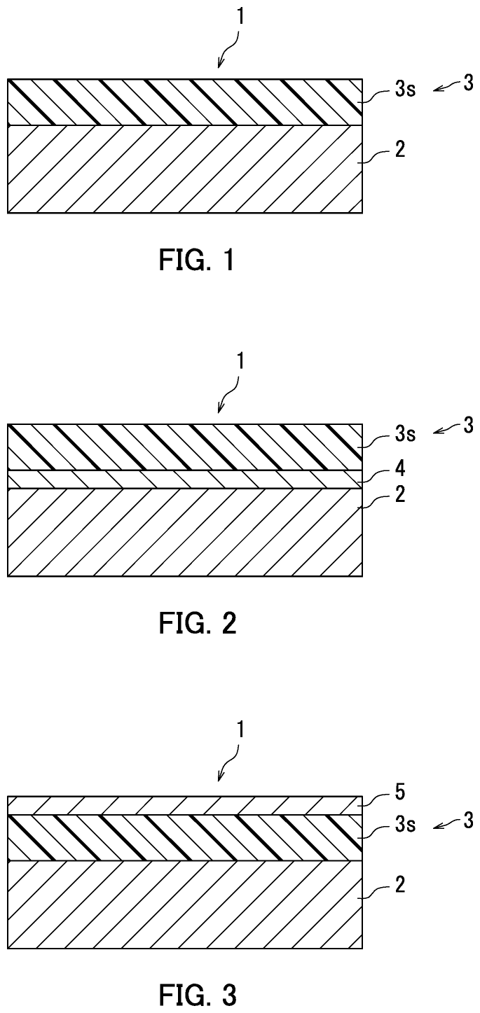

The following describes a single-layer photosensitive member 1, which is an example of the photosensitive member of the first embodiment, with reference to FIGS. 1 to 3. FIGS. 1 to 3 each are a partial cross-sectional view of an example of the single-layer photosensitive member 1.

As illustrated in FIG. 1, the single-layer photosensitive member 1 includes a conductive substrate 2 and a photosensitive layer 3, for example. The photosensitive layer 3 included in the single-layer photosensitive member 1 is a single layer (one layer). The photosensitive layer 3 of one layer is a single-layer photosensitive layer 3s that is the first photosensitive layer.

As illustrated in FIG. 2, the single-layer photosensitive member 1 may further include an intermediate layer 4 (undercoat layer) in addition to the conductive substrate 2 and the single-layer photosensitive layer 3s. The intermediate layer 4 is disposed between the conductive substrate 2 and the single-layer photosensitive layer 3s. As illustrated in FIG. 1, the single-layer photosensitive layer 3s may be disposed directly on the conductive substrate 2. Alternatively, as illustrated in FIG. 2, the single-layer photosensitive layer 3s may be disposed on the conductive substrate 2 with the intermediate layer 4 therebetween.

As illustrated in FIG. 3, the single-layer photosensitive member 1 may further include a protective layer 5 in addition to the conductive substrate 2 and the single-layer photosensitive layer 3s. The protective layer 5 is disposed on the single-layer photosensitive layer 3s. The single-layer photosensitive layer 3s is preferably provided as an outermost layer of the photosensitive member 1 as illustrated in FIGS. 1 and 2. As a result of the single-layer photosensitive member 1 including as an outermost layer the single-layer photosensitive layer 3s that contains a later-described polyarylate resin (PA) and a later-described specific electron transport material, anti-fogging property of the single-layer photosensitive member 1 can be easily improved. Note that the protective layer 5 may be provided as an outermost layer of the photosensitive member 1 as illustrated in FIG. 3.

Although no particular limitations are placed on the thickness of the single-layer photosensitive layer 3s, the single-layer photosensitive layer 3s preferably has a thickness of at least 5 μm and no greater than 100 μm, and more preferably at least 10 μm and no greater than 50 μm.

The single-layer photosensitive layer 3s being the first photosensitive layer contains a charge generating material, a binder resin, an electron transport material, and a hole transport material. In the following, the “hole transport material contained in the single-layer photosensitive layer 3s” may be also referred to below as “hole transport material (SL)”. Also, the “binder resin contained in the single-layer photosensitive layer 3s” may be referred to as “binder resin (SL)”. The single-layer photosensitive layer 3s may contain an additive as necessary. The single-layer photosensitive member 1 has been described so far with reference to FIGS. 1 to 3.

(Positively Chargeable Multi-Layer Photosensitive Member)

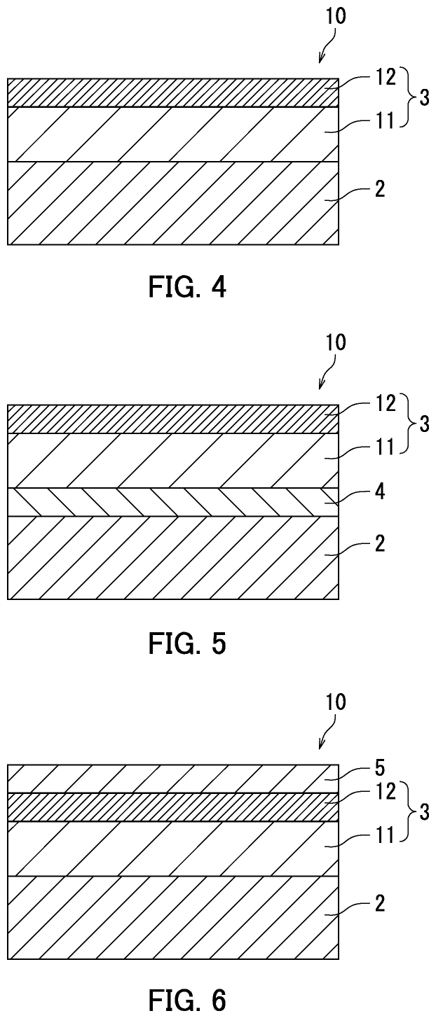

The following describes a positively chargeable multi-layer photosensitive member 10, which is an example of the photosensitive member of the first embodiment, with reference to FIGS. 4 to 6. FIGS. 4 to 6 each are a partial cross-sectional view of an example of the positively chargeable multi-layer photosensitive member 10.

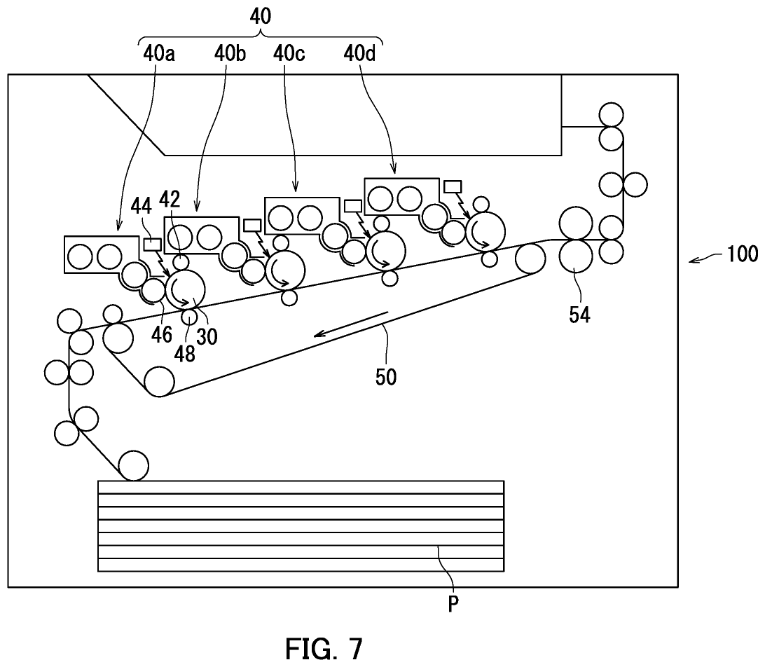

As illustrated in FIG. 4, the positively chargeable multi-layer photosensitive member 10 includes a conductive substrate 2 and a photosensitive layer 3, for example. The photosensitive layer 3 included in the positively chargeable multi-layer photosensitive member 10 includes two layers. The two layers of the photosensitive layer 3 are a charge generating layer 12 and a charge transport layer 11. The charge generating layer 12 is the first photosensitive layer. The charge transport layer 11 is a second photosensitive layer. The charge generating layer 12 being the first photosensitive layer is disposed on the outermost side of the photosensitive layer 3 of two layers (the charge generating layer 12 and the charge transport layer 11). The charge transport layer 11 is disposed on the side of the conductive substrate 2 rather than the charge generating layer 12. Because the charge generating layer 12 is located on the outermost side (a side opposite to the side on which the conductive substrate 2 of the positively chargeable multi-layer photosensitive member 10 is disposed), the charge transport layer 11 is disposed on the conductive substrate 2 and the charge generating layer 12 is disposed on the charge transport layer 11, for example. In a case in which an image forming apparatus 100 (see FIG. 7) is provided with the positively chargeable multi-layer photosensitive member 10, the positively chargeable multi-layer photosensitive member 10 is charged to a positive polarity by a charger 42 (see FIG. 7).

As illustrated in FIG. 5, the positively chargeable multi-layer photosensitive member 10 may further include an intermediate layer 4 (undercoat layer) in addition to the conductive substrate 2 and the photosensitive layer 3. The intermediate layer 4 is disposed between the conductive substrate 2 and the photosensitive layer 3 (e.g., the charge transport layer 11). As illustrated in FIG. 4, the photosensitive layer 3 (e.g., the charge transport layer 11) may be disposed directly on the conductive substrate 2. Alternatively, as illustrated in FIG. 5, the photosensitive layer 3 (e.g., the charge transport layer 11) may be disposed on the conductive substrate 2 with the intermediate layer 4 therebetween.

As illustrated in FIG. 6, the positively chargeable multi-layer photosensitive member 10 may further include a protective layer 5 in addition to the conductive substrate 2 and the photosensitive layer 3. The protective layer 5 is provided on the photosensitive layer 3 (e.g., charge generating layer 12). As illustrated in FIGS. 4 and 5, the photosensitive layer 3 is preferably provided as an outermost layer of the positively chargeable multi-layer photosensitive member 10. As a result of the photosensitive layer 3 (e.g., the charge generating layer 12) that contains the later-described polyarylate resin (PA) and the later-described specific electron transport material being provided as an outermost layer, anti-fogging property of the positively chargeable multi-layer photosensitive member 10 can be easily improved. Note that the protective layer 5 may be provided as an outermost layer of the positively chargeable multi-layer photosensitive member 10 as illustrated in FIG. 6.

The charge generating layer 12 has a thickness of preferably at least 2 μm and no greater than 100 μm, and more preferably at least 15 μm and no greater than 30 μm. The charge transport layer 11 preferably has a thickness of at least 2 μm and no greater than 100 μm, and more preferably at least 3 μm and no greater than 20 μm, and further preferably at least 5 μm and no greater than 15 μm.

The charge generating layer 12 being the first photosensitive layer contains a charge generating material, a binder resin, an electron transport material, and a hole transport material. In the following, the “hole transport material contained in the charge generating layer 12” may be also referred to below as “hole transport material (CG)”. Also, the “binder resin contained in the charge generating layer 12” may be referred to as “binder resin (CG)”. The charge generating layer 12 may contain an additive as necessary.

The charge transport layer 11 being the second photosensitive layer contains a hole transport material and a binder resin. In the following, the “hole transport material contained in the charge transport layer 11” may be also referred to below as “hole transport material (CT)”. Also, the “binder resin contained in the charge transport layer 11” may be referred to as “binder resin (CT)”. The charge transport layer 11 may contain an additive as necessary. The positively chargeable multi-layer photosensitive member 10 has been described so far with reference to FIGS. 4 to 6.

The photosensitive member will be described further in detail below. Note that where there is no need to distinguish among the binder resin (SL), the binder resin (CG), and the binder resin (CT), the binder resins may be each referred to simply as “binder resin”. Where there is no need to distinguish among the hole transport material (SL), the hole transport material (CG), and the hole transport material (CT), the hole transport materials may be each referred to simply as “hole transport material”.

(Binder Resin)

The binder resin (specifically, the binder resins (SL) and (CG)) contained in the first photosensitive layer includes a polyarylate resin. The polyarylate resin includes repeating units represented by formulas (1), (2), (3), and (4). A third percentage is greater than 0% and less than 50% in the polyarylate resin. The third percentage is a percentage of the number of repeats of the repeating unit represented by formula (3) relative to the total of the number of repeats of the repeating units represented by formula (1) and the number of repeats of the repeating units represented by formula (3). A fourth percentage is at least 35% and less than 70% in the polyarylate resin. The fourth percentage is a percentage of the number of repeats of the repeating unit represented by formula (4) relative to the total of the number of repeats of the repeating units represented by formula (2) and the number of repeats of the repeating units represented by formula (4).

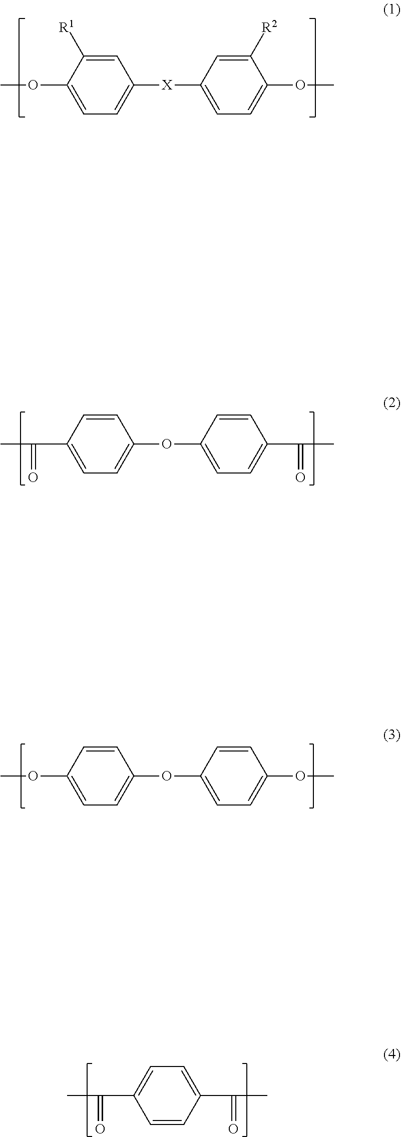

In formula (1), R¹ and R² each represent a methyl group and X represents a divalent group represented by formula (X1). Alternatively, R¹ and R² each represent a hydrogen atom and X represents a divalent group represented by formula (X2).

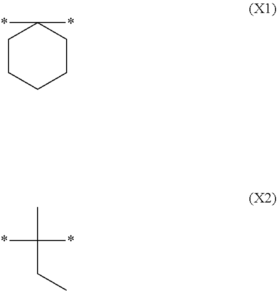

In formulas (X1) and (X2), * represents a bond. Each bond that is represented by * in formulas (X1) and (X2) is bonded to a carbon atom to which X in formula (1) is bonded.

In the following, the repeating units represented by formulas (1), (2), (3), and (4) may be referred to as “repeating units (1). (2), (3), and (4)”, respectively. Also, the polyarylate resin including the repeating units (1), (2), (3), and (4) and having a third percentage of greater than 0% and less than 50% and a fourth percentage of at least 35% and less than 70% may be referred to as “polyarylate resin (PA)”.

As described previously, the binder resins (SL) and (CG) contained in the first photosensitive layer each essentially includes the polyarylate resin (PA). Note that the binder resin (CT) contained in the charge transport layer is not particularly limited and may include the polyarylate resin (PA) or an additional binder resin which will be described later. Furthermore, the binder resin (CG) and the binder resin (CT) may be the same as or different from one another.

The photosensitive layer (especially, the first photosensitive layer) containing the polyarylate resin (PA) is resistant to microscopic scratches. Therefore, toner is inhibited from entering such microscopic scratches, thereby improving anti-fogging property of the photosensitive member. Furthermore, the polyarylate resin (PA) has excellent solubility in a solvent, thereby achieving favorable formation of the photosensitive layer (especially, the first photosensitive layer).

When R¹ and R² each represent a methyl group and X represents a divalent group represented by formula (X1) in formula (1), the repeating unit (1) is a repeating unit represented by formula (1-1) (also referred to below as repeating unit (1-1)). When R¹ and R² each represent a hydrogen atom and X represents a divalent group represented by formula (X2) in formula (1), the repeating unit (1) is a repeating unit represented by formula (1-2) (also referred to below as repeating unit (1-2)). The polyarylate resin (PA) may include as the repeating unit (1) only one repeating unit (1) or include two repeating units (1).

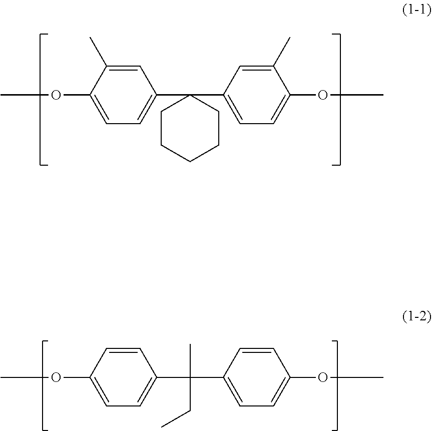

A percentage of the number of repeats of the repeating unit (1) relative to the total number of repeats of the repeating units (1) and (3) is also referred to below as first percentage. The first percentage corresponds to a percentage (i.e., 100×M₁/(M₁+M₃)) of the number M₁ of repeats of the repeating unit (1) relative to the total of the number M₁ of repeats of the repeating unit (1) and the number M₃ of repeats of the repeating unit (3) in the polyarylate resin (PA). Note that in a case in which the polyarylate resin (PA) contains two repeating units (1), the number M₁ of repeats of the repeating unit (1) is the total number of repeats of the two repeating units (1).

The first percentage is preferably less than 100%, more preferably no greater than 99%, further preferably no greater than 90%, further more preferably no greater than 80%, still further preferably no greater than 70%, still more preferably less than 70%, and particularly preferably no greater than 65%. By contrast, the first percentage is preferably greater than 50%, more preferably at least 51%, and further preferably at least 55%. In order to improve anti-fogging property of the photosensitive member, the first percentage is preferably greater than 50% and no greater than 70%, and more preferably greater than 50% and less than 70%.

A percentage of the number of repeats of the repeating unit (2) relative to the total number of repeats of the repeating units (2) and (4) is also referred to below as second percentage. The second percentage corresponds to a percentage (i.e., 100×M₂/(M₂+M₄)) of the number M₂ of repeats of the repeating unit (2) relative to the total of the number M₂ of repeats of the repeating unit (2) and the number M₄ of repeats of the repeating unit (4) in the polyarylate resin (PA).

The second percentage is preferably no greater than 65%, and more preferably no greater than 60%. By contrast, the second percentage is preferably greater than 30%, more preferably at least 31%, further preferably at least 35%, further more preferably at least 40%, and particularly preferably at least 55%. The second percentage is preferably greater than 30% and no greater than 60% in order to improve anti-fogging property of the photosensitive member. In order to improve abrasion resistance of the photosensitive member where the polyarylate resin (PA) is contained in the photosensitive layer, the second percentage is preferably at least 55% and no greater than 65%.

As described previously, the third percentage is greater than 0% and less than 50%. The third percentage corresponds to a percentage (i.e., 100×M₃/(M₁+M₃)) of the number M³ of repeats of the repeating unit (3) relative to the total of the number M₁ of repeats of the repeating unit (1) and the number M₃ of repeats of the repeating unit (3) in the polyarylate resin (PA).

As a result of the third percentage being less than 50%, the polyarylate resin (PA) can have increased solubility in a solvent to achieve favorable formation of the photosensitive layer. As a result of the third percentage being greater than 0%, that is, as a result of the third percentage being not 0%, abrasion resistance of the photosensitive member where the polyarylate resin (PA) is contained in the photosensitive layer can be improved. The third percentage is preferably at least 1%, more preferably at least 10%, further preferably at least 20%, further more preferably at least 30%, still more preferably greater than 30%, and particularly preferably at least 35%. By contrast, the third percentage is preferably no greater than 49%, and more preferably no greater than 45%.

In order to improve anti-fogging property of the photosensitive member, the third percentage is preferably at least 30% and less than 50%, and more preferably greater than 30% and less than 50%.

As described previously, the fourth percentage is at least 35% and less than 70%. The fourth percentage corresponds to a percentage (i.e., 100×M₄/(M₂+M₄)) of the number M₄ of repeats of the repeating unit (4) relative to the total of the number M₂ of repeats of the repeating unit (2) and the number M₄ of repeats of the repeating unit (4) in the polyarylate resin (PA).

As a result of the fourth percentage being at least 35%, anti-fogging property of the photosensitive member is improved. As a result of the third percentage being at least 35%, the polyarylate resin (PA) can have increased solubility in a solvent to achieve favorable formation of the photosensitive layer. As a result of the fourth percentage being less than 70% by contrast, abrasion resistance and anti-fogging property of the photosensitive member are improved. Preferably, the fourth percentage is at least 40%. Furthermore, the percentage (4) is preferably no greater than 69%, more preferably no greater than 65%, further preferably no greater than 60%, and still further preferably no greater than 45%.

In order to improve anti-fogging property of the photosensitive member, the fourth percentage is preferably at least 40% and less than 70%. In order to improve abrasion resistance of the photosensitive member where the polyarylate resin (PA) is contained in the photosensitive layer, the fourth percentage is preferably at least 35% and no greater than 45%.

The first percentage, the second percentage, the third percentage, and the fourth percentage can be each calculated from a ratio of a peak unique to a corresponding repeating unit in a ¹H-NMR spectrum of the polyarylate resin (PA) measured using a proton nuclear magnetic resonance spectrometer.

In order to increase solubility in a solvent and improve anti-fogging property and abrasion resistance of the photosensitive member, it is preferable that the value of the first percentage differs from that of the second percentage and that of the fourth percentage. For the same purpose as above, it is preferable that the value of the third percentage differs from that of the second percentage and that of the fourth percentage.

In order to further improve anti-fogging property of the photosensitive member, it is preferable that: R¹ and R² each represent a methyl group and X represents a divalent group represented by formula (X1) in formula (1); and the fourth percentage is at least 40% and less than 70%.

In order to improve anti-fogging property and abrasion resistance of the photosensitive member in a well-balanced manner, it is preferable that: R¹ and R² each represent a methyl group and X represents a divalent group represented by formula (X1) in formula (1): and the third percentage is at least 30% and less than 50%.

In order to further improve abrasion resistance of the photosensitive member, it is preferable that: R¹ and R² each represent a hydrogen atom and X represents a divalent group represented by formula (X2) in formula (1); and the fourth percentage is at least 35% and no greater than 45%.

In order to improve anti-fogging property and abrasion resistance of the photosensitive member without scarifying sensitivity characteristics of the photosensitive member, the polyarylate resin (PA) preferably does not include a repeating unit with a biphenyl structure. An example of the repeating unit with a biphenyl structure is a repeating unit represented by formula (5). Examples of the repeating unit represented by formula (5) include repeating units represented by formulas (5-1) and (5-2).

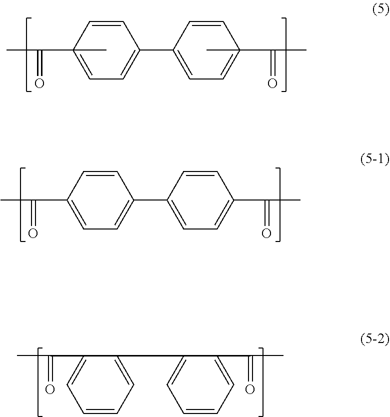

In order to further improve abrasion resistance of the photosensitive member where the polyarylate resin (PA) is contained photosensitive layer, the polyarylate resin (PA) preferably does not include a repeating unit derived from isophthalic acid.

The polyarylate resin (PA) may include an end group. Examples of the end group of the polyarylate resin (PA) include end groups represented by formulas (T-1) and (T-2). A preferable example of the end group represented by formula (T-1) is an end group represented by formula (T-DMP) (also referred to below as end group (T-DMP)). A preferable example of the end group represented by formula (T-2) is an end group represented by formula (T-PFH) (also referred to below as end group (T-PFH)).

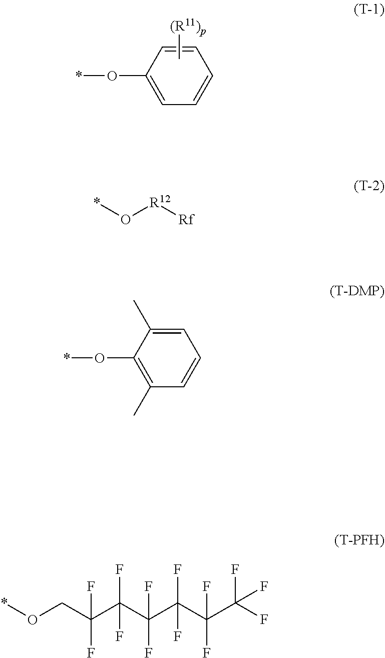

In formula (T-1), R¹¹ represents a halogen atom or an alkyl group with a carbon number of at least 1 and no greater than 6 and p represents an integer of at least 0 and no greater than 5. R¹¹ preferably represents an alkyl group with a carbon number of at least 1 and no greater than 6, more preferably represents an alkyl group with a carbon number of at least 1 and no greater than 3, and further preferably represents a methyl group. p preferably represents an integer of at least 1 and no greater than 3, and more preferably represents 2.

In formula (T-2), R¹² represents an alkanediyl group with a carbon number of at least 1 and no greater than 6 and Rf represents a perfluoroalkyl group with a carbon number of at least 1 and no greater than 10. R¹² preferably represents an alkanediyl group with a carbon number of at least 1 and no greater than 3, and more preferably represents a methylene group. Rf preferably represents a perfluoroalkyl group with a carbon number of at least 3 and no greater than 10, more preferably represents a perfluoroalkyl group with a carbon number of at least 5 and no greater than 7, and further preferably represents a perfluoroalkyl group with a carbon number of 6.

In formulas (T-1), (T-2), (T-DMP), and (T-PFH), * represents a bond. Each bond represented by * in formulas (T-1), (T-2), (T-DMP), and (T-PFH) is bonded to a repeating unit (specifically, the repeating unit (2) or (4)) derived from dicarboxylic acid located at an end of the polyarylate resin (PA).

In order to further improve anti-fogging property and abrasion resistance of the photosensitive member, the polyarylate resin (PA) preferably includes an end group having a halogen atom. For the same purpose as above, it is preferable that: R¹ and R² each represent a methyl group and X represents a divalent group represented by formula (X1) in formula (1); and the polyarylate resin (PA) includes an end group having a halogen atom.

An example of the end group having a halogen atom is an end group (T-1) where R¹¹ in formula (T-1) represents a halogen atom. Another example of the end group having a halogen atom is the end group (T-2).

Preferable examples of the polyarylate resin (PA) include polyarylate resins (PA-1) and (PA-2) shown in Table 1. The polyarylate resins (PA-1) and (PA-2) include respective repeating units shown in Table 1 as the repeating units (1) to (4). Further preferable examples of the polyarylate resin (PA) include polyarylate resins (PA-a) to (PA-d) shown in Table 2. The polyarylate resins (PA-a) to (PA-d) include end groups shown in Table 2 and include repeating units shown in Table 2 as the repeating units (1) to (4). In Tables 1 and 2, “Units (1) to (4)” indicate the “repeating units (1) to (4)”, respectively.

TABLE 1

| Polyarylate | | | | |
|---|---|---|---|---|
| resin | Unit (1) | Unit (2) | Unit (3) | Unit (4) |
| PA-1 | 1-1 | 2 | 3 | 4 |
| PA-2 | 1-2 | 2 | 3 | 4 |

TABLE 2

| Polyarylate | | | | | End |
|---|---|---|---|---|---|
| resin | Unit (1) | Unit (2) | Unit (3) | Unit (4) | group |
| PA-a | 1-1 | 2 | 3 | 4 | T-DMP |
| PA-b | 1-2 | 2 | 3 | 4 | T-DMP |
| PA-c | 1-1 | 2 | 3 | 4 | T-PFH |
| PA-d | 1-2 | 2 | 3 | 4 | T-PFH |

In the polyarylate resin (PA), repeating units (specifically, the repeating units (1) and (3)) derived from bisphenols and repeating units (specifically, the repeating units (2) and (4)) derived from dicarboxylic acids are adjacent and bonded to each other. That is, the repeating unit (1) may be bonded to the repeating unit (2) or bonded to the repeating unit (4). Also, the repeating unit (3) may be bonded to the repeating unit (2) or bonded to the repeating unit (4). The number of repeats of the repeating units derived from bisphenols and the number of repeats of the repeating units derived from dicarboxylic acids are substantially equal to each other and satisfy a calculation formula “number of repeats of repeating units derived from dicarboxylic acids=number of repeats of repeating units derived from bisphenols+1”. The polyarylate resin (PA) may be a random copolymer, an alternating copolymer, a periodic copolymer, or a block copolymer, for example.

The polyarylate resin (PA) may further include a repeating unit other than the repeating units (1) to (4) as a repeating unit. However, in order to increase solubility in a solvent and improve anti-fogging property and abrasion resistance of the photosensitive member, the percentage of the total of the numbers of repeats of the repeating units (1) to (4) relative to the total of the numbers of repeats of all repeating units included in the polyarylate resin (PA) is preferably at least 80%, more preferably at least 90%, and further preferably at least 95%, still further preferably at least 99%, and particularly preferably 100%. That is, the polyarylate resin (PA) particularly preferably includes only the repeating units (1) to (4) each as a repeating unit.

The percentage of the number of repeats of the repeating unit (1) relative to the total of the numbers of repeats of repeating units derived from bisphenols in the polyarylate resin (PA) is preferably gerater than 50% and less than 100%, more preferably at least 55% and no greater than 90%, further preferably at least 60% and no greater than 80%, still further preferably at least 60% and no greater than 70%, and still more preferably at least 60% and less than 70%. The percentage of the total of the numbers of repeats of the repeating unit (3) relative to the total of the numbers of repeats of the repeating units derived from bisphenols in the polyarylate resin (PA) is preferably greater than 0% and less than 50%, more preferably at least 10% and no greater than 45%, further preferably at least 20% and no greater than 40%, still further preferably at least 30% and no greater than 40%, and still more preferably greater than 30% and no greater than 40%.

The percentage of the number of repeats of the repeating unit (2) relative to the total of the numbers of repeats of the repeating units derived from dicarboxylic acids in the polyarylate resin (PA) is preferably greater than 30% and no greater than 65%, more preferably at least 35% and no greater than 65%, and further preferably at least 40% and no greater than 60%. The percentage of the number of repeats of the repeating unit (4) relative to the total of the numbers of repeats of the repeating units derived from dicarboxylic acids in the polyarylate resin (PA) is preferably greater than 35% and less than 70%, more preferably at least 35% and no greater than 65%, and further preferably at least 40% and no greater than 60%.

The polyarylate resin (PA) has a viscosity average molecular weight of preferably at least 10,000, more preferably at least 30.000, further preferably at least 35,000, still further preferably at least 50,000, and particularly preferably at least 55,000. As a result of the viscosity average molecular weight of the polyarylate resin (PA) being set to at least 10,000, abrasion resistance of the photosensitive member is improved where the polyarylate resin (PA) is contained in the photosensitive layer thereof. As a result of the viscosity average molecular weight of the polyarylate resin (PA) being set to at least 35,000, the strain at break becomes a desirable value or larger to improve abrasion resistance of the photosensitive member. Also, as a result of the viscosity average molecular weight of the polyarylate resin (PA) being set to at least 35,000, anti-fogging property of the photosensitive member is further improved. By contrast, the polyarylate resin (PA) has a viscosity average molecular weight of preferably no greater than 80.000, more preferably no greater than 70,000, and further preferably no greater than 60,000. As a result of the viscosity average molecular weight of the polyarylate resin (PA) being set to no greater than 80,000, anti-fogging property of the photosensitive member is further improved. Solubility of the polyarylate resin (PA) in a solvent is also increased. The viscosity average molecular weight of the polyarylate resin (PA) is measured in accordance with the Japanese Industrial Standards (JIS) K7252-1:2016.

The ratio of the mass of the binder resin to the mass of the first photosensitive layer is preferably at least 0.35 and no greater than 0.50. As a result of the ratio of the mass of the binder resin to the mass of the first photosensitive layer being set to at least 0.35 and no greater than 0.50, anti-fogging property of the photosensitive member is further improved. Furthermore, as a result of the ratio of the mass of the binder resin to the mass of the first photosensitive layer being set to no greater than 0.50, the amounts of the electron transport material and the hole transport material in the first photosensitive layer are relatively large to improve sensitivity characteristics of the photosensitive member. In a case in which the photosensitive member is a single-layer photosensitive member, the ratio of the mass of the binder resin to the mass of the first photosensitive layer is the ratio of the mass of the binder resin (SL) to the mass of the single-layer photosensitive layer being the first photosensitive layer. In a case in which the photosensitive member is a positively chargeable multi-layer photosensitive member, the ratio of the mass of the binder resin to the mass of the first photosensitive layer is the ratio of the mass of the binder resin (CG) to the mass of the charge generating layer being the first photosensitive layer. In a case in which the binder resin (SL) includes a later-described additional binder resin in addition to the polyarylate resin (PA), the mass of the binder resin (SL) is the total mass of the polyarylate resin (PA) and the additional binder resin. In a case in which the binder resin (CG) includes a later-described additional binder resin in addition to the polyarylate resin (PA), the mass of the binder resin (CG) is the total mass of the polyarylate resin (PA) and the additional binder resin. In a case in which the binder resin (SL) includes two or more resins, the mass of the binder resin (SL) is the total mass of the two or more resins. In a case in which the binder resin (CG) includes two or more resins, the mass of the binder resin (CG) is the total mass of the two or more resins.

The following describes a method for producing the polyarylate resin (PA). An example of the method for producing the polyarylate resin (PA) is condensation polymerization of bisphenols for forming bisphenol-derived repeating units and dicarboxylic acids for forming dicarboxylic acid-derived repeating units. Any known synthesis method (e.g., solution polymerization, melt polymerization, or interface polymerization) can be employed as condensation polymerization.

Examples of the bisphenols for forming the bisphenol-derived repeating units include compounds represented by formulas (BP-1) and (BP-3) (also referred to below as compounds (BP-1) and (BP-3), respectively). Examples of the dicarboxylic acids for forming the dicarboxylic acid-derived repeating units include compounds represented by formulas (DC-2) and (DC-4) (also referred to below as compounds (DC-2) and (CD-4), respectively). R¹, R², and X in formula (BP-1) are the same as defined for R¹, R², and X in formula (1), respectively.

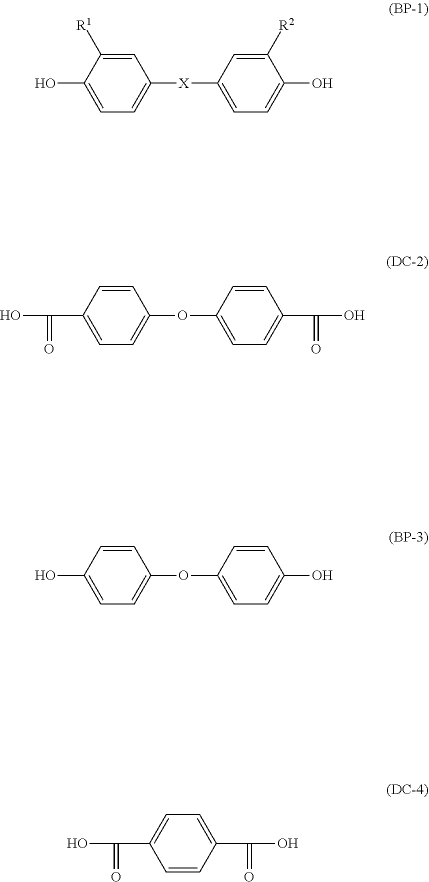

In production of the polyarylate resin (PA), the first percentage is adjusted by changing the addition amount (unit: mol) of the compound (BP-1) relative to the total (unit: mol) of the addition amounts of the compounds (BP-1) and (BP-3). The first percentage corresponds to the mole fraction (unit: mol %) of the repeating unit (1) in the total amount of the repeating units (1) and (3) of the polyarylate resin (PA). Also, the second percentage is adjusted by changing the addition amount (unit: mol) of the compound (DC-2) relative to the total (unit: mol) of the addition amounts of the compounds (DC-2) and (DC-4). The second percentage corresponds to the mole fraction (unit: mol %) of the repeating unit (2) in the total amount of the repeating units (2) and (4) of the polyarylate resin (PA). The third percentage is adjusted by changing the addition amount (unit: mol) of the compound (BP-3) relative to the total (unit: mol) of the addition amounts of the compounds (BP-1) and (BP-3). The third percentage corresponds to the mole fraction (unit: mol %) of the repeating unit (3) in the total amount of the repeating units (1) and (3) of the polyarylate resin (PA). The fourth percentage is adjusted by changing the addition amount (unit: mol) of the compound (DC-4) relative to the total (unit: mol) of the addition amounts of the compounds (DC-2) and (DC-4). The fourth percentage corresponds to the mole fraction (unit: mol %) of the repeating unit (4) in the total amount of the repeating units (2) and (4) of the polyarylate resin (PA).

Bisphenols may be derivatized to aromatic diacetates for use. The dicarboxylic acids may be derivatized for use. Examples of the derivatives of the carboxylic acids include dicarboxylic acid dichloride, dicarboxylic acid dimethyl ester, dicarboxylic acid diethyl ester, and dicarboxylic acid anhydride. Dicarboxylic acid dichloride is a compound in which two “—C(═O)—OH” groups of dicarboxylic acid are each substituted with a “—C(═O)—Cl” group.

In condensation polymerization of the bisphenols and the dicarboxylic acids, a terminator may be added. Examples of the terminator include 2,6-dimethylphenol and 1H,1H-perfluoro-1-heptanol. Use of 2,6-dimethylphenol as a terminator forms the end group (T-DMP). Use of 1H,1H-perfluoro-1-heptanol as a terminator forms the end group (T-PFH).

In condensation polymerization of the bisphenols and the dicarboxylic acids, either or both a base and a catalyst may be added. An examples of the base is sodium hydroxide. Examples of the catalyst include benzyltributylammonium chloride, ammonium chloride, ammonium bromide, quaternary ammonium salt, triethylamine, and trimethylamine.

The photosensitive layer (specifically, each of the single-layer photosensitive layer, the charge generating layer, and the charge transport layer) may contain only one polyarylate resin (PA) as a binder resin or may contain two or more polyarylate resins (PA). The photosensitive layer (specifically, each of the single-layer photosensitive layer, the charge generating layer, and the charge transport layer) may contain only the polyarylate resin (PA) as the binder resin, or may further contain a binder resin (also referred to below as additional binder resin) other than the polyarylate resin (PA).

Examples of the additional binder resin include thermoplastic resins (specific examples include polyarylate resin other than the polyarylate resin (PA), polycarbonate resin, styrene-based resin, styrene-butadiene copolymers, styrene-acrylonitrile copolymers, styrene-maleic acid copolymers, styrene-acrylic acid copolymers, acrylic copolymers, polyethylene resin, ethylene-vinyl acetate copolymers, chlorinated polyethylene resin, polyvinyl chloride resin, polypropylene resin, ionomers, vinyl chloride-vinyl acetate copolymers, polyester resin, alkyd resin, polyamide resin, polyurethane resin, polysulfone resin, diallyl phthalate resin, ketone resin, polyvinyl butyral resin, polyvinyl acetal resin, and polyether resin), thermosetting resins (specific examples include silicone resin, epoxy resin, phenolic resin, urea resin, melamine resin, and crosslinkable resins other than these), and photocurable resins (specific examples include epoxy-acrylic acid-based resin and urethane-acrylic acid-based copolymers).

(Electron Transport Material)

The electron transport material includes a compound represented by formula (11), (12). (13). (14), (15), (16), or (17) (also referred to below as electron transport materials (11), (12), (13), (14), (15), (16), and (17), respectively). As a result of the first photosensitive layer containing any of the electron transport materials (11) to (17) in addition to the polyarylate resin (PA), anti-fogging property is improved.

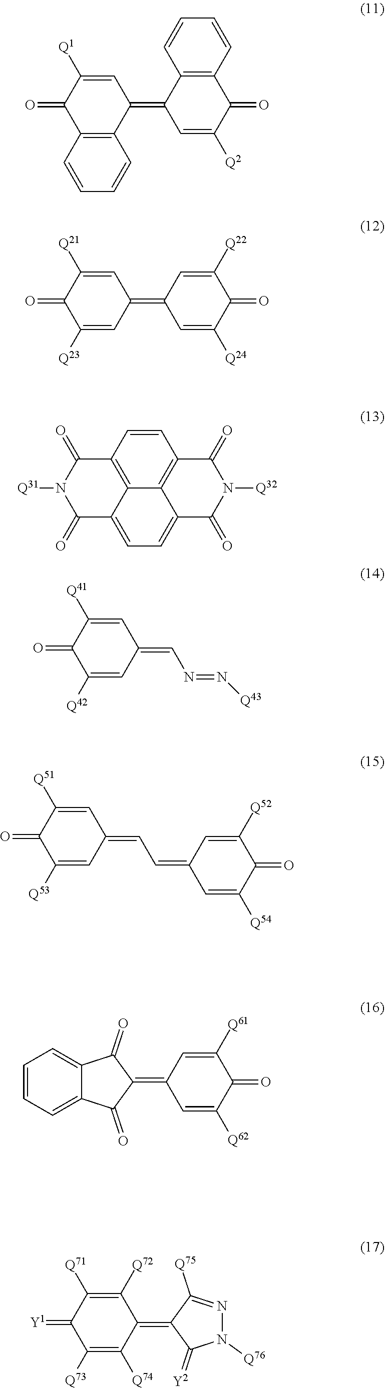

Q¹ and Q² in formula (11), Q²¹, Q²², Q²³, and Q²⁴ in formula (12), Q³ and Q³² in formula (13), Q⁴, Q⁴², and Q⁴³ in formula (14), Q⁵¹, Q⁵², Q⁵³, and Q⁵⁴ in formula (15), Q⁶¹ and Q⁶² in formula (16), and Q⁷¹, Q⁷², Q⁷³, Q⁷⁴, Q⁷⁵, and Q⁷⁶ in formula (17) each represent, independently of one another, a hydrogen atom, a halogen atom, a cyano group, an alkyl group with a carbon number of at least 1 and no greater than 6, an alkenyl group with a carbon number of at least 2 and no greater than 6, an alkoxy group with a carbon number of at least 1 and no greater than 6, or an aryl group with a carbon number of at least 6 and no greater than 14 optionally substituted with at least one substituent selected from the group consisting of a halogen atom and an alkyl group with a carbon number of at least 1 and no greater than 6. In formula (17), Y¹ and Y² each represent, independently of one another, an oxygen atom or a sulfur atom.

Preferably, Q¹ and Q² in formula (11), Q²¹, Q²², Q²³, and Q²⁴ in formula (12), Q³¹ and Q³² in formula (13), Q⁴¹, Q⁴², and Q⁴³ in formula (14), Q⁵¹, Q⁵², Q⁵³, and Q⁵⁴ in formula (15), Q⁶¹ and Q⁶² in formula (16), and Q⁷¹, Q⁷², Q⁷³, Q⁷⁴, Q⁷⁵, and Q⁷⁶ in formula (17) each represent, independently of one another, a hydrogen atom, an alkyl group with a carbon number of at least 1 and no greater than 6, or an aryl group with a carbon number of at least 6 and no greater than 14 optionally substituted with at least one substituent selected from the group consisting of a halogen atom and an alkyl group with a carbon number of at least 1 and no greater than 6. Preferably, Y¹ and Y² each represents an oxygen atom.

The alkyl group with a carbon number of at least 1 and no greater than 16 represented by Q¹ and Q² in formula (11), Q²¹, Q²², Q²³, and Q²⁴ in formula (12), Q³¹ and Q³² in formula (13), Q⁴¹, Q⁴², and Q⁴³ in formula (14), Q⁵¹, Q⁵², Q⁵³, and Q⁵⁴ in formula (15), Q⁶¹ and Q⁶² in formula (16), and Q⁷¹, Q⁷², Q⁷³, Q⁷⁴, Q⁷⁵, and Q⁷⁶ in formula (17) is preferably an alkyl group with a carbon number of at least 1 and no greater than 5, more preferably a methyl group, an ethyl group, a propyl group, a butyl group, or a pentyl group, and particularly preferably a methyl group, an isopropyl group, a tert-butyl group, or a 1,1-dimethylpropyl group.

The aryl group with a carbon number of at least 6 and no greater than 14 represented by Q¹ and Q² in formula (11), Q²¹, Q²², Q²³, and Q²⁴ in formula (12), Q³¹ and Q³² in formula (13), Q⁴¹, Q⁴², and Q⁴³ in formula (14), Q⁵¹, Q⁵², Q⁵³, and Q⁵⁴ in formula (15), Q⁶¹ and Q⁶² in formula (16), and Q⁷¹, Q⁷², Q⁷⁴, Q⁷⁵, and Q⁷⁶ in formula (17) is preferably an aryl group with a carbon number of at least 6 and no greater than 10, and more preferably a phenyl group. The aryl group with a carbon number of at least 6 and no greater than 14 may be substituted with at least one substituent selected from the group consisting of a halogen atom and an alkyl group with a carbon number of at least 1 and no greater than 6. The alkyl group with a carbon number of at least 1 and no greater than 6 being a substituent is preferably an alkyl group with a carbon number of at least 1 and no greater than 3, and more preferably a methyl group or an ethyl group. The halogen atom being a substituent is preferably a fluorine atom, a chlorine atom, or a bromine atom, and particularly preferably a chlorine atom. Where the aryl group with a carbon number of at least 6 and no greater than 14 is substituted with a substituent, the number of substituents is preferably at least 1 and no greater than 5, and more preferably 1 or 2. The aryl group with a carbon number of at least 6 and no greater than 14 substituted with at least one substituted selected from the group consisting of a halogen atom and an alkyl group with a carbon number of at least 1 and no greater than 6 is preferably a chlorophenyl group, a dichlorophenyl group, or an ethylmethylphenyl group, and further preferably a 4-chlorophenyl group, a 2,5-dichlorophenyl group, or a 2-ethyl-6-methylphenyl group.

More preferable examples of the electron transport material include compounds represented by formulas (E-1) to (E-9) (also referred to below as electron transport materials (E-1) to (E-9), respectively).

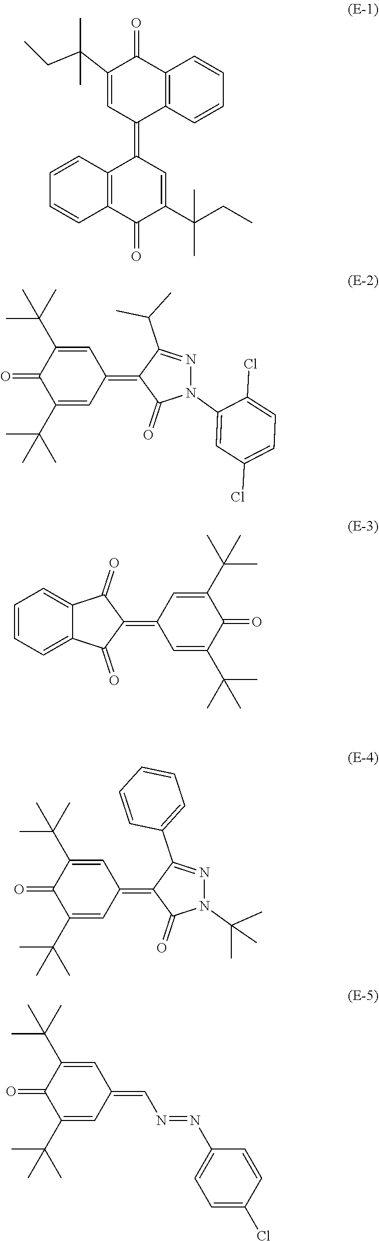

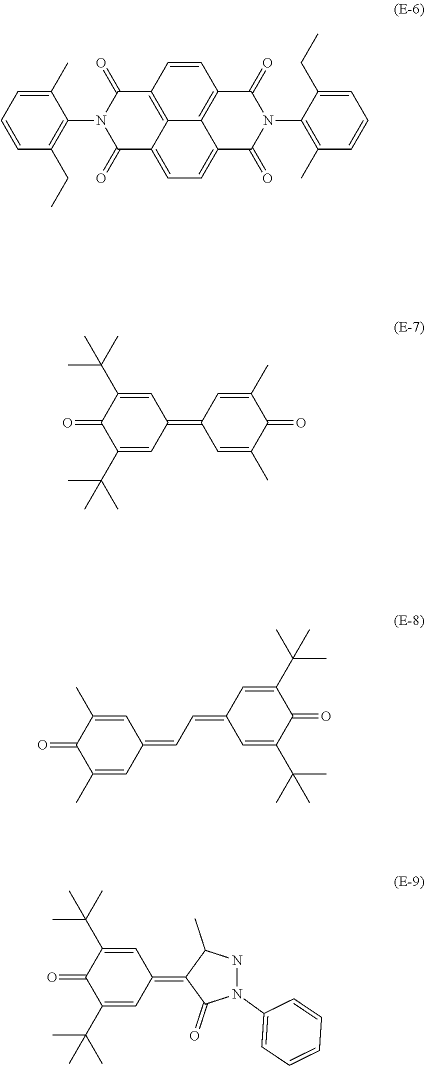 [SMILES: CCc1cccc(C)c1N1C(=O)c2ccc3c4c(ccc(c24)C1=O)C(=O)N(c1c(C)cccc1CC)C3=O ; CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O ; CC1NN(c2ccccc2)C(=O)C1=C1C=C(C(C)(C)C)C(=O)C(C(C)(C)C)=C1]

The amount of the electron transport material is preferably at least 5 parts by mass and no greater than 150 parts by mass relative to 100 parts by mass of the binder resin (SL) (or relative to 100 parts by mass of the binder resin (CG)), more preferably at least 10 parts by mass and no greater than 100 parts by mass, and further preferably at least 30 parts by mass and no greater than 70 parts by mass. The first photosensitive layer may contain only one electron transport material or may contain two or more electron transport materials.

(Hole Transport Material)

Examples of the hole transport material include triphenylamine derivatives, diamine derivatives (e.g., an N,N,N′,N′-tetraphenylbenzidine derivative, an N,N,N′,N′-tetraphenylphenylenediamine derivative, an N,N,N′,N′-tetraphenylnaphtylenediamine derivative, an N,N,N′,N′-tetraphenylphenanthrylenediamine derivative, and a di(aminophenylethenyl)benzene derivative), oxadiazole-based compounds (e.g., 2,5-di(4-methylaminophenyl)-1,3,4-oxadiazole), styryl-based compounds (e.g., 9-(4-diethylaminostyryl)anthracene), carbazole-based compounds (e.g., polyvinyl carbazole), organic polysilane compounds, pyrazoline-based compounds (e.g., 1-phenyl-3-(p-dimethylaminophenyl)pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compounds. Each of the single-layer photosensitive layer, the charge generating layer, and the charge transport layer may contain only one hole transport material or may contain two or more hole transport materials. The hole transport material (CG) contained in the charge generating layer and the hole transport material (CT) contained in the charge transport layer may be the same as or different from one another.

Preferable examples of the hole transport material include compounds represented by formulas (20), (21), (22), (23), (24), and (25) (also referred to below as hole transport materials (20), (21), (22), (23), (24), and (25), respectively). As a result of the photosensitive layer containing any of the hole transport materials (20), (21), (22), (23), (24), and (25) together with the polyarylate resin (PA), the photosensitive layer can be further favorably formed and anti-fogging property of the photosensitive member is further improved. Preferably, the photosensitive layer contains the hole transport material (20), (21), (22), (23), or (24). Each of the hole transport materials (20), (21), (22), (23), and (24) is excellent in compatibility with the polyarylate resin (PA), thereby improving abrasion resistance and sensitivity characteristics of the photosensitive member in addition to anti-fogging property.

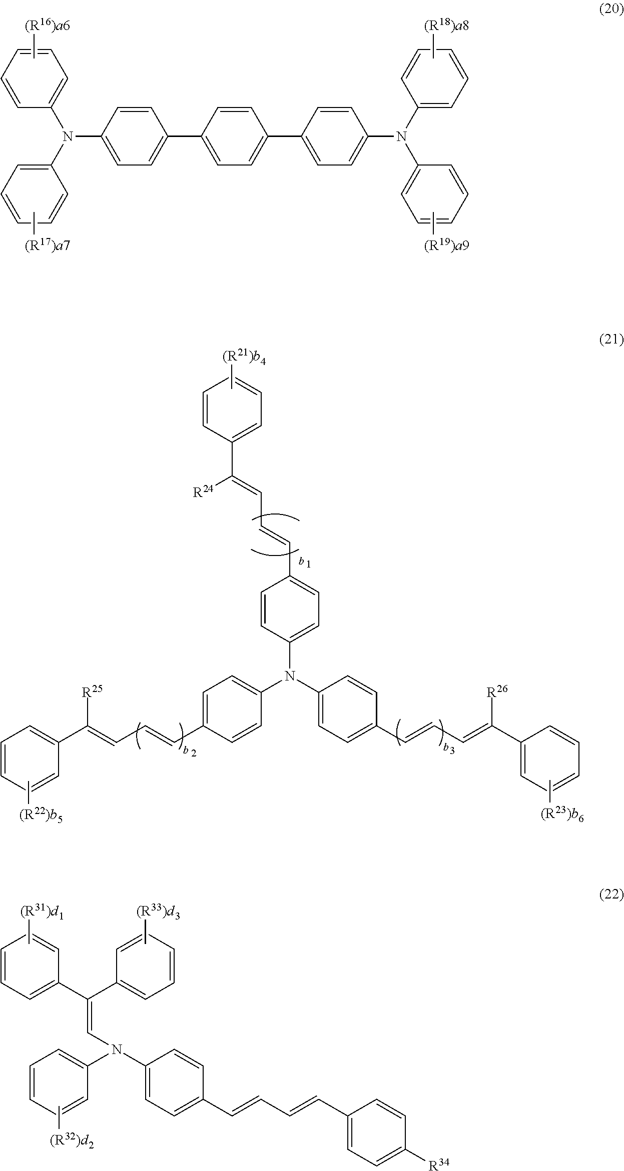

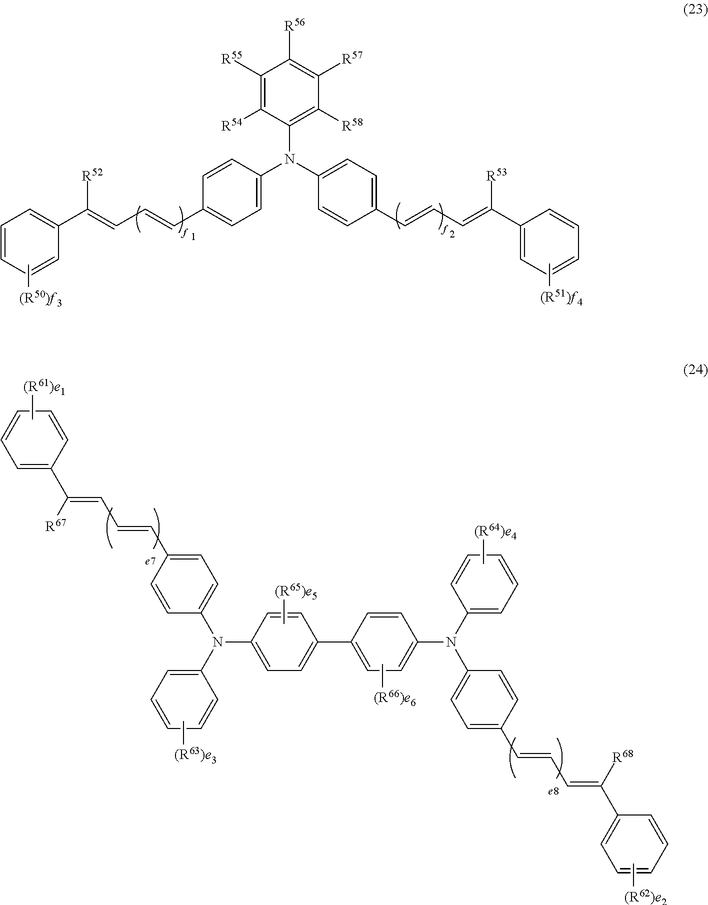

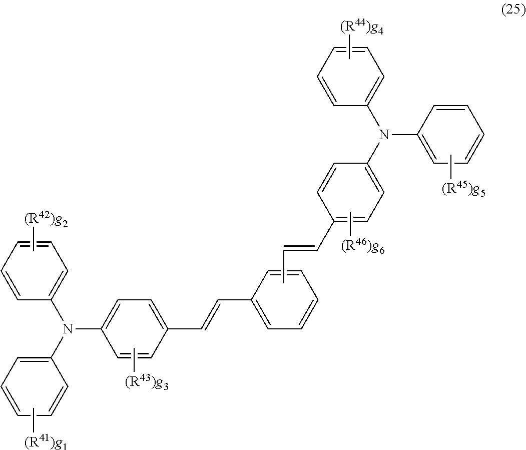

In formula (20), R¹⁶, R¹⁷, R¹⁸, and R¹⁹ each represent, independently of one another, an alkyl group with a carbon number of at least 1 and no greater than 6. a6, a7, a8, and a9 each represent, independently of one another, an integer of at least 0 and no greater than 5.

In formula (20), where a6 represents an integer of at least 2 and no greater than 5, the chemical groups R⁶ may represent the same group as or different groups from one another. Where a7 represents an integer of at least 2 and no greater than 5, the chemical groups R may represent the same group as or different groups from one another. Where a8 represents an integer of at least 2 and no greater than 5, the chemical groups R¹⁸ may represent the same group as or different groups from one another. Where a9 represents an integer of at least 2 and no greater than 5, the chemical groups R¹⁹ may represent the same group as or different groups from one another.

In formula (20), R¹⁶, R¹⁷, R¹⁸, and R¹⁹ each represent, independently of one another, preferably an alkyl group with a carbon number of at least 1 and no greater than 3, and more preferably a methyl group or an ethyl group. a6, a7, a8, and a9 each represent, independently of one another, preferably an integer of at least 1 and no greater than 3, and more preferably represent 1.

In formula (21), R²¹, R²² and R²³ each represent, independently of one another, an alkyl group with a carbon number of at least 1 and no greater than 6. R²⁴, R^{2S}, and R²⁶ each represent, independently of one another, a hydrogen atom, an alkyl group with a carbon number of at least 1 and no greater than 6, or an aryl group with a carbon number of at least 6 and no greater than 14. b₁, b₂, and b₃ each represent, independently of one another, 0 or 1. b₄, b₅, and b₆ each represent, independently of one another, an integer of at least 0 and no greater than 5.

In formula (21), R²¹, R²², and R²³ each represent, independently of one another, preferably an alkyl group with a carbon number of at least 1 and no greater than 3, and more preferably a methyl group. R²¹, R²², and R²³ are preferably bonded at the meta position of a phenyl group relative to an ethenyl group or a butadienyl group. Preferably, R²⁴, R^{2S}, and R²⁶ each represent a hydrogen atom. Preferably, b₁, b₂, and b3 each represent 0 or each represent 1. Preferably, b₄, b₅, and b₆ each represent 1.

In formula (22), R³¹, R³², and R³³ each represent, independently of one another, an alkyl group with a carbon number of at least 1 and no greater than 6. R³⁴ represents a hydrogen atom or an alkyl group with a carbon number of at least 1 and no greater than 6. d₁, d₂, and d₃ each represent, independently of one another, an integer of at least 0 and no greater than 5.

In formula (22), where d₁ represents an integer of at least 2 and no greater than 5, the chemical groups R³¹ may be the same group as or different groups from one another. Where d₂ represents an integer of at least 2 and no greater than 5, the chemical groups R³² may represent the same group as or different groups from one another. Where d₃ represents an integer of at least 2 and no greater than 5, the chemical groups R³³ may represent the same group as or different groups from one another.

In formula (22), R³⁴ preferably represents a hydrogen atom. Preferably, d₁, d₂, and d₃ each represent 0.

In formula (23), R⁵⁰ and R⁵¹ each represent, independently of one another, a phenyl group, an alkyl group with a carbon number of at least 1 and no greater than 6, or an alkoxy group with a carbon number of at least 1 and no greater than 6. R⁵², R⁵³, R⁵⁴, R⁵⁵, R⁵⁶, R⁵⁷, and R⁵⁸ each represent, independently of one another, a hydrogen atom, an alkyl group with a carbon number of at least 1 and no greater than 6, an alkoxy group with a carbon number of at least 1 and no greater than 6, or a phenyl group optionally substituted with an alkyl group with a carbon number of at least 1 and no greater than 6. f₁ and f₂ each represent, independently of one another, an integer of at least 0 and no greater than 2. f₃ and f₄ each represent, independently of one another, an integer of at least 0 and no greater than 5.

In formula (23), where f₃ represents an integer of at least 2 and no greater than 5, the chemical groups R⁵⁰ may be the same group as or different groups from one another. Where f₄ represents an integer of at least 2 and no greater than 5, the chemical groups R₅₁ may represent the same group as or different groups from one another.

In formula (23), R⁵⁰ and R⁵¹ each represent, independently of one another, preferably an alkyl group with a carbon number of at least 1 and no greater than 6. Preferably, R⁵¹ and R⁵³ each represent a hydrogen atom or a phenyl group optionally substituted with an alkyl group with a carbon number of at least 1 and no greater than 6. Preferably, R⁵⁴ to R₅₈ each represent, independently of one another, a hydrogen atom, an alkyl group with a carbon number of at least 1 and no greater than 6, or an alkoxy group with a carbon number of at least 1 and no greater than 6. Preferably, f₁ and f₂ each represent 0, each represent 1, or each represent 2. Preferably, f₃ and f₄ each represent, independently of one another, 0 or 1.

In formula (23), the alkyl group with a carbon number of at least 1 and no greater than 6 represented by R⁵⁰ and R⁵¹ is preferably an alkyl group with a carbon number of at least 1 and no greater than 3, and more preferably a methyl group. The phenyl group optionally substituted with an alkyl group with a carbon number of at least 1 and no greater than 6 and represented by R⁵² and R⁵³ is preferably a phenyl group or a phenyl group substituted with an alkyl group with a carbon number of at least 1 and no greater than 3. The phenyl group substituted with an alkyl group with a carbon number of at least 1 and no greater than 3 is preferably a methylphenyl group, and more preferably a 4-methylphenyl group. The alkyl group with a carbon number of at least 1 and no greater than 6 represented by R⁵⁴ to R⁵⁸ is preferably an alkyl group with a carbon number of at least 1 and no greater than 4, and more preferably a methyl group, an ethyl group, or an n-butyl group. The alkoxy group with a carbon number of at least 1 and no greater than 6 represented by R⁵⁴ to R⁵⁸ is preferably an alkoxy group with a carbon number of at least 1 and no greater than 3, and more preferably an ethoxy group.

In formula (24), R⁶¹, R⁶², R⁶³, R⁶⁴, R⁶⁵, and R⁶⁶ each represent, independently of one another, a phenyl group or an alkyl group with a carbon number of at least 1 and no greater than 8. R⁶⁷ and R⁶⁸ each represent, independently of one another, a hydrogen atom, a phenyl group, or an alkyl group with a carbon number of at least 1 and no greater than 8. e1, e2, e3, and e4 each represent, independently of one another, an integer of at least 0 and no greater than 5. e5 and e6 each represent, independently of one another, an integer of at least 0 and no greater than 4. e7 and e8 each represent, independently of one another, 0 or 1.

In formula (24), where e1 represents an integer of at least 2 and no greater than 5, the chemical groups R⁶¹ may represent the same group as or different groups from one another. Where e2 represents an integer of at least 2 and no greater than 5, the chemical groups R⁶² may represent the same group as or different groups from one another. Where e3 represents an integer of at least 2 and no greater than 5, the chemical groups R⁶³ may represent the same group as or different groups from one another. Where e4 represents an integer of at least 2 and no greater than 5, the chemical groups R⁶ may represent the same group as or different groups from one another. Where e5 represents an integer of at least 2 and no greater than 4, the chemical groups R⁶⁵ may represent the same group as or different groups from one another. Where e6 represents an integer of at least 2 and no greater than 4, the chemical groups R⁶⁶ may represent the same group as or different groups from one another.

In formula (24), R⁶¹ to R⁶⁶ each represent, independently of one another, preferably an alkyl group with a carbon number of at least 1 and no greater than 8, more preferably an alkyl group with a carbon number of at least 1 and no greater than 3, and further preferably a methyl group or an ethyl group. Preferably, R⁶⁷ and R⁶¹ each represent a hydrogen atom. Preferably, e1, e2, e3, and e4 each represent, independently of one another, an integer of at least 0 and no greater than 2. Preferably, e5 and e6 each represent 0.

In formula (25), R⁴¹, R⁴² R⁴³, R⁴⁴, R⁴⁵, and R⁴⁶ each represent, independently of one another, a phenyl group, an alkyl group with a carbon number of at least 1 and no greater than 8, or an alkoxy group with a carbon number of at least 1 and no greater than 8. g1, g2, g4, and g5 each represent, independently of one another, an integer of at least 0 and no greater than 5. g3 and g6 each represent, independently of one another, an integer of at least 0 and no greater than 4.

In formula (25), where g1 represents an integer of at least 2 and no greater than 5, the chemical groups R⁴¹ may represent the same group as or different groups from one another. Where g2 represents an integer of at least 2 and no greater than 5, the chemical groups R⁴² may represent the same group as or different groups from one another. Where g4 represents an integer of at least 2 and no greater than 5, the chemical groups R⁴⁴ may represent the same group as or different groups from one another. Where g5 represents an integer of at least 2 and no greater than 5, the chemical groups R⁴⁵ may represent the same group as or different groups from one another. Where g3 represents an integer of at least 2 and no greater than 4, the chemical groups R⁴³ may represent the same group as or different groups from one another. Where g6 represents an integer of at least 2 and no greater than 4, the chemical groups R⁴⁶ may represent the same group as or different groups from one another.

In formula (25), R⁴¹ to R⁴⁶ each represent, independently of one another, preferably an alkyl group with a carbon number of at least 1 and no greater than 8, more preferably an alkyl group with a carbon number of at least 1 and no greater than 3, and further preferably a methyl group or an ethyl group. Preferably, g1, g2, g4, and g5 each represent, independently of one another, an integer of at least 0 and no greater than 2. Preferably, g3 and g6 each represent 0. A diphenylaminophenylethenyl group having R⁴⁴, R⁴⁵, and R⁴⁶ is preferably bonded at the para position of a phenyl group relative to the diphenylaminophenylethenyl group having R⁴¹, R⁴², and R⁴³.

More preferable examples of the hole transport material include compounds represented by formulas (H-1) to (H-11) (also referred to below as hole transport materials (H-1) to (H-11), respectively).

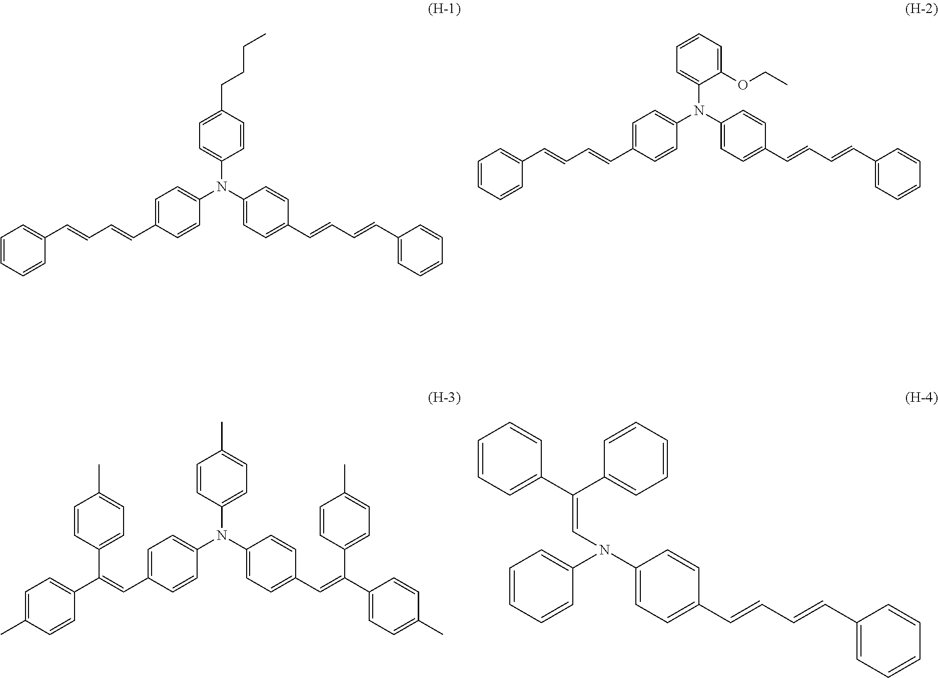

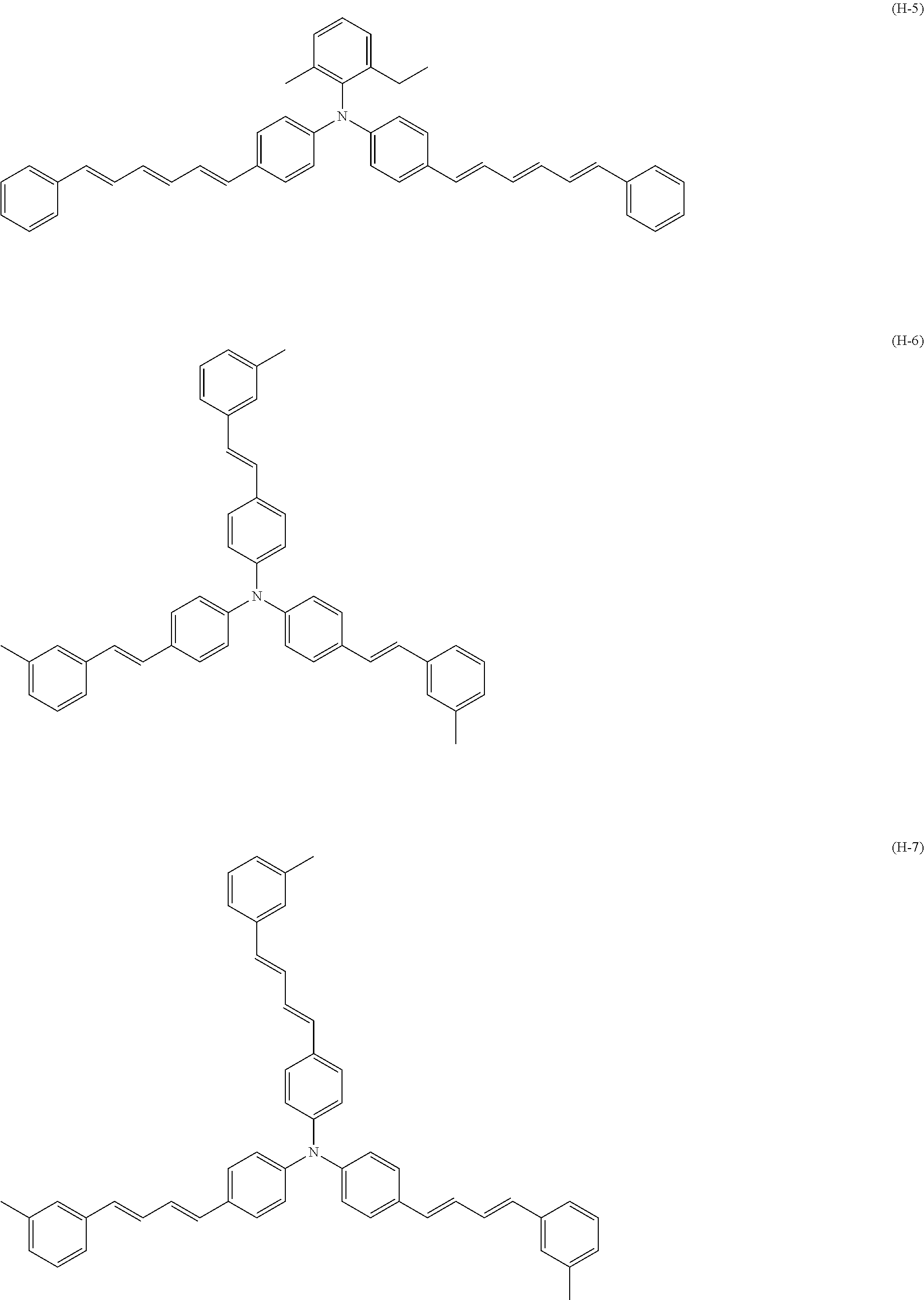 [SMILES: CCc1cccc(C)c1N(c1ccc(/C=C/C=C/C=C/c2ccccc2)cc1)c1ccc(/C=C/C=C/C=C/c2ccccc2)cc1 ; Cc1cccc(/C=C/c2ccc(N(c3ccc(/C=C/c4cccc(C)c4)cc3)c3ccc(/C=C/c4cccc(C)c4)cc3)cc2)c1 ; Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1]

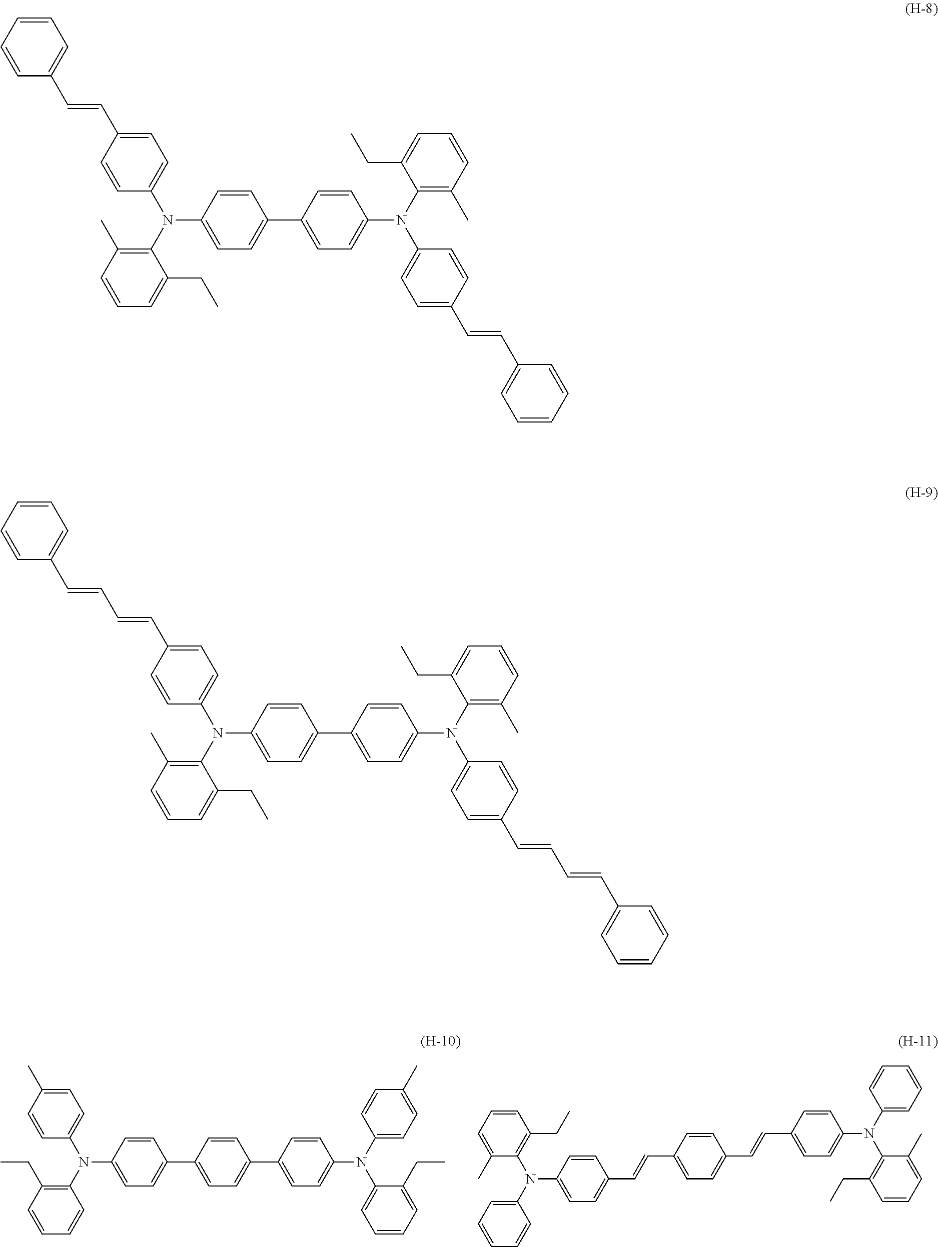

Each of the amount of the hole transport material (SL) relative to 100 parts by mass of the binder resin (SL), the amount of the hole transport material (CG) relative to 100 parts by mass of the binder resin (CG), and the amount of the hole transport material (CT) relative to 100 parts by mass of the binder resin (CT) is preferably at least 10 parts by mass and no greater than 200 parts by mass, more preferably at least 50 parts by mass and no greater than 150 parts by mass, and further preferably at least 70 parts by mass and no greater than 130 parts by mass.

(Charge Generating Material)

Examples of the charge generating material include a phthalocyanine pigment, a perylene-based pigment, a bisazo pigment, a tris-azo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, powders of inorganic photoconductive materials (e.g., selenium, selenium-tellurium, selenium-arsenic, cadmium sulfide, and amorphous silicon), a pyrylium pigment, an anthanthrone-based pigment, a triphenylmethane-based pigment, a threne-based pigment, a toluidine-based pigment, a pyrazoline-based pigment, and a quinacridone-based pigment. Each of the single-layer photosensitive layer and the charge generating layer may contain only one charge generating material or may contain two or more charge generating materials.

The phthalocyanine-based pigment is a pigment with a phthalocyanine structure. Examples of the phthalocyanine-based pigment include metal phthalocyanine and metal-free phthalocyanine. Examples of the metal phthalocyanine include titanyl phthalocyanine, hydroxygallium phthalocyanine, and chlorogallium phthalocyanine. The metal-free phthalocyanine is represented by formula (CGM-1). Titanyl phthalocyanine is represented by formula (CGM-2).

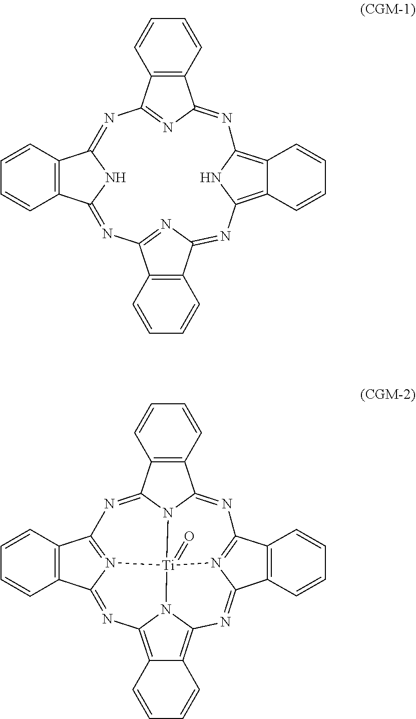

The phthalocyanine-based pigment may be crystalline or non-crystalline. An example of crystal of metal-free phthalocyanine is X-form crystal of metal-free phthalocyanine (also referred to below as X-form metal-free phthalocyanine). Examples of crystal of titanyl phthalocyanine include α-form, β-form, and Y-form crystals of titanyl phthalocyanine (also referred to below as α-form, β-form, and Y-form titanyl phthalocyanines, respectively).

For example, a photosensitive member sensitive in a wavelength range of at least 700 nm is preferably used in a digital optical image forming apparatus (e.g., a laser beam printer or facsimile machine with a light source such as a semiconductor laser). In terms of high quantum yield in a wavelength range of at least 700 nm, the charge generating material is preferably a phthalocyanine-based pigment, more preferably metal-free phthalocyanine or titanyl phthalocyanine, further preferably titanyl phthalocyanine, and particularly preferably Y-form titanyl phthalocyanine.

Y-form titanyl phthalocyanine exhibits a main peak at a Bragg angle (20+0.2°) of 27.2° in a CuKα characteristic X-ray diffraction spectrum, for example. The term “main peak” refers to a peak in the CuKα characteristic X-ray diffraction spectrum having a highest or second highest intensity in a range of Bragg angles (20+0.2°) from 30 to 40°. Y-form titanyl phthalocyanine has no peaks at 26.2° in the CuKα characteristic X-ray diffraction spectrum.

The CuKα characteristic X-ray diffraction spectrum can be measured by the following method, for example. A sample (titanyl phthalocyanine) is loaded into a sample holder of an X-ray diffraction spectrometer (e.g., a product of Rigaku Corporation, “RINT (registered Japanese trademark) 1100”) and an X-ray diffraction spectrum is measured using a Cu X-ray tube under conditions of a tube voltage of 40 kV, a tube current of 30 mA, and a wavelength of CuKα characteristic X-rays of 1.542 Å. The measurement range (20) is for example from 3° to 40° (start angle: 3°, stop angle: 40°), and the scanning speed is for example 10°/min. A main peak in the obtained X-ray diffraction spectrum is determined and a Bragg angle of the main peak is read.

Each of the amount of the charge generating material relative to 100 parts by mass of the binder resin (SL) and the amount of the charge generating material relative to 100 parts by mass of the binder resin (CG) is preferably at least 0.1 parts by mass and no greater than 50 parts by mass, and more preferably at least 0.5 parts by mass and no greater than 5 parts by mass.

(Additive)

Examples of the additive include an ultraviolet absorbing agent, an antioxidant, a radical scavenger, a singlet quencher, a softener, a surface modifier, an extender, a thickener, a dispersion stabilizer, a wax, a donor, a surfactant, a plasticizer, a sensitizer, an electron acceptor compound, and a leveling agent.

(Scratch Resistance Depth)

Preferably, the first photosensitive layer has a scratch resistance depth of no greater than 0.50 μm. The scratch resistance depth of the first photosensitive layer is a value indicating a hardness of the first photosensitive layer. The scratch resistance depth of the first photosensitive layer being no greater than 0.50 μm means the first photosensitive layer being hard enough such that a scratch with a scratch resistance depth of no greater than 0.50 μm is formed on the surface of the first photosensitive layer by a later-described scratch resistance depth measurement method. As a result of the first photosensitive layer having a scratch resistance depth of no greater than 0.50 μm, microscopic scratches are hardly formed on the surface of the photosensitive member. Accordingly, toner is inhibited from entering such scratches on the surface of the photosensitive member to inhibit occurrence of fogging in formed images. Also, as a result of the first photosensitive layer having a scratch resistance depth of no greater than 0.50 μm, abrasion resistance of the photosensitive member is improved. In order to improve anti-fogging property, the scratch resistance depth of the first photosensitive layer is preferably at least 0.00 μm and no greater than 0.50 μm, more preferably at least 0.05 μm and no greater than 0.40 μm, and further preferably at least 0.10 μm and no greater than 0.30 μm.

The scratch resistance depth of the first photosensitive layer is measured according to the following method. The scratch resistance depth of the first photosensitive layer is measured by performing a first step, a second step, a third step, and a fourth step using a scratching apparatus defined in the Japanese Industrial Standards (JIS) K5600-5-5. The scratching apparatus includes a fixing table and a scratching stylus. The scratching stylus has a hemi-spherical sapphire tip end with a diameter of 1 mm. In the first step, the photosensitive member is fixed on the upper surface of the fixing table such that the longitudinal direction of the photosensitive member is parallel to the longitudinal direction of the fixing table. In the second step, the scratching stylus is brought into perpendicular contact with the surface of the first photosensitive layer. In the third step, a scratch is formed on the surface of the first photosensitive layer using the scratching stylus in a manner that the fixing table and the photosensitive member fixed on the upper surface of the fixing table are moved in the longitudinal direction of the fixing table by 30 mm at a speed of 30 mm/min. while 10 g of a load is applied to the first photosensitive layer through the scratching stylus in a state in which the scratching stylus is kept in perpendicular contact with the surface of the first photosensitive layer. In the fourth step, a scratch resistance depth that is a maximum depth of the scratch is measured. The outline of the scratch resistance depth measurement method has been described so far. The scratch resistance depth measurement method will be described in detail in Examples.

The scratch resistance depth of the first photosensitive layer can be adjusted by changing the type of the binder resin, for example. Alternatively or additionally, the scratch resistance depth of the first photosensitive layer can be adjusted by changing the ratio of the mass of the binder resin to the mass of the first photosensitive layer, for example.

(Strain at Break)

The first photosensitive layer has a strain at break of preferably at least 7.5% and no greater than 21.0%, and more preferably at least 14.0% and no greater than 21.0%. As a result of the first photosensitive layer having a strain at break of at least 7.5%, anti-fogging property and abrasion resistance of the photosensitive member are improved. As a result of the first photosensitive layer having a strain at break of no greater than 21.0%, anti-fogging property of the photosensitive member is improved. The strain at break of the first photosensitive layer is a value obtained from a stress-strain curve that is measured when the first photosensitive layer is pulled at a tensile speed of 5 mm/min. using a tensile tester. The strain at break of the first photosensitive layer is measured by a method described in Examples described later, for example. The strain at break is adjusted by changing the type of the binder resin and the viscosity average molecular weight of the binder resin, for example.

(Vickers Hardness)

The first photosensitive layer has a Vickers hardness of preferably at least 19.0 HV, and more preferably at least 20.0 HV. As a result of the first photosensitive layer having a Vickers hardness of at least 19.0 HV, anti-fogging property of the photosensitive member is improved. No particular limitations are placed on the upper limit of the Vickers hardness of the first photosensitive layer, and the Vickers hardness is no greater than 25.0 HV, for example. The Vickers hardness of the first photosensitive layer is measured by a method in compliance with the Japanese Industrial Standards (JIS) Z2244. The Vickers hardness of the first photosensitive layer is adjusted by changing the type of the binder resin and the type of the hole transport material, for example.

(Conductive Substrate)

No particular limitations are placed on the conductive substrate, and it is only required that at least a surface portion of the conductive substrate be constituted by a conductive material. An example of the conductive substrate is a conductive substrate made from a conductive material. Another example of the conductive substrate is a substrate covered with a conductive material. Examples of the conductive material include aluminum, iron, copper, tin, platinum, silver, vanadium, molybdenum, chromium, cadmium, titanium, nickel, palladium, indium, stainless steel, and brass. In terms of excellent mobility of electric charge from the photosensitive layer to the conductive substrate, aluminum or an aluminum alloy is preferable among the conductive materials listed above.

The shape of the conductive substrate is appropriately selected according to the configuration of an image forming apparatus including the conductive substrate. Examples of the shape of the conductive substrate include a sheet-like shape and a drum-like shape. Thickness of the conductive substrate is also appropriately selected according to the shape of the conductive substrate.

(Intermediate Layer)

The intermediate layer (undercoat layer) contains for example inorganic particles and a resin for intermediate layer use (intermediate layer resin). In presence of the intermediate layer, electric current generated at exposure of the photosensitive member can smoothly flow while an insulation state to an extent that occurrence of leakage current can be inhibited is maintained, thereby suppressing an increase in electric resistance.

Examples of the inorganic particles include particles of metals (e.g., aluminum, iron, and copper), particles of metal oxides (e.g., titanium oxide, alumina, zirconium oxide, tin oxide, and zinc oxide), and particles of non-metal oxides (e.g., silica).

Examples of the intermediate layer resin are the same as those listed as the examples of the additional binder resin as described previously. In order to favorably form the intermediate layer and the photosensitive layer, the intermediate layer resin is preferably different from the binder resin contained in the photosensitive layer. The intermediate layer may contain an additive. Examples of the additive contained in the intermediate layer are the same as those listed as the examples of the additive contained in the photosensitive layer.

(Photosensitive Member Production Method)

The following describes an example of a single-layer photosensitive member production method and an example of a positively chargeable multi-layer photosensitive member production method each as a photosensitive member production method.

The single-layer photosensitive member production method includes a single-layer photosensitive layer formation process, for example. In the single-layer photosensitive layer formation process, an application liquid (also referred to below as application liquid for single-layer photosensitive layer formation) for forming a single-layer photosensitive layer is prepared. The application liquid for single-layer photosensitive layer formation is applied onto a conductive substrate. Next, at least a portion of a solvent contained in the applied application liquid for single-layer photosensitive layer formation is removed to form a single-layer photosensitive layer. The application liquid for single-layer photosensitive layer formation contains the charge generating material, the binder resin (SL), the electron transport material, the hole transport material (SL), and the solvent, for example. The application liquid for single-layer photosensitive layer formation is prepared by dissolving or dispersing the charge generating material, the binder resin (SL), the electron transport material, and the hole transport material (SL) in the solvent. The application liquid for single-layer photosensitive layer formation may further contain an additive as necessary.

The positively chargeable multi-layer photosensitive member production method includes a charge transport layer formation process and a charge generating layer formation process, for example.

In the charge transport layer formation process, an application liquid for charge transport layer formation is applied onto a conductive substrate. Next, at least a portion of a solvent contained in the applied application liquid for charge transport layer formation is removed to form a charge transport layer. The application liquid for charge transport layer formation contains the hole transport material (CT), the binder resin (CT), and the solvent. The application liquid for charge transport layer formation is prepared by dissolving or dispersing the hole transport material (CT) and the binder resin (CT) in the solvent. The application liquid for charge transport layer formation may further contain an additive as necessary.

In the charge generating layer formation process, an application liquid for charge generating layer formation is applied onto the charge transport layer. Next, at least a portion of a solvent contained in the applied application liquid for charge generating layer formation is removed to form a charge generating layer. The application liquid for charge generating layer formation contains the charge generating material, the binder resin (CG), the electron transport material, the hole transport material (CG), and the solvent, for example. The application liquid for charge generating layer formation is prepared by dissolving or dispersing the charge generating material, the binder resin (CG), the electron transport material, and the hole transport material (CG) in the solvent. The application liquid for charge generating layer formation may further contain an additive as necessary.

No particular limitations are placed on the solvents contained in the application liquid for single-layer photosensitive layer formation, the application liquid for charge generating layer formation, and the application liquid for charge transport layer formation (each also referred generally to below as application liquid) so long as each solvent can dissolve or disperse each component contained in a corresponding one of the application liquids. Examples of the solvents include alcohols (specific examples include methanol, ethanol, isopropanol, and butanol), aliphatic hydrocarbons (specific examples include n-hexane, octane, and cyclohexane), aromatic hydrocarbons (specific examples include benzene, toluene, and xylene), halogenated hydrocarbons (specific examples include dichloromethane, dichloroethane, carbon tetrachloride, and chlorobenzene), ethers (specific examples include dimethyl ether, diethyl ether, tetrahydrofuran, ethylene glycol dimethyl ether, and diethylene glycol dimethyl ether), ketones (specific examples include acetone, methyl ethyl ketone, and cyclohexanone), esters (specific examples include ethyl acetate and methyl acetate), dimethyl formaldehyde, dimethyl formamide, and dimethyl sulfoxide.

Preferably, the solvent contained in the application liquid for charge transport layer formation differs from the solvent contained in the application liquid for charge generating layer formation. This is because it is desirable that the charge transport layer does not dissolve in the solvent of the application liquid for charge generating layer formation when the application liquid for charge generating layer formation is applied onto the charge transport layer.

Each of the application liquids is prepared by mixing the corresponding components in order to disperse the components in the corresponding solvent. Mixing or dispersion can for example be performed using a bead mill, a roll mill, a ball mill, an attritor, a paint shaker, or an ultrasonic disperser.

The method for applying each application liquid is not particularly limited so long as the application liquid can be applied uniformly. Examples of the application method include dip coating, spray coating, spin coating, and bar coating.

Examples of a method for removing at least a portion of the solvent contained in each application liquid include heating, pressure reduction, and a combination of heating and pressure reduction. One specific example of the method involves heat treatment (hot-air drying) using a high-temperature dryer or a reduced pressure dryer. The temperature of the heat treatment is at least 40° C. and no greater than 150° C., for example. The time of the heat treatment is at least 3 minutes and no greater than 120 minutes, for example.

The photosensitive member production method may further include either or both an intermediate layer formation process and a protective layer formation process as necessary. Any known method can be selected as appropriate as the intermediate layer formation process or the protective layer formation process.

### Second Embodiment: Image Forming Apparatus

The following describes an image forming apparatus according to a second embodiment of the present disclosure. The image forming apparatus will be described with reference to FIG. 7 using a tandem color image forming apparatus as an example. FIG. 7 is a cross-sectional view of an example of the image forming apparatus.

An image forming apparatus 100 illustrated in FIG. 7 includes image forming units 40a, 40b, 40c, and 40d, a transfer belt 50, and a fixing device 54. Each of the image forming units 40a. 40b, 40c, and 40d is referred below to as image forming unit 40 where it is not necessary to distinguish among the image forming units 40a to 40d.

Each of the image forming units 40 includes an image bearing member 30, a charger 42, a light exposure device 44, a development device 46, and a transfer device 48. The image bearing member 30 is the photosensitive member (specifically, the single-layer photosensitive member 1 or the positively chargeable multi-layer photosensitive member 10) of the first embodiment.

As described previously, anti-fogging property can be improved through use of the photosensitive member of the first embodiment. As such, as a result of including the photosensitive member of the first embodiment as the image bearing member 30, the image forming apparatus 100 can form an image with less fogging on a recording medium P.

The image bearing member 30 is disposed at a central part of each image forming unit 40. The image bearing member 30 is rotatable in an arrowed direction (anticlockwise direction) in FIG. 7. The charger 42, the light exposure device 44, the development device 46, and the transfer device 48 are disposed around the image bearing member 30 in the stated order from upstream in the rotational direction of the image bearing member 30.

Toner images in multiple colors (e.g., four colors of black, cyan, magenta, and yellow) are sequentially superimposed by the image forming units 40a to 40d one on the other on a recording medium P placed on the transfer belt 50.

The charger 42 charges the surface (e.g., the circumferential surface) of the image bearing member 30 to a positive polarity. In both a case in which the image bearing member 30 is the single-layer photosensitive member 1 and a case in which the image bearing member 30 is the positively chargeable multi-layer photosensitive member 10, the surface of the image bearing member 30 is charged to the positive polarity. The charger 42 is a charging roller, for example.

The light exposure device 44 irradiates the charged surface of the image bearing member 30 with exposure light. That is, the light exposure device 44 exposes the charged surface of the image bearing member 30 to light. An electrostatic latent image is formed on the surface of the image bearing member 30 in the manner described above. The electrostatic latent image is formed based on image data input to the image forming apparatus 100.

The development device 46 develops the electrostatic latent image into a toner image by supplying toner to the surface of the image bearing member 30. The development device 46 (e.g., the surface of the development device 46, more specifically, the circumferential surface of the development device 46) is in contact with the surface of the image bearing member 30. That is, the image forming apparatus 100 adopts a contact development process. The development device 46 is a development roller, for example. In a case in which the developer is a one-component developer, the development device 46 supplies toner, which is the one-component developer, to the electrostatic latent image formed on the image bearing member 30. In a case in which the developer is a two-component developer, the development device 46 supplies toner of the two-component developer including the toner and a carrier to the electrostatic latent image formed on the image bearing member 30. The image bearing member 30 carries the toner image in the manner described above.

The transfer belt 50 conveys the recording medium P between the image bearing member 30 and the transfer device 48. The transfer belt 50 is an endless belt. The transfer belt 50 circulates in an arrowed direction (clockwise direction) in FIG. 7.

The transfer device 48 transfers the toner image developed by the development device 46 from the surface of the image bearing member 30 to a transfer target. The transfer target is the recording medium P. In transfer of the toner image, the image bearing member 30 is in contact with the recording medium P. That is, the image forming apparatus 100 adopts a direct transfer process. The transfer device 48 is a transfer roller, for example.

The recording medium P to which the toner images have been transferred by the transfer device 48 is conveyed to the fixing device 54 by the transfer belt 50. The fixing device 54 includes either or both a heating roller and a pressure roller, for example. Either or both heat and pressure are applied by the fixing device 54 to the unfixed toner images transferred by the transfer device 48. Application of either or both heat and pressure to the toner images fixes the toner image to the recording medium P. As a result, an image is formed on the recording medium P.

An example of the image forming apparatus has been described so far. However, the image forming apparatus is not limited to the previously-described image forming apparatus 100. The previously-described image forming apparatus 100 is a color image forming apparatus, but the image forming apparatus may be a monochrome image forming apparatus. In this case, the image forming apparatus may include only one image forming unit, for example. Furthermore, the previously-described image forming apparatus 100 is a tandem image forming apparatus, but the image forming apparatus may be a rotary image forming apparatus, for example. A charging roller is exemplified as the charger 42. However, the charger may be a charger (e.g., a scorotron charger, a charging brush, or a corotron charger) other than the charging roller. The previously-described image forming apparatus 100 adopts a contact development process. However, the image forming apparatus may adopt a non-contact development process. The previously-described image forming apparatus 100 adopts a direct transfer process. However, the image forming apparatus may adopt an intermediate transfer process. In a case in which the image forming apparatus adopts an intermediate transfer process, the transfer target corresponds to an intermediate transfer belt. In the image forming apparatus, the previously-described image forming units 40 each include no cleaning member but may each further include a cleaning member (e.g., a cleaning blade). Note that the previously-described image forming units 40 each include no static eliminators. However, the image forming units may each further include a static eliminator.

### Third Embodiment: Process Cartridge

With further reference to FIG. 7, a process cartridge according to a third embodiment of the present disclosure will be described next. The process cartridge corresponds to each of the image forming units 40a to 40d. The process cartridge includes the image bearing member 30. The image bearing member 30 is the photosensitive member of the first embodiment. As described previously, anti-fogging property can be improved through use of the photosensitive member of the first embodiment. As such, as a result of including the photosensitive member of the first embodiment as the image bearing member 30, the process cartridge can form an image with less fogging on a recording medium P. The process cartridge includes at least one selected from the group consisting of the charger 42, the light exposure device 44, the development device 46, and the transfer device 48 in addition to the image bearing member 30. The process cartridge may further include a cleaning member (not illustrated) and a static eliminator (not illustrated). The process cartridge is designed to be freely attachable to and freely detachable from the image forming apparatus 100. In the above configuration, the process cartridge can be easily handled. As a result, easy and speedy replacement of the process cartridge including the image bearing member 30 can be achieved in a situation in which sensitivity characteristics or the like of the image bearing member 30 degrade. The process cartridge including the photosensitive member of the first embodiment has been described so far with reference to FIG. 7.

### EXAMPLE

The following provides more specific description of the present disclosure through use of Examples. However, the present disclosure is not in any way limited to the scope of the examples.

### <Preparation of Polyarylate Resins (R-1) to (R-7) and (R-12) to (R-24)

Polyarylate resins (R-1) to (R-7) of Examples and polyarylate resins (R-12) to (R-24) of Comparative Examples were synthesized according to the methods described below. In the following, the “polyarylate resins (R-1) to (R-7) and (R-12) to (R-24)” may be also referred to below as “resins (R-1) to (R-7) and (R-12) to (R-24)”, respectively. Compositions of the respective resins (R-1) to (R-7) and (R-12) to (R-24) are shown below in Table 3.

TABLE 3

| | Bisphenol addition rate [%] | | | | | | Dicarboxylic acid addition rate [%] | | | |
|---|---|---|---|---|---|---|---|---|---|---|
| | BisCZ | BisB | BisC | BisZ | BisCE | DHPE | DPEC | TPC | IPC | |
| Monomer | Unit | Unit | Unit | Unit | Unit | Unit | Unit | Unit | Unit | |
| Resin | (1-1) | (1-2) | (BisC) | (BisZ) | (BisCE) | (3) | (2) | (4) | (IPC) | Terminator |
| R-1 | 80 | — | — | — | — | 20 | 65 | 35 | — | DMP |
| R-2 | — | 80 | — | — | — | 20 | 65 | 35 | — | DMP |
| R-3 | 80 | — | — | — | — | 20 | 50 | 50 | — | DMP |
| R-4 | 80 | — | — | — | — | 20 | 35 | 65 | — | DMP |
| R-5 | — | 80 | — | — | — | 20 | 50 | 50 | — | DMP |
| R-6 | 60 | — | — | — | — | 40 | 65 | 35 | — | DMP |
| R-7 | 80 | — | — | — | — | 20 | 65 | 35 | — | PFH |
| R-12 | 50 | — | — | — | — | 50 | 65 | 35 | — | DMP |
| R-13 | 80 | — | — | — | — | 20 | 100 | — | — | DMP |
| R-14 | 60 | — | — | — | — | 40 | 100 | — | — | DMP |
| R-15 | — | 80 | — | — | — | 20 | 100 | — | — | DMP |
| R-16 | — | — | — | 80 | — | 20 | 65 | 35 | — | DMP |
| R-17 | — | — | 80 | — | — | 20 | 65 | 35 | — | DMP |
| R-18 | — | 80 | — | — | — | 20 | 50 | 25 | 25 | DMP |
| R-19 | 80 | — | — | — | — | 20 | 25 | 75 | — | DMP |
| R-20 | 100 | — | — | — | — | — | 65 | 35 | — | DMP |
| R-21 | — | — | — | 100 | — | — | 50 | 30 | 20 | DMP |
| R-22 | 80 | — | — | — | — | 20 | 65 | — | 35 | DMP |
| R-23 | — | — | — | — | 70 | 30 | 100 | — | — | DMP |
| R-24 | 80 | — | — | — | — | 20 | — | 100 | — | DMP |

In Table 3, “BisCZ”, “BisB”, “BisC”, “BisZ”, “BisCE”, “DHPE”, “DPEC”, “TPC”, and “IPC” respectively refer to compounds represented by the following formulas (BisCZ), (BisB), (BisC), (BisZ), (BisCE), (DHPE), (DPEC), (TPC), and (IPC) (also referred to below as compounds (BisCZ), (BisB), (BisC), (BisZ), (BisCE), (DHPE), (DPEC), (TPC), and (IPC), respectively).

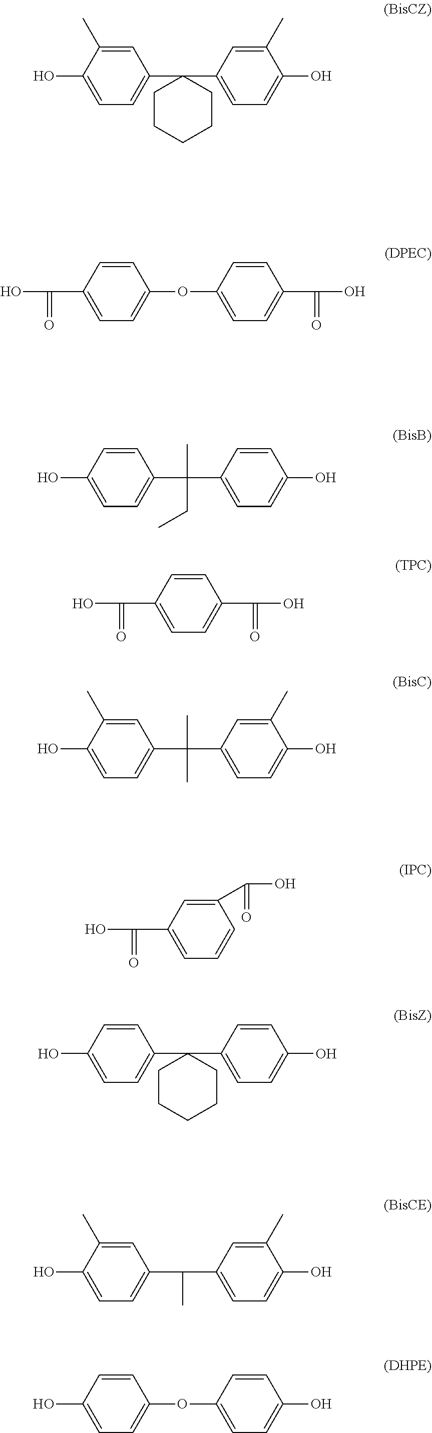

The terms in Table 3 mean as follows.

Monomer: monomer used for synthesis of corresponding polyarylate resin

Resin: polyarylate resin

Bisphenol addition rate: percentage (unit: %) of amount (unit: mol) of corresponding bisphenol monomer relative to total amount (unit: mol) of bisphenol monomers added in synthesis of corresponding polyarylate resin

Dicarboxylic acid addition rate: percentage (unit: %) of amount (unit: mol) of corresponding dicarboxylic acid monomer relative to total amount (unit: mol) of dicarboxylic acid monomers added in synthesis of corresponding polyarylate resin

Unit: repeating unit Note that the repeating units indicated in Table 3 are each formed from corresponding one of monomers indicated in Table 3.

Unit (BisC): repeating unit derived from compound (BisC)

Unit (BisZ): repeating unit derived from compound (BisZ)

Unit (BisCE): repeating unit derived from compound (BisCE)

Unit (IPC): repeating unit derived from compound (IPC)

DMP: 2,6-dimethylphenol

PFH: 1H,1H-perfluoro-1-heptanol

-: non-use of corresponding monomer

(Synthesis of Resin (R-1))

A three-necked flask equipped with a thermometer, a three-way cock, and a dropping funnel was used as a reaction vessel. The reaction vessel was charged with the compound (BisCZ) (32.8 mmol) being a monomer, the compound (DHPE) (8.2 mmol) being a monomer, 2,6-dimethylphenol (0.413 mmol) being a terminator, sodium hydroxide (98 mmol), and benzyltributylammonium chloride (0.384 mmol). The reaction vessel was purged with an argon gas. Water (300 mL) was added to the contents of the reaction vessel. The contents of the reaction vessel were stirred at 50° C. for 1 hours. The contents of the reaction vessel were cooled to 10° C. to yield an alkaline aqueous solution S-A.

Next, dicarboxylic acid dichloride (20.8 mmol) of the compound (DPEC) being a monomer and dicarboxylic acid dichloride (11.2 mmol) of the compound (TPC) being a monomer were dissolved in chloroform (150 mL). Through the above, a chloroform solution S-B was yielded.

Using the dropping funnel, the chloroform solution S-B was gradually dripped into the alkaline aqueous solution S-A over 110 minutes. A polymerization reaction was allowed to proceed by stirring the contents of the reaction vessel for 4 hours while the temperature (liquid temperature) of the contents of the reaction vessel was adjusted to 15±5° C. The upper layer (water layer) of the contents of the reaction vessel was removed using a decant to obtain an organic layer. Next, ion exchange water (400 mL) was added into a conical flask. The obtained organic layer was further added into the conical flask. Chloroform (400 mL) and acetic acid (2 mL) were further added into the conical flask. The contents of the conical flask were stirred for 30 minutes at room temperature (25° C.). The upper layer (water layer) of the contents of the conical flask was removed using a decant to obtain an organic layer. The obtained organic layer was washed with ion exchange water (1 L) using a separatory funnel. The washing with ion exchange water was repeated 5 times to obtain a washed organic layer. The washed organic layer was filtered to yield a filtrate. The resultant filtrate was gradually dripped into methanol (1 L) to yield a precipitate. The precipitate was taken out by filtration. The taken-out precipitate was vacuum-dried at a temperature of 70° C. for 12 hours. Through the above, a resin (R-1) with a viscosity average molecular weight of 56,000 was obtained.

Resins (R-1) with respective viscosity average molecular weights indicated in Tables 4 to 8 and 15 to 21 were obtained according to the same method as that for synthesis of the resin (R-1) with a viscosity average molecular weight of 56,000 in all aspects other than that the amount of the terminator was changed so that the resins (R-1) had respective viscosity average molecular weights indicated in Table 4 to 8 and 15 to 21. Note that the viscosity average molecular weight of each resin (R-1) increases as the amount of the terminator is increased.

(Synthesis of Resins (R-2) to (R-7) and (R-12) to (R-24))

The resins (R-2) to (R-7) and (R-12) to (R-24) were synthesized according to the same method as that for synthesis of the resin (R-1) in all aspects other than use of the monomers indicated in Table 3 in corresponding amounts in terms of addition rate indicated in Table 3. Note that the addition amount of each bisphenol monomer was set so that the total amount of the bisphenols was 41.0 mmol and corresponded to a corresponding bisphenol addition rate indicated in Table 3. For example, in synthesis of the resin (R-5), the addition amount of the compound (BisB) was 32.8 mmol (=41.0×80/100) and the addition amount of the compound (DHPE) was 8.2 mmol (=41.0×20/100). Furthermore, the addition amount of each dicarboxylic acid monomer was set so that the total amount of the dicarboxylic acid monomers was 32.0 mmol and corresponded to a corresponding dicarboxylic acid addition rate indicated in Table 3. For example, in synthesis of the resin (R-5), the addition amount of the compound (DPEC) was 16.0 mmol (=32.0×50/100) and the addition amount of the compound (TPC) was 16.0 mmol (=32.0×50/100).

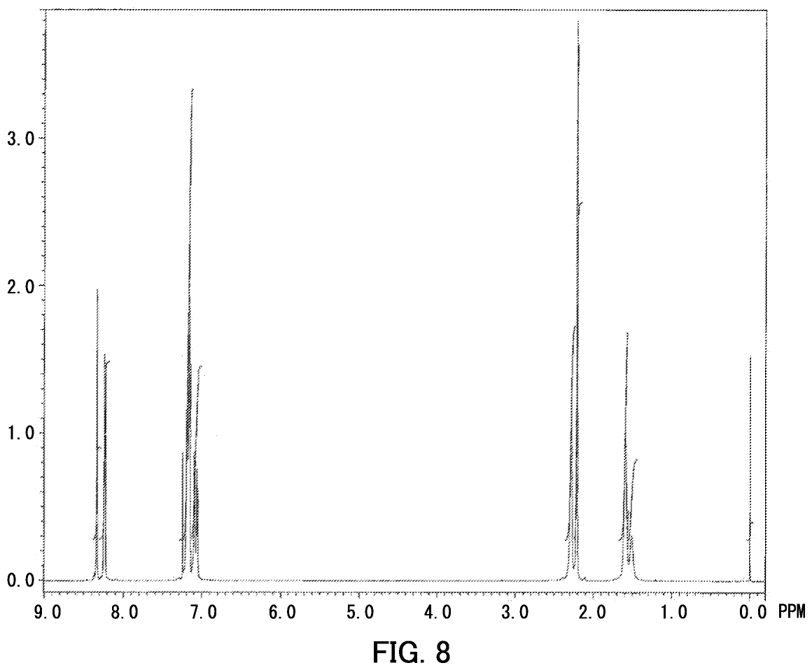

Each ¹H-NMR spectrum of the obtained resins (R-1) to (R-7) and (R-12) to (R-24) was plotted using a proton nuclear magnetic resonance spectrometer (product of JEOL Ltd., 600 MHz). Deuterated chloroform was used as a solvent. Tetramethylsilane (TMS) was used as an internal standard sample. The ¹H-NMR NMR of the resin (R-1) is shown in FIG. 8 as a typical example of the resins (R-1) to (R-7) and (R-12) to (R-24). It was confirmed from the chemical shift read from the ¹H-NMR spectrum that the resin (R-1) had been obtained. It was also confirmed by the same method that the resins (R-2) to (R-7) and (R-12) to (R-24) had been obtained.

### Polycarbonate Resins (R-8) to (R-10) and Polyarylate Resin (R-11)

Polycarbonate resins represented by formulas (R-8) to (R-10) and a polyarylate resin represented by formula (R-11) were prepared as binder resins used for production of photosensitive members of Comparative Examples. In the following, the “polycarbonate resins represented by formulas (R-8) to (R-10) and the polyarylate resin represented by formula (R-11)” may be also referred to below as “resins (R-8) to (R-11)”, respectively. m1 and m2 in formula (R-10) and n1, n2, n3, and n4 in formula (R-1l) each represent a percentage (unit: mol %) of the number of repeats of a corresponding repeating unit relative to the total number of repeats of repeating units included in a corresponding one of the resins. m1 and m2 in formula (R-10) were 50 mol % and 50 mol %, respectively. n1, n2, n3, and n4 in formula (R-11) were 25 mol %, 25 mol %, 25 mol %, and 25 mol %, respectively. Furthermore, the resins (R-8) to (R-11) had viscosity average molecular weights of 65,000, 58,000, 51,000, and 55,000, respectively.

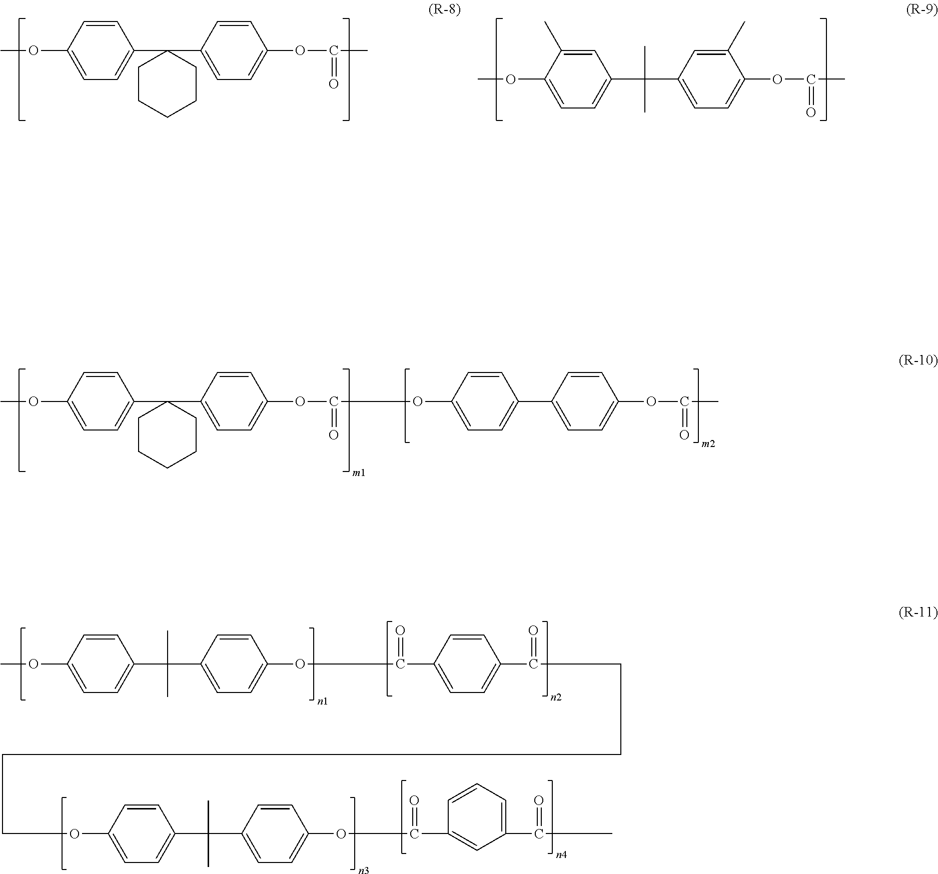

### Single-Layer Photosensitive Member Productio

(Production of Single-Layer Photosensitive Member (A-1))

A dispersion was yielded by mixing 2 parts by mass of Y-form titanyl phthalocyanine being a charge generating material, 70 parts by mass of the hole transport material (H-1) as the hole transport material (SL), 50 parts by mass of the electron transport material (E-1), 100 parts by mass of the resin (R-1) (viscosity average molecular weight 35,200) as the binder resin (SL), and 500 parts by mass of tetrahydrofuran as a solvent for 20 minutes using a rod-shaped sonic oscillator. The dispersion was filtered using a filter with an opening of 5 μm to obtain an application liquid for single-layer photosensitive layer formation. The application liquid for single-layer photosensitive layer formation was applied onto a conductive substrate (drum-shaped aluminum support) by dip coating, and hot-air dried at 120° C. for 50 minutes. Through the above, a single-layer photosensitive layer (film thickness 30 μm) was formed on the conductive substrate to obtain a single-layer photosensitive member (A-1). In the single-layer photosensitive member (A-1), a single-layer photosensitive layer was directly provided on the conductive substrate.

(Production of Single-Layer Photosensitive Members (A-2) to (A-70) and (B-1) to (B-25))

Single-layer photosensitive members (A-2) to (A-70) and (B-1) to (B-25) were produced according to the same method as that for producing the single-layer photosensitive member (A-1) in all aspects other than use of the resins of types and with viscosity average molecular weights shown in Tables 4 to 10 in amounts shown in Tables 4 to 10, use of the hole transport materials of types shown in Tables 4 to 10 in amounts shown in Tables 4 to 10, and use of electron transport materials of types shown in Tables 4 to 10 in amounts shown in Tables 4 to 10.

### Positively Chargeable Multi-layer Photosensitive Member Production

(Production of Positively Chargeable Multi-Layer Photosensitive Member (C-1))

First, a charge transport layer was formed. In detail, a dispersion was yielded by mixing 100 parts by mass of the hole transport material (H-10) as the hole transport material (CT), 100 parts by mass of the resins (R-1) (viscosity average molecular weight 62,000) as the binder resin (CT), and 500 parts by mas of tetrahydrofuran as a solvent for 20 minutes using a rod-shaped sonic oscillator. The dispersion was filtered using a filter with an opening of 5 μm to obtain an application liquid for charge transport layer formation. The application liquid for charge transport layer formation was applied onto a conductive substrate (drum-shaped aluminum support) by dip coating, and hot-air dried at 120° C. for 50 minutes. Through the above, a charge transport layer (film thickness 15 μm) was formed on the conductive substrate.

Next, a charge generating layer was formed. In detail, a dispersion was yielded by mixing 2 parts by mass of Y-form titanyl phthalocyanine as a charge generating material, 70 parts by mass of the hole transport material (H-1) as the hole transport material (CG), 50 parts by mass of the electron transport material (E-1), 100 parts by mass of the resin (R-1) (viscosity average molecular weight 35,200) as the binder resin (CG), and 500 parts by mass of 1,2-dichloroethane as a solvent for 20 minutes using a rod-shaped sonic oscillator. The dispersion was filtered using a filter with an opening of 5 μm to obtain an application liquid for charge generating layer formation. The application liquid for charge generating layer formation was applied onto the formed charge transport layer by dip coating, and hot-air dried at 120° C. for 50 minutes. In the manner described above, the charge generating layer (film thickness 15 μm) was formed on the charge transport layer to obtain a positively chargeable multi-layer photosensitive member (C-1). In the positively chargeable multi-layer photosensitive member (C-1), the charge transport layer was directly provided on the conductive substrate and the charge generating layer was directly provided on the charge transport layer.

(Production of Positively Chargeable Multi-Layer Photosensitive Members (C-2) to (C-75) and (D-1) to (D-25))

Positively chargeable multi-layer photosensitive members (C-2) to (C-75) and (D-1) to (D-25) were produced according to the same method as that for producing the positively chargeable multi-layer photosensitive member (C-1) in all aspects other than use of the resins of types and with viscosity average molecular weights shown in the column titled “Charge transport layer” in Tables 15 to 21 each as the binder resin (CT), use of the resins of types, with viscosity average molecular weights, and in amounts shown in the column titled “Charge generating layer” in Tables 15 to 21 each as the binder resin (CG), use of the hole transport materials of types and in amount shown in the column titled “Charge generating layer” in Tables 15 to 21 each as the hole transport material (CG), use of the charge transport materials of types and in amount shown in the column titled “Charge generating layer” in Tables 15 to 21, and charge generating layers being formed so as to have thicknesses shown in the column titled “Charge generating layer” in Tables 15 to 21. The addition amounts of the binder resin (CT) and the hole transport material (CT) in production of each positively chargeable multi-layer photosensitive member (C-2) to (C-75) and (D-1) to (D-25) were the same as those of the binder resin (CT) and the hole transport material (CT) in production of the positively chargeable multi-layer photosensitive member (C-1). The film thicknesses of the charge generating layers were changed by changing the speed of the conductive substrate being pulled out of the application liquid for charge generating layer formation in application of the application liquid for charge generating layer formation. The film thickness of a charge generating layer increases as the pulling speed is increased.

### Viscosity Average Molecular Weight Measurement

Each viscosity average molecular weight of the resins was measured in accordance with the Japanese Industrial Standards (JIS) K7252-1:2016. The measured viscosity average molecular weights are shown in Tables 4 to 10 and 15 to 21.

### Film Thickness Measurement

Each film thickness was measured using an eddy current film thickness meter (product of Kett Electric Laboratory, “LH-373”). The measured film thicknesses are shown in Tables 4 to 10 and 15 to 21.

### Scratch Resistance Depth Measurement

Each scratch resistance depth was measured using a scratching apparatus 200 defined in the JIS K5600-5-5 (JIS K5600: Testing methods for paints, Part 5: Mechanical Property of Film, Section 5: Scratch Hardness (Stylus method)).

A target of the scratch resistance depth measurement was each photosensitive member (the single-layer photosensitive member 1 or the positively chargeable multi-layer photosensitive member 10). The following explains a case in which the measurement target was the single-layer photosensitive member 1 as an example. In a case in which the measurement target is the positively chargeable multi-layer photosensitive member 10, the scratch resistance depth measurement can be carried out according to the same method as that for the single-layer photosensitive member 1 in all aspects other than change of the single-layer photosensitive member 1 to the positively chargeable multi-layer photosensitive member 10.

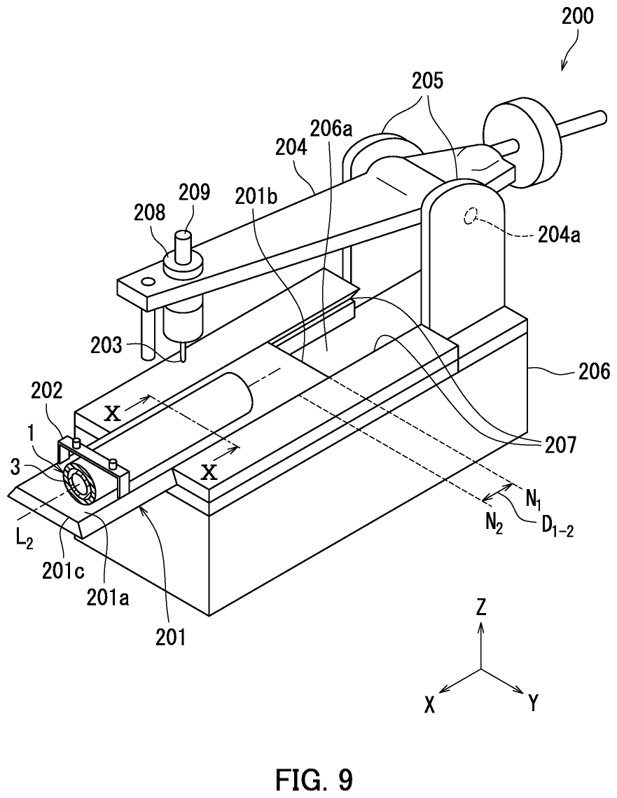

The scratching apparatus 200 will be described first with reference to FIG. 9. FIG. 9 is a diagram illustrating an example of the configuration of the scratching apparatus 200. The scratching apparatus 200 includes a fixing table 201, a fixing jig 202, a scratching stylus 203, a support arm 204, two shaft supports 205, a base 206, two rails 207, a weight pan 208, and a constant speed motor (not illustrated).

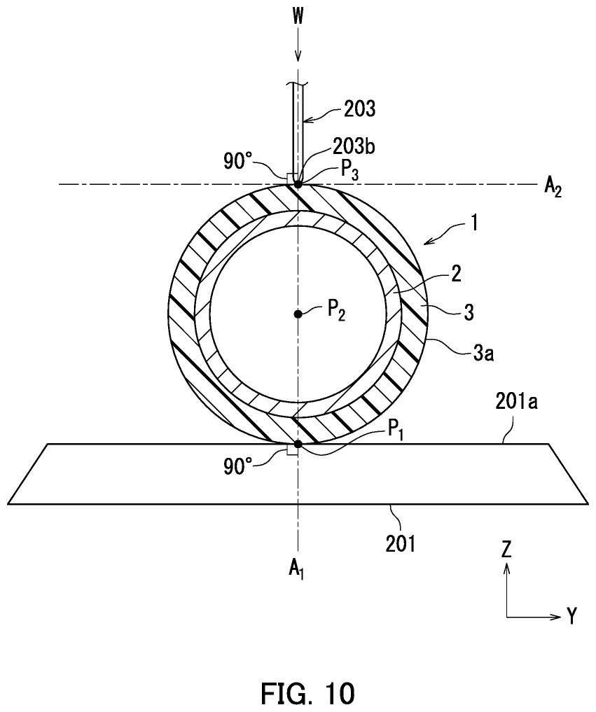

In FIG. 9, X and Y directions each are the horizontal direction and a Z direction is the vertical direction. The X direction coincides with the longitudinal direction of the fixing table 201. The Y direction coincides with a direction perpendicular to the X direction on a plane parallel to an upper surface 201a (placement surface) of the fixing table 201. Note that the X, Y, and Z directions in FIGS. 10 to 12, which will be described later, are defined the same as those in FIG. 9.

The fixing table 201 corresponds to a fixing table for fixing a standard panel for testing in the Japanese Industrial Standards (JIS) K5600-5-5. The fixing table 201 has the upper surface 201a, one end 201b, and another end 201c. The one end 201b is opposite to the two shaft supports 205.

The fixing jig 202 is disposed on the side of the other end 201c of the upper surface 201a of the fixing table 201. The fixing jig 202 fixes the measurement target (the single-layer photosensitive member 1) on the upper surface 201a of the fixing table 201. The upper surface 201a of the fixing table 201 is parallel to a horizontal plane.

The scratching stylus 203 has a tip end 203b (see FIG. 10). The tip end 203b has a hemispherical shape with a diameter of 1 mm. The tip end 203b is made from sapphire.

The support arm 204 supports the scratching stylus 203. The support arm 204 pivots about the support shaft 204a as a pivot center in a direction in which the scratching stylus 203 moves to and away from the single-layer photosensitive member 1.

The two shaft supports 205 support the support arm 204 in a pivotal manner.

The base 206 has an upper surface 206a. The two shaft supports 205 are disposed at a side of one end of the upper surface 206a.

The two rails 207 are disposed at the side of the other end of the upper surface 206a. The two rails 207 are disposed parallel to each other. The two rails 207 are disposed parallel to the longitudinal direction (X direction) of the fixing table 201. The fixing table 201 is mounted between the two rails 207. The fixing table 201 is horizontally movable in the longitudinal direction (X direction) of the fixing table 201 along the rails 207.

The weight pan 208 is disposed on the scratching stylus 203 with the support arm 204 therebetween. The weight 209 is put on the weight pan 208.

The constant speed motor moves the fixing table 201 in the longitudinal direction (X direction) of the fixing table 201 along the rails 207.

The scratch resistance depth measurement method will be described below. The scratch resistance depth measurement method included a first step, a second step, a third step, and a fourth step. The scratch resistance depth was measured using the scratching apparatus 200 defined in the Japanese Industrial Standards (JIS) K5600-5-5. A surface property measuring machine (product of Shinto Scientific Co., Ltd., “HEIDON TYPE14”) was used as the scratching apparatus 200. The scratch depth measurement was carried out in an environment at a temperature of 23° C. and a relative humidity of 50%. The photosensitive member was drum-shaped (cylindrical). As a result of the later-described scratch depth measurement method being employed, characteristics of the photosensitive layers that affect occurrence of fogging in formed images were enabled to be measured with accuracy.

(First Step)

In the first step, the single-layer photosensitive member 1 was fixed to the upper surface 201a of the fixing table 201 so that the longitudinal direction of the single-layer photosensitive member 1 was parallel to the longitudinal direction of the fixing table 201. The direction of a central axis L₂ (rotational axis) of the single-layer photosensitive member 1 corresponded to the longitudinal direction of the single-layer photosensitive member 1. In a case in which the single-layer photosensitive member 1 has a sheet shape, the long-side direction of the single-layer photosensitive member 1 corresponds to the longitudinal direction of the single-layer photosensitive member 1.

(Second Step)

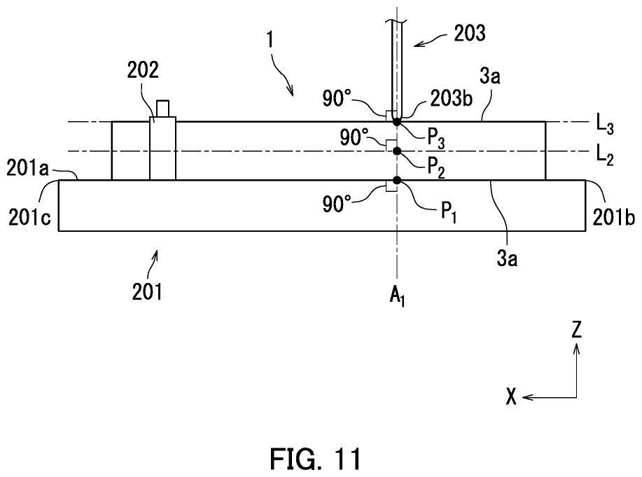

In the second step, the scratching stylus 203 was placed in perpendicular contact with the surface 3a of the photosensitive layer 3 of the photosensitive member 1. With reference to FIGS. 10 and 11 in addition to FIG. 9, a method of placing the scratching stylus 203 in perpendicular contact with the surface 3a of the photosensitive layer 3 of the drum-shaped single-layer photosensitive member 1 will be described. FIG. 10 is a cross-sectional view taken along a line X-X in FIG. 9. FIG. 10 is a cross-sectional view of the scratching stylus 203 in contact with the single-layer photosensitive member 1. FIG. 11 is a side view of the fixing table 201, the scratching stylus 203, and the single-layer photosensitive member 1 each shown in FIG. 9.

The scratching stylus 203 was moved toward the single-layer photosensitive member 1 such that an extension of a central axis A₁ of the scratching stylus 203 was perpendicular to the upper surface 201a of the fixing table 201. Thereafter, the tip end 203b of the scratching stylus 203 was placed in contact with a point on the surface 3a of the photosensitive layer 3 of the single-layer photosensitive member 1 that was farthest from the upper surface 201a of the fixing table 201 in the perpendicular direction (Z direction). This made the tip end 203b of the scratching stylus 203 in contact with the surface 3a of the photosensitive layer 3 of the single-layer photosensitive member 1 at a tangent point P₃. Furthermore, the tip end 203b of the scratching stylus 203 was placed in contact with the single-layer photosensitive member 1 such that the central axis A₁ of the scratching stylus 203 was perpendicular to a tangent A₂. Note that the tangent A₂ is a tangent at the tangent point P₃ of the outer circumference constituted by a section of the single-layer photosensitive member 1 perpendicular to the central axis L₂ of the single-layer photosensitive member 1. The above made the scratching stylus 203 in perpendicular contact with the surface 3a of the photosensitive layer 3 of the single-layer photosensitive member 1. Note that in a case in which the single-layer photosensitive member 1 has a sheet shape, the scratching stylus 203 is placed in contact with the surface 3a of the photosensitive layer 3 of the single-layer photosensitive member 1 so that the extension of the central axis A₁ of the scratching stylus 203 is perpendicular to the surface 3a (plane) of the photosensitive layer 3.

A positional relationship among the fixing table 201, the single-layer photosensitive member 1, and the scratching stylus 203 was as follows when the scratching stylus 203 was placed through the above process. The extension of the central axis A₁ of the scratching stylus 203 and the central axis L₂ of the single-layer photosensitive member 1 intersected perpendicularly at an intersection point P₂. The contact point P₁ between the upper surface 201a and the photosensitive layer 3, the intersection point P₂, and the tangent point P₃ between the photosensitive layer 3 and the tip end 203b of the scratching stylus 203 were located on the extension of the central axis A₁ of the scratching stylus 203. Furthermore, the extension of the central axis A₁ of the scratching stylus 203 was perpendicular to the tangent A₂ and the upper surface 201a of the fixing table 201.

(Third Step)

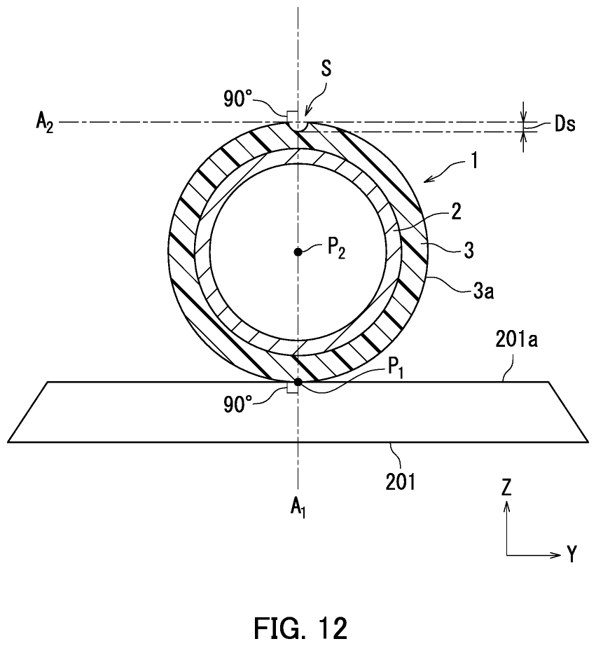

In the third step, 10 g of a load W was applied to the photosensitive layer 3 through the scratching stylus 203 with the scratching stylus 203 placed in perpendicular contact with the surface 3a of the photosensitive layer 3. Specifically, a 10-g weight was placed on the weight pan 208. The fixing table 201 was moved in the above state. Specifically, the constant speed motor is driven to horizontally move the fixing table 201 in the longitudinal direction (X direction) thereof along the rails 207. In other words, the one end 201b of the fixing table 201 was moved from a first point N₁ to a second point N₂. Note that the second point N₂ was located downstream of the first point N₁ in the longitudinal direction of the fixing table 201 and in terms of a direction in which the fixing table 201 was moved away from the two shaft supports 205. The single-layer photosensitive member 1 was also moved horizontally in the longitudinal direction of the fixing table 201 along with the movement of the fixing table 201 in the longitudinal direction thereof. The travel speed of the fixing table 201 and the single-layer photosensitive member 1 was 30 mm/min. The travel distance of the fixing table 201 and the single-layer photosensitive member 1 was 30 mm. The travel distance of the fixing table 201 and the single-layer photosensitive member 1 corresponded to a distance D₁₋₂ between the first point N₁ and the second point N₂. As the fixing table 201 and the single-layer photosensitive member 1 were moved, the scratching stylus 203 formed a scratch S on the surface 3a of the photosensitive layer 3 of the single-layer photosensitive member 1. The scratch S will be described with reference to FIG. 12 in addition to FIGS. 9 to 11. FIG. 12 illustrates the scratch S formed on the surface 3a of the photosensitive layer 3. The scratch S was formed perpendicularly to the tangent A₂ and the upper surface 201a of the fixing table 201. The scratch S was formed so as to draw a line L₃ in FIG. 11. Note that the line L₃ is an aggregation of a plurality of tangent points P₃. The line L₃ was parallel to each of the upper surface 201a of the fixing table 201 and the central axis L₂ of the single-layer photosensitive member 1. The line L₃ was perpendicular to the central axis A₁ of the scratching stylus 203.

(Fourth Step)

In the fourth step, a scratch resistance depth being a maximum depth Dsₘₐₓ of the scratch S was measured. Specifically, the single-layer photosensitive member 1 was removed from the fixing table 201. The scratch S formed on the photosensitive layer 3 of the single-layer photosensitive member 1 was observed at a magnification of 5X using a three-dimensional interference microscope (available at Bruker Corporation, “WYKO NT-1100”) to measure depths Ds of the scratch S. The depths Ds of the scratch S each corresponded to a distance from the tangent A₂ to a bottom part of the scratch S. A maximum depth Dsₘₐₓ of the depths Ds of the scratch S was taken to be a scratch resistance depth. The measured scratch resistance depths (unit: μm) are shown in Tables 4 to 10 and 15 to 21.

### Strain-at-Break Measurement

Among the single-layer photosensitive members and positively chargeable multi-layer photosensitive members produced as above, strains at break of the first photosensitive layers of the single-layer photosensitive members shown in Table 11 and the positively chargeable multi-layer photosensitive members shown in Table 22 were measured as typical examples. In detail, each of the first photosensitive layers was peeled from the conductive substrate of a corresponding one of the photosensitive members (the single-layer photosensitive members and the positively chargeable multi-layer photosensitive members). Next, a sample was obtained by cutting the first photosensitive layer to 3 mm wide and 30 mm long. Next, the sample was mounted on a tensile tester (product of SHIMADZU CORPORATION, “AUTOGRAPH (registered Japanese trademark) AGS-J 5 kN”). In mounting the sample, the distance between the gripping jigs of the tensile tester was adjusted to 8 mm. Next, the sample was pulled at a tensile speed of 5 mm/min. in an environment at a temperature of 23° C. and a relative humidity of 50% to obtain a stress-strain curve. From the obtained stress-strain curve, a strain at break was determined. The measured strains at break are shown in Tables 11 and 22.

### Vickers Hardness Measurement

Among the single-layer photosensitive members and the positively chargeable multi-layer photosensitive members produced as above, Vickers hardnesses of the first photosensitive layers of the single-layer photosensitive members shown in Table 12 and the positively chargeable multi-layer photosensitive members shown in Table 23 were measured as typical examples. In detail, the Vickers hardness of each first photosensitive layer was measured by a method in accordance with the Japanese Industrial Standards (JIS) Z2244. In the Vickers hardness measurement, a hardness tester (product of Matsuzawa Co., Ltd. (former Matsuzawa Seiki Kabushiki Kaisha, “MICRO VICKERS HARDNESS TESTER Model DMH-1”) was used. The Vickers hardness measurement was carried out under conditions of: a temperature of 23° C.: a load (testing power) of a diamond indenter of 10 gf: a time necessary for reaching the testing power of 5 seconds; an approaching speed of the diamond indenter of 2 mm/sec.; and a retention period of the testing power of 1 second. The measured Vickers hardnesses are shown in Tables 12 and 23.

### Evaluation

A remodeled version of a monochrome printer (product of KYOCERA Document Solutions Inc., “ECOSYS (registered Japanese trademark) P2040dw”) was used as an evaluation apparatus for evaluation of anti-fogging property and abrasion resistance. The evaluation apparatus included a charging roller as a charger. The evaluation apparatus adopted a contact development process and a direct transfer process. Furthermore, the evaluation apparatus included no cleaning blade. Paper used in the evaluation was “Brand Paper of KYOCERA Document Solutions. VM-A4” (A4 size) available at KYOCERA Document Solutions Inc. A developer used in the evaluation was a one-component developer (prototype). The evaluation apparatus was set so that the rotational speed of the photosensitive member (specifically, any of the single-layer photosensitive members and the positively chargeable multi-layer photosensitive members) was 240 mm/sec. and the charge potential of the photosensitive member was +600 V.

(Anti-Fogging Property Evaluation)

Anti-fogging property was evaluated for the single-layer photosensitive members and the positively chargeable multi-layer photosensitive members produced as above. The evaluation of anti-fogging property was carried out in an environment at a temperature of 32.5° C. and a relative humidity of 80%. An image with a printing rate of 1% was consecutively printed on 12,000 sheets of the paper using the evaluation apparatus. Next, a white image was printed on a single sheet of the paper. Reflectance densities at three points in the printed white image on the paper were measured using a reflectance densitometer (product of X-Rite Inc., “RD914”), and the arithmetic mean thereof was taken to be a reflection density A. Also, reflectance densities at three points on a sheet of paper not subjected to printing were measured, and the arithmetic mean thereof was taken to be a reflection density B. Thereafter, a fogging density (FD) was calculated using an equation “FD=reflection density A−reflection density B”. Anti-fogging property was evaluated using the calculated FD according to the following criteria. Each FD and evaluation results are shown in Tables 4 to 10 and 15 to 21.

Photosensitive members with a grade of A, B, or C were evaluated as having good anti-fogging property, and those with a grade of D were evaluated as having poor anti-fogging property.

(Criteria for Anti-fogging Property Evaluation)

Grade A: FD of no greater than 0.010

Grade B: FD of greater than 0.010 and no greater than 0.020

Grade C: FD of greater than 0.020 and less than 0.045

Grade D (poor): FD of 0.045 or greater

(Abrasion Resistance Evaluation)

Abrasion resistance was evaluated for the single-layer photosensitive members shown in Table 13 and the positively chargeable multi-layer photosensitive members shown in Table 24 as typical examples among the single-layer photosensitive members and the positively chargeable multi-layer photosensitive members produced as above. The abrasion resistance evaluation was carried out in an environment at a temperature of 23° C. and a relative humidity of 50%. A film thickness T1 of each first photosensitive layer was measured. Next, one of the photosensitive members was mounted in the evaluation apparatus. An image with a printing rate of 1% was consecutively printed on 15,000 sheets of the paper using the evaluation apparatus. A film thickness T2 of the first photosensitive layer was measured after the printing. Note that the measurement of the film thicknesses T1 and T2 was carried out according to the method described above in <Film Thickness Measurement>. Thereafter, an abrasion amount (unit: μm) of the first photosensitive layer was calculated using an equation “abrasion amount=T1−T2”. The calculated abrasion amounts are shown in Tables 13 and 24.

A less abrasion amount indicates more excellent abrasion resistance of a photosensitive member. Note that a photosensitive member with an abrasion amount of no greater than 6.0 μm can be determined to have abrasion resistance sufficient for practical use.

(Sensitivity Characteristics Evaluation)

Sensitivity characteristics were evaluated for the single-layer photosensitive members shown in Table 14 and the positively chargeable multi-layer photosensitive members shown in Table 25 as typical examples among the single-layer photosensitive members and the positively chargeable multi-layer photosensitive members produced as above. Sensitivity characteristics of each photosensitive member was evaluated using a drum sensitivity test device (product of GEN-TECH. INC.) in an environment at a temperature of 23° C. and a relative humidity of 50%. In detail, the photosensitive member was charged using the drum sensitivity test device so that the surface potential of the photosensitive member reached +600 V. Next, the surface of the photosensitive member was irradiated with monochromatic light (wavelength: 780 nm, half-width: 20 nm, light energy: 1.0 μJ/cm) taken out of a halogen lamp using a bandpass filter. The surface potential of the photosensitive member at the time when 0.5 seconds elapsed from monochromatic light irradiation was measured and the measured value was taken to be a post-exposure potential (V_{L}, unit: +V). The post-exposure potentials of the photosensitive members are shown in Tables 14 and 25. A lower post-exposure potential indicates more excellent sensitivity characteristics of a photosensitive member. Note that a photosensitive member with a post-exposure potential of no greater than +135 V can be determined to have sensitivity characteristics sufficient for practical use.

Tables 4 to 25 are shown below. Note that the terms in Tables 4 to 25 mean as follows.
Molecular weight: viscosity average molecular weight
Ratio: ratio of mass of binder resin to mass of first photosensitive layer
Fogging: anti-fogging property evaluation
FD: fogging density
Application liquid preparation disabled: application liquid not being prepared due to corresponding resin not dissolving in solvent for application liquid preparation
Unmeasurable: measurement of viscosity average molecular weight being disabled due to corresponding resin not dissolving in solvent for viscosity molecular weight measurement
Hardness: Vickers hardness
V_{L}: post-exposure potential

TABLE 4

| | Single- | Single-layer photosensitive layer | | | | | | | | | | | |
|---|---|---|---|---|---|---|---|---|---|---|---|---|---|
| | layer | | | | | | | | | Film | Scratch | | |
| | photo- | Resin | | | | HTM | | ETM | | thick- | resistance | | |
| | sensitive | | Molecular | Amount | | | Amount | | Amount | ness | depth | Fogging | |
| | member | Type | weight | [part] | Ratio | Type | [part] | Type | [part] | [μm] | [μm] | FD | Grade |
| Example 1-1 | A-l | R-1 | 35200 | 100 | 0.45 | H-1 | 70 | E-1 | 50 | 30 | 0.33 | 0.002 | A |
| Example 1-2 | A-2 | R-1 | 53100 | 100 | 0.45 | H-1 | 70 | E-1 | 50 | 30 | 0.39 | 0.005 | A |
| Example 1-3 | A-3 | R-1 | 66000 | 100 | 0.45 | H-1 | 70 | E-1 | 50 | 30 | 0.38 | 0.006 | A |
| Example 1-4 | A-4 | R-1 | 79000 | 100 | 0.45 | H-1 | 70 | E-1 | 50 | 30 | 0.40 | 0.008 | A |
| Example 1-5 | A-5 | R-1 | 55000 | 100 | 0.45 | H-2 | 70 | E-1 | 50 | 30 | 0.32 | 0.002 | A |
| Example 1-6 | A-6 | R-1 | 56000 | 100 | 0.45 | H-3 | 70 | E-1 | 50 | 30 | 0.33 | 0.002 | A |
| Example 1-7 | A-7 | R-1 | 61000 | 100 | 0.45 | H-4 | 70 | E-1 | 50 | 30 | 0.41 | 0.003 | A |
| Example 1-8 | A-8 | R-1 | 51000 | 100 | 0.45 | H-5 | 70 | E-1 | 50 | 30 | 0.46 | 0.006 | A |
| Example 1-9 | A-9 | R-1 | 66000 | 100 | 0.45 | H-6 | 70 | E-1 | 50 | 30 | 0.37 | 0.008 | A |
| Example 1-10 | A-10 | R-1 | 69000 | 100 | 0 45 | H-7 | 70 | E-1 | 50 | 30 | 0.32 | 0.008 | A |
| Example 1-11 | A-11 | R-1 | 53000 | 100 | 0.45 | H-8 | 70 | E-1 | 50 | 30 | 0.41 | 0.009 | A |
| Example 1-12 | A-12 | R-1 | 44000 | 100 | 0.45 | H-9 | 70 | E-1 | 50 | 30 | 0.40 | 0.006 | A |
| Example 1-13 | A-13 | R-1 | 62000 | 100 | 0.45 | H-10 | 70 | E-1 | 50 | 30 | 0.35 | 0.002 | A |
| Example 1-14 | A-14 | R-2 | 64200 | 100 | 0.45 | H-1 | 70 | E-1 | 50 | 30 | 0.49 | 0.002 | A |
| Example 1-15 | A-15 | R-3 | 54500 | 100 | 0.45 | H-1 | 70 | E-1 | 50 | 30 | 0.36 | 0.003 | A |

TABLE 5

| | Single- | Single-layer photosensitive layer | | | | | | | | | | | |
|---|---|---|---|---|---|---|---|---|---|---|---|---|---|
| | layer | | | | | | | | | Film | Scratch | | |
| | photo- | Resin | | | | HTM | | ETM | | thick- | resistance | | |
| | sensitive | | Molecular | Amount | | | Amount | | Amount | ness | depth | Fogging | |
| | member | Type | weight | [part] | Ratio | Type | [part] | Type | [part] | [μm] | [μm] | FD | Grade |
| Example 1-16 | A-16 | R-4 | 52700 | 100 | 0.45 | H-1 | 70 | E-1 | 50 | 30 | 0.38 | 0.004 | A |
| Example 1-17 | A-17 | R-5 | 62300 | 100 | 0.45 | H-1 | 70 | E-1 | 50 | 30 | 0.49 | 0.008 | A |
| Example 1-18 | A-18 | R-6 | 58000 | 100 | 0.45 | H-1 | 70 | E-1 | 50 | 30 | 0.44 | 0.008 | A |
| Example 1-19 | A-19 | R-7 | 54300 | 100 | 0.45 | H-1 | 70 | E-1 | 50 | 30 | 0.41 | 0.009 | A |
| Example 1-20 | A-20 | R-1 | 35200 | 100 | 0.45 | H-11 | 70 | E-1 | 50 | 30 | 0.88 | 0.033 | C |
| Example 1-21 | A-21 | R-1 | 24000 | 100 | 0.45 | H-1 | 70 | E-1 | 50 | 30 | 0.34 | 0.041 | C |
| Example 1-22 | A-22 | R-1 | 83000 | 100 | 0 45 | H-1 | 70 | E-1 | 50 | 30 | 0.36 | 0.015 | B |
| Example 1-23 | A-23 | R-1 | 52000 | 90 | 0.42 | H-10 | 80 | E-1 | 40 | 30 | 0.35 | 0.003 | A |
| Example 1-24 | A-24 | R-1 | 52000 | 68 | 0.36 | H-10 | 80 | E-1 | 40 | 30 | 0.41 | 0.007 | A |
| Example 1-25 | A-25 | R-1 | 52000 | 116 | 0.49 | H-10 | 80 | E-1 | 40 | 30 | 0.15 | 0.002 | A |
| Example 1-26 | A-26 | R-1 | 52000 | 90 | 0.42 | H-1 | 80 | E-1 | 40 | 30 | 0.32 | 0.007 | A |
| Example 1-27 | A-27 | R-1 | 52000 | 90 | 0.42 | H-2 | 80 | E-1 | 40 | 30 | 0.35 | 0.002 | A |
| Example 1-28 | A-28 | R-1 | 52000 | 90 | 0.42 | H-3 | 80 | E-1 | 40 | 30 | 0.36 | 0.003 | A |
| Example 1-29 | A-29 | R-1 | 52000 | 90 | 0.42 | H-4 | 80 | E-1 | 40 | 30 | 0.40 | 0.003 | A |
| Example 1-30 | A-30 | R-1 | 52000 | 90 | 0.42 | H-5 | 80 | E-1 | 40 | 30 | 0.41 | 0.006 | A |

TABLE 6

| | Single- | Single-layer photosensitive layer | | | | | | | | | | | |
|---|---|---|---|---|---|---|---|---|---|---|---|---|---|
| | layer | | | | | | | | | | Scratch | | |
| | photo- | Resin | | | | HTM | | ETM | | Film | resistance | | |
| | sensitive | | Molecular | Amount | | | Amount | | Amount | thickness | depth | Fogging | |
| | member | Type | weight | [part] | Ratio | Type | [part] | Type | [part] | [μm] | [μm] | FD | Grade |
| Example 1-31 | A-31 | R-1 | 52000 | 90 | 0.42 | H-6 | 80 | E-1 | 40 | 30 | 0.38 | 0.008 | A |
| Example 1-32 | A-32 | R-1 | 52000 | 90 | 0.42 | H-7 | 80 | E-1 | 40 | 30 | 0.34 | 0.008 | A |
| Example 1-33 | A-33 | R-1 | 52000 | 90 | 0.42 | H-8 | 80 | E-1 | 40 | 30 | 0.37 | 0.009 | A |
| Example 1-34 | A-34 | R-1 | 52000 | 90 | 0.42 | H-9 | 80 | E-1 | 40 | 30 | 0.33 | 0.008 | A |
| Example 1-35 | A-35 | R-1 | 52000 | 90 | 0.42 | H-10 | 80 | E-2 | 40 | 30 | 0.31 | 0.006 | A |
| Example 1-36 | A-36 | R-1 | 52000 | 90 | 0.42 | H-10 | 80 | E-3 | 40 | 30 | 0.28 | 0.008 | A |
| Example 1-37 | A-37 | R-1 | 52000 | 90 | 0 42 | H-10 | 80 | E-4 | 40 | 30 | 0.33 | 0.006 | A |
| Example 1-38 | A-38 | R-1 | 52000 | 90 | 0.42 | H-10 | 80 | E-5 | 40 | 30 | 0.38 | 0.008 | A |
| Example 1-39 | A-39 | R-1 | 52000 | 90 | 0.42 | H-10 | 80 | E-6 | 40 | 30 | 0.39 | 0.006 | A |
| Example 1-40 | A-40 | R-1 | 52000 | 90 | 0.42 | H-10 | 80 | E-7 | 40 | 30 | 0.23 | 0.004 | A |
| Example 1-41 | A-41 | R-1 | 52000 | 90 | 0.42 | H-10 | 80 | E-8 | 40 | 30 | 0.34 | 0.002 | A |
| Example 1-42 | A-42 | R-2 | 64200 | 90 | 0.42 | H-10 | 80 | E-1 | 40 | 30 | 0.44 | 0.002 | A |
| Example 1-43 | A-43 | R-3 | 54500 | 90 | 0.42 | H-10 | 80 | E-1 | 40 | 30 | 0.31 | 0.004 | A |
| Example 1-44 | A-44 | R-4 | 52700 | 90 | 0.42 | H-10 | 80 | E-1 | 40 | 30 | 0.30 | 0.004 | A |
| Example 1-45 | A-45 | R-5 | 62300 | 90 | 0.42 | H-10 | 80 | E-1 | 40 | 30 | 0.48 | 0.008 | A |

TABLE 7

| | Single- | Single-layer photosensitive layer | | | | | | | | | | | |
|---|---|---|---|---|---|---|---|---|---|---|---|---|---|
| | layer | | | | | | | | | Film | Scratch | | |
| | photo- | Resin | | | | HTM | | ETM | | thick- | resistance | | |
| | sensitive | | Molecular | Amount | | | Amount | | Amount | ness | depth | Fogging | |
| | member | Type | weight | [part] | Ratio | Type | [part] | Type | [part] | [μm] | [μm] | FD | Evaluation |
| Example 1-46 | A-46 | R-6 | 58000 | 90 | 0.42 | H-10 | 80 | E-1 | 40 | 30 | 0.38 | 0.008 | A |
| Example 1-47 | A-47 | R-7 | 54300 | 90 | 0.42 | H-10 | 80 | E-1 | 40 | 30 | 0.39 | 0.009 | A |
| Example 1-48 | A-48 | R-1 | 52000 | 90 | 0.42 | H-10 | 80 | E-9 | 40 | 30 | 0.33 | 0.006 | A |
| Example 1-49 | A-49 | R-1 | 52000 | 90 | 0.42 | H-11 | 80 | E-1 | 40 | 30 | 0.75 | 0.033 | C |
| Example 1-50 | A-50 | R-1 | 52000 | 60 | 0.33 | H-10 | 80 | E-1 | 40 | 30 | 0.52 | 0.018 | B |
| Example 1-51 | A-51 | R-1 | 52000 | 125 | 0.51 | H-10 | 80 | E-1 | 40 | 30 | 0.12 | 0.015 | B |
| Example 1-52 | A-52 | R-1 | 51000 | 100 | 0.45 | H-1 | 70 | E-1 | 50 | 30 | 0.33 | 0.002 | A |
| Example 1-53 | A-53 | R-1 | 51000 | 100 | 0.45 | H-1 | 70 | E-2 | 50 | 30 | 0.39 | 0.005 | A |
| Example 1-54 | A-54 | R-1 | 51000 | 100 | 0.45 | H-1 | 70 | E-3 | 50 | 30 | 0.38 | 0.006 | A |
| Example 1-55 | A-55 | R-1 | 51000 | 100 | 0.45 | H-1 | 70 | E-4 | 50 | 30 | 0.40 | 0.008 | A |
| Example 1-56 | A-56 | R-1 | 51000 | 100 | 0.45 | H-1 | 70 | E-5 | 50 | 30 | 0.41 | 0.009 | A |
| Example 1-57 | A-57 | R-1 | 51000 | 100 | 0.45 | H-1 | 70 | E-6 | 50 | 30 | 0.43 | 0.009 | A |
| Example 1-58 | A-58 | R-1 | 51000 | 100 | 0.45 | H-1 | 70 | E-7 | 50 | 30 | 0.38 | 0.007 | A |
| Example 1-59 | A-59 | R-1 | 51000 | 100 | 0.45 | H-1 | 70 | E-8 | 50 | 30 | 0.40 | 0.002 | A |
| Example 1-60 | A-60 | R-1 | 51000 | 100 | 0.45 | H-2 | 70 | E-1 | 50 | 30 | 0.32 | 0.002 | A |

TABLE 8

| | Single- | Single-layer photosensitive layer | | | | | | | | | | | |
|---|---|---|---|---|---|---|---|---|---|---|---|---|---|
| | layer | | | | | | | | | Film | Scratch | | |
| | photo- | Resin | | | | HTM | | ETM | | thick- | resistance | | |
| | sensitive | | Molecular | Amount | | | Amount | | Amount | ness | depth | Fogging | |
| | member | Type | weight | [part] | Ratio | Type | part] | Type | [part] | [μm] | [μm] | FD | Evaluation |
| Example 1-61 | A-61 | R-1 | 51000 | 100 | 0.45 | H-3 | 70 | E-1 | 50 | 30 | 0.33 | 0.002 | A |
| Example 1-62 | A-62 | R-1 | 51000 | 100 | 0.45 | H-4 | 70 | E-1 | 50 | 30 | 0.41 | 0.003 | A |
| Example 1-63 | A-63 | R-1 | 51000 | 100 | 0.45 | H-5 | 70 | E-1 | 50 | 30 | 0.46 | 0.006 | A |
| Example 1-64 | A-64 | R-1 | 51000 | 100 | 0.45 | H-6 | 70 | E-1 | 50 | 30 | 0.37 | 0.008 | A |
| Example 1-65 | A-65 | R-1 | 51000 | 100 | 0.45 | H-7 | 70 | E-1 | 50 | 30 | 0.32 | 0.008 | A |
| Example 1-66 | A-66 | R-1 | 51000 | 100 | 0.45 | H-8 | 70 | E-1 | 50 | 30 | 0.41 | 0.009 | A |
| Example 1-67 | A-67 | R-1 | 51000 | 100 | 0.45 | H-9 | 70 | E-1 | 50 | 30 | 0.40 | 0.006 | A |
| Example 1-68 | A-68 | R-1 | 51000 | 100 | 0.45 | H-1 | 70 | E-9 | 50 | 30 | 0.41 | 0.008 | A |
| Example 1-69 | A-69 | R-1 | 51000 | 100 | 0.45 | H-11 | 70 | E-1 | 50 | 30 | 0.88 | 0.033 | C |
| Example 1-70 | A-70 | R-1 | 51000 | 100 | 0.45 | H-10 | 70 | E-1 | 50 | 30 | 0.35 | 0.002 | A |

TABLE 9

| | Single- | Single-layer photosensitive layer | | | | | | | | | | | |
|---|---|---|---|---|---|---|---|---|---|---|---|---|---|
| | layer | | | | | | | | | | Scratch | | |
| | photo- | Resin | | | | HTM | | ETM | | Film | resistance | | |
| | sensitive | | Molecular | Amount | | | Amount | | Amount | thickness | depth | Fogging | |
| | member | Type | weight | [part] | Ratio | Type | [part] | Type | [part] | [μm] | [μm] | FD | Grade |
| Comparative Example 1-1 | B-1 | R-8 | 65000 | 100 | 0.45 | H-2 | 70 | E-1 | 50 | 30 | 1.56 | 0.106 | D |
| Comparative Example 1-2 | B-2 | R-9 | 52000 | 100 | 0.45 | H-2 | 70 | E-1 | 50 | 30 | 1.22 | 0.085 | D |
| Comparative Example 1-3 | B-3 | R-10 | 58000 | 100 | 0.45 | H-2 | 70 | E-1 | 50 | 30 | 1.08 | 0.071 | D |
| Comparative Example 1-4 | B-4 | R-11 | 51000 | 100 | 0.45 | H-2 | 70 | E-1 | 50 | 30 | 0.98 | 0.045 | D |
| Comparative Example 1-5 | B-5 | R-8 | 65000 | 100 | 0 45 | H-2 | 70 | E-4 | 50 | 30 | 1.56 | 0.106 | D |
| Comparative Example 1-6 | B-6 | R-9 | 52000 | 100 | 0.45 | H-2 | 70 | E-4 | 50 | 30 | 1.22 | 0.085 | D |
| Comparative Example 1-7 | B-7 | R-10 | 58000 | 100 | 0.45 | H-2 | 70 | E-4 | 50 | 30 | 1.08 | 0.071 | D |
| Comparative Example 1-8 | B-8 | R-11 | 51000 | 100 | 0.45 | H-2 | 70 | E-4 | 50 | 30 | 0.98 | 0.045 | D |
| Comparative Example 1-9 | B-9 | R-8 | 65000 | 90 | 0.42 | H-10 | 80 | E-1 | 40 | 30 | 1.66 | 0.106 | D |
| Comparative Example 1-10 | B-10 | R-9 | 52000 | 90 | 0.42 | H-10 | 80 | E-1 | 40 | 30 | 1.26 | 0.085 | D |
| Comparative Example 1-11 | B-11 | R-10 | 58000 | 90 | 0.42 | H-10 | 80 | E-1 | 40 | 30 | 1.08 | 0.071 | D |
| Comparative Example 1-12 | B-12 | R-11 | 51000 | 90 | 0 42 | H-10 | 80 | E-1 | 40 | 30 | 0.98 | 0.045 | D |

TABLE 10

| | Single- | Single-layer photosensitive layer | | | | | | | | | | | |
|---|---|---|---|---|---|---|---|---|---|---|---|---|---|
| | layer | | | | | | | | | Film | Scratch | | |
| | photo- | Resin | | | | HTM | | ETM | | thick- | resistance | | |
| | sensitive | | Molecular | Amount | | | Amount | | Amount | ness | depth | Fogging | |
| | member | Type | weight | [part] | Ratio | Type | [part] | Type | [part] | [μm] | [μm] | FD | Grade |
| Comparative Example 1-13 | B-13 | R-12 | 58600 | 100 | 0.45 | H-10 | 70 | E-1 | 50 | Application liquid preparation disabled | | | |
| Comparative Example 1-14 | B-14 | R-13 | 57200 | 100 | 0.45 | H-10 | 70 | E-1 | 50 | 30 | 0.62 | 0.046 | D |
| Comparative Example 1-15 | B-15 | R-14 | 56600 | 100 | 0.45 | H10 | 70 | E-1 | 50 | Application liquid preparation disabled | | | |
| Comparative Example 1-16 | B-16 | R-15 | 61000 | 100 | 0.45 | H-10 | 70 | E-1 | 50 | 30 | 0.61 | 0.050 | D |
| Comparative Example 1-17 | B-17 | R-16 | Unmeasurable | 100 | 0.45 | H-10 | 70 | E-1 | 50 | Application liquid preparation disabled | | | |
| Comparative Example 1-18 | B-18 | R-17 | 49900 | 100 | 0.45 | H-10 | 70 | E-1 | 50 | 30 | 1.05 | 0.072 | D |
| Comparative Example 1-19 | B-19 | R-18 | 50800 | 100 | 0.45 | H-10 | 70 | E-1 | 50 | 30 | 1.22 | 0.086 | D |
| Comparative Example 1-20 | B-20 | R-19 | 52100 | 100 | 0.45 | H-10 | 70 | E-1 | 50 | 30 | 0.91 | 0.049 | D |
| Comparative Example 1-21 | B-21 | R-20 | 53500 | 100 | 0.45 | H-10 | 70 | E-1 | 50 | 30 | 0.91 | 0.050 | D |
| Comparative Example 1-22 | B-22 | R-21 | Unmeasurable | 100 | 0.45 | H-10 | 70 | E-1 | 50 | Application liquid preparation disabled | | | |
| Comparative Example 1-23 | B-23 | R-22 | 48100 | 100 | 0.45 | H-10 | 70 | E-1 | 50 | 30 | 1.10 | 0.075 | D |
| Comparative Example 1-24 | B-24 | R-23 | 56900 | 100 | 0.45 | H-10 | 70 | E-1 | 50 | 30 | 0.99 | 0.053 | D |

| | | | | | | | | | | |
|---|---|---|---|---|---|---|---|---|---|---|
| Comparative Example 1-25 | B-25 | R-24 | 42300 | 100 | 0.45 | H-10 | 70 | E-1 | 50 | Application liquid preparation disabled |

TABLE 11

| | Single-layer | Strain | | Single-layer | Strain |
|---|---|---|---|---|---|
| | photosensitive | at break | | photosensitive | at break |
| | member | [%] | | member | [%] |
| Example 1-1 | A-1 | 10.0 | Example 1-21 | A-21 | 7.1 |
| Example 1-2 | A-2 | 14.6 | Example 1-22 | A-22 | 22.3 |
| Example 1-3 | A-3 | 17.9 | Comparative | B-1 | 7.6 |
| | | | Example 1-1 | | |
| Example 1-4 | A-4 | 20.9 | Comparative | B-2 | 9.3 |
| | | | Example 1-2 | | |
| Example 1-5 | A-5 | 13.8 | Comparative | B-3 | 10.1 |
| | | | Example 1-3 | | |
| Example 1-6 | A-6 | 15.3 | Comparative | B-4 | 12.1 |
| | | | Example 1-4 | | |
| Example 1-7 | A-7 | 16.6 | Comparative | B-13 | Application |
| | | | Example 1-13 | | liquid |
| | | | | | preparation |
| | | | | | disabled |
| Example 1-8 | A-8 | 14.1 | Comparative | B-14 | 4.2 |
| | | | Example 1-14 | | |
| Example 1-9 | A-9 | 16.4 | Comparative | B-15 | Application |
| | | | Example 1-15 | | liquid |
| | | | | | preparation |
| | | | | | disabled |
| Example 1-10 | A-10 | 18.7 | Comparative | B-16 | 4.3 |
| | | | Example 1-16 | | |
| Example 1-11 | A-11 | 14.6 | Comparative | B-17 | Application |
| | | | Example 1-17 | | liquid |
| | | | | | preparation |
| | | | | | disabled |
| Example 1-12 | A-12 | 12.3 | Comparative | B-18 | 6.4 |
| | | | Example 1-18 | | |
| Example 1-13 | A-13 | 16.9 | Comparative | B-19 | 5.5 |
| | | | Example 1-19 | | |
| Example 1-14 | A-14 | 17.4v | Comparative | B-20 | 7.2 |
| | | | Example 1-20 | | |
| Example 1-15 | A-15 | 14.8 | Comparative | B-21 | 7.2 |
| | | | Example 1-21 | | |
| Example 1-16 | A-16 | 14.2 | Comparative | B-22 | Application |
| | | | Example 1-22 | | liquid |
| | | | | | preparation |
| | | | | | disabled |
| Example 1-17 | A-17 | 17.0 | Comparative | B-23 | 6.1 |
| | | | Example 1-23 | | |
| Example 1-18 | A-18 | 15.9 | Comparative | B-24 | 6.9 |
| | | | Example 1-24 | | |
| Example 1-19 | A-19 | 14.9 | Comparative | B-25 | Application |
| | | | Example 1-25 | | liquid |
| | | | | | preparation |
| | | | | | disabled |
| Example 1-20 | A-20 | 10.0 | | | |

TABLE 12

| | Single-layer | | | Single-layer | |
|---|---|---|---|---|---|
| | photosensitive | Hardness | | photosensitive | Hardness |
| | member | [HV] | | member | [HV] |
| Example 1-70 | A-70 | 23.0 | Comparative | B-5 | 11.0 |
| | | | Example 1-5 | | |
| Example 1-14 | A-14 | 23.4 | Comparative | B-6 | 13.3 |
| | | | Example 1-6 | | |
| Example 1-15 | A-15 | 22.3 | Comparative | B-7 | 14.9 |
| | | | Example 1-7 | | |
| Example 1-16 | A-16 | 21.9 | Comparative | B-8 | 15.7 |
| | | | Example 1-8 | | |
| Example 1-17 | A-17 | 19.7 | Comparative | B-13 | Application |
| | | | Example 1-13 | | liquid |
| | | | | | preparation |
| | | | | | disabled |
| Example 1-18 | A-18 | 20.0 | Comparative | B-14 | 18.2 |
| | | | Example 1-14 | | |
| Example 1-19 | A-19 | 19.9 | Comparative | B-15 | Application |
| | | | Example 1-15 | | liquid |
| | | | | | preparation |
| | | | | | disabled |
| Example 1-52 | A-52 | 22.5 | Comparative | B-16 | 18.1 |
| | | | Example 1-16 | | |
| Example 1-53 | A-53 | 21.8 | Comparative | B-17 | Application |
| | | | Example 1-17 | | liquid |
| | | | | | preparation |
| | | | | | disabled |
| Example 1-54 | A-54 | 21.5 | Comparative | B-18 | 33.5 |
| | | | Example 1-18 | | |
| Example 1-55 | A-55 | 29.2 | Comparative | B-19 | 10.5 |
| | | | Example 1-19 | | |
| Example 1-56 | A-56 | 19.9 | Comparative | B-20 | 14.1 |
| | | | Example 1-20 | | |
| Example 1-57 | A-57 | 20.2 | Comparative | B-21 | 14.1 |
| | | | Example 1-21 | | |
| Example 1-58 | A-58 | 21.3 | Comparative | B-22 | Application |
| | | | Example 1-22 | | liquid |
| | | | | | preparation |
| | | | | | disabled |
| Example 1-59 | A-59 | 22.6 | Comparative | B-23 | 13.2 |
| | | | Example 1-23 | | |
| Example 1-60 | A-60 | 26.0 | Comparative | B-24 | 13.1 |
| | | | Example 1-24 | | |
| Example 1-61 | A-61 | 22.5 | Comparative | B-25 | Application |
| | | | Example 1-25 | | liquid |
| | | | | | preparation |
| | | | | | disabled |
| Example 1-62 | A-62 | 21.7 | | | |
| Example 1-63 | A-63 | 20.9 | | | |
| Example 1-64 | A-64 | 20.4 | | | |
| Example 1-65 | A-65 | 20.4 | | | |
| Example 1-66 | A-66 | 20.3 | | | |
| Example 1-67 | A-67 | 21.2 | | | |
| Example 1-68 | A-68 | 19.8 | | | |
| Example 1-69 | A-69 | 16.8 | | | |

TABLE 13

| | Single-layer | Abrasion | | Single-layer | Abrasion |
|---|---|---|---|---|---|
| | photosensitive | amount | | photosensitive | amount |
| | member | [μm] | | member | [μm] |
| Example 1-1 | A-1 | 2.2 | Comparative | B-1 | 9.6 |
| | | | Example 1-1 | | |
| Example 1-2 | A-2 | 2.0 | Comparative | B-2 | 8.4 |
| | | | Example 1-2 | | |
| Example 1-3 | A-3 | 1.5 | Comparative | B-3 | 7.2 |
| | | | Example 1-3 | | |
| Example 1-4 | A-4 | 3.2 | Comparative | B-4 | 5.8 |
| | | | Example 1-4 | | |
| Example 1-5 | A-5 | 1.7 | Comparative | B-13 | Application |
| | | | Example 1-13 | | liquid |
| | | | | | preparation |
| | | | | | disabled |
| Example 1-6 | A-6 | 1.6 | Comparative | B-14 | 4.5 |
| | | | Example 1-14 | | |
| Example 1-7 | A-7 | 1.8 | Comparative | B-15 | Application |
| | | | Example 1-15 | | liquid |
| | | | | | preparation |
| | | | | | disabled |
| Example 1-8 | A-8 | 2.4 | Comparative | B-16 | 4.6 |
| | | | Example 1-16 | | |
| Example 1-9 | A-9 | 1.7 | Comparative | B-17 | Application |
| | | | Example 1-17 | | liquid |
| | | | | | preparation |
| | | | | | disabled |
| Example 1-10 | A-10 | 1.2 | Comparative | B-18 | 9.8 |
| | | | Example 1-18 | | |
| Example 1-11 | A-11 | 2.1 | Comparative | B-19 | 11.3 |
| | | | Example 1-19 | | |
| Example 1-12 | A-12 | 2.4 | Comparative | B-20 | 8.5 |
| | | | Example 1-20 | | |
| Example 1-13 | A-13 | 1.5 | Comparative | B-21 | 8.5 |
| | | | Example 1-21 | | |
| Example 1-14 | A-14 | 2.3 | Comparative | B-22 | Application |
| | | | Example 1-22 | | liquid |
| | | | | | preparation |
| | | | | | disabled |
| Example 1-15 | A-15 | 3.8 | Comparative | B-23 | 10.1 |
| | | | Example 1-23 | | |
| Example 1-16 | A-36 | 2.0 | Comparative | B-24 | 9.1 |
| | | | Example 1-24 | | |
| Example 1-17 | A-17 | 2.6 | Comparative | B-25 | Application |
| | | | Example 1-25 | | liquid |
| | | | | | preparation |
| | | | | | disabled |
| Example 1-18 | A-18 | 2.1 | | | |
| Example 1-19 | A-19 | 2.1 | | | |
| Example 1-20 | A-20 | 5.9 | | | |
| Example 1-21 | A-21 | 4.9 | | | |
| Example 1-22 | A-22 | 0.9 | | | |

TABLE 14

| | Single-layer | | | Single-layer | |
|---|---|---|---|---|---|
| | photosensitive | V_{L} | | photosensitive | V_{L} |
| | member | [+V] | | member | [+V] |
| Example 1-23 | A-23 | 110 | Comparative | B-9 | 100 |
| | | | Example 1-9 | | |
| Example 1-24 | A-24 | 90 | Comparative | B-10 | 115 |
| | | | Example 1-10 | | |
| Example 1-25 | A-25 | 125 | Comparative | B-11 | 113 |
| | | | Example 1-11 | | |
| Example 1-26 | A-26 | 113 | Comparative | B-12 | 133 |
| | | | Example 1-12 | | |
| Example 1-27 | A-27 | 114 | Comparative | B-13 | Application |
| | | | Example 1-13 | | liquid |
| | | | | | preparation |
| | | | | | disabled |
| Example 1-28 | A-28 | 120 | Comparative | B-14 | 125 |
| | | | Example 1-14 | | |
| Example 1-29 | A-29 | 121 | Comparative | B-15 | Application |
| | | | Example 1-15 | | liquid |
| | | | | | preparation |
| | | | | | disabled |
| Example 1-30 | A-30 | 113 | Comparative | B-16 | 120 |
| | | | Example 1-16 | | |
| Example 1-31 | A-31 | 110 | Comparative | B-17 | Application |
| | | | Example 1-17 | | liquid |
| | | | | | preparation |
| | | | | | disabled |
| Example 1-52 | A-32 | 113 | Comparative | B-18 | 120 |
| | | | Example 1-18 | | |
| Example 1-33 | A-33 | 118 | Comparative | B-19 | 122 |
| | | | Example 1-19 | | |
| Example 1-34 | A-34 | 120 | Comparative | B-20 | 135 |
| | | | Example 1-20 | | |
| Example 1-35 | A-35 | 114 | Comparative | B-21 | 127 |
| | | | Example 1-21 | | |
| Example 1-36 | A-36 | 121 | Comparative | B-22 | Application |
| | | | Example 1-22 | | liquid |
| | | | | | preparation |
| | | | | | disabled |
| Example 1-37 | A-37 | 122 | Comparative | B-23 | 128 |
| | | | Example 1-23 | | |
| Example 1-38 | A-38 | 116 | Comparative | B-24 | 120 |
| | | | Example 1-24 | | |
| Example 1-39 | A-39 | 118 | Comparative | B-25 | Application |
| | | | Example 1-25 | | liquid |
| | | | | | preparation |
| | | | | | disabled |
| Example 1-40 | A-40 | 127 | | | |
| Example 1-41 | A-41 | 123 | | | |
| Example 1-42 | A-42 | 115 | | | |
| Example 1-43 | A-43 | 116 | | | |
| Example 1-44 | A-44 | 114 | | | |
| Example 1-45 | A-45 | 113 | | | |
| Example 1-46 | A-46 | 112 | | | |
| Example 1-47 | A-47 | 116 | | | |
| Example 1-48 | A-48 | 117 | | | |
| Example 1-49 | A-49 | 131 | | | |
| Example 1-50 | A-50 | 90 | | | |
| Example 1-51 | A-51 | 132 | | | |

TABLE 15

| | Positively | | | | | | | | | | | | | | | |
|---|---|---|---|---|---|---|---|---|---|---|---|---|---|---|---|---|
| | chargeable | | | | | | | | | | | | | | | |
| | multi- | | | | Charge generating layer | | | | | | | | | Scratch | | |
| | layer | Charge transport layer | | | | | | | | | | | Film | resist- | | |
| | photo- | Resin | | | Resin | | | | HTM | | ETM | | thick- | ance | | |
| | sensitive | | Molecular | | | Molecular | Amount | | | Amount | | Amount | ness | depth | Fogging | |
| | member | Type | weight | HTM | Type | weight | [part] | Ratio | Type | [part] | Type | [part] | [μm] | [μm] | FD | Grade |
| Example 2-1 | C-1 | R-1 | 62000 | H-10 | R-1 | 35200 | 100 | 0.45 | H-1 | 70 | E-1 | 50 | 15 | 0.32 | 0.003 | A |
| Example 2-2 | C-2 | R-1 | 62000 | H-10 | R-1 | 53100 | 100 | 0.45 | H-1 | 70 | E-1 | 50 | 15 | 0.36 | 0.006 | A |
| Example 2-3 | C-3 | R-1 | 62000 | H-10 | R-1 | 66000 | 100 | 0.45 | H-1 | 70 | E-1 | 50 | 15 | 0.36 | 0.005 | A |
| Example 2-4 | C-4 | R-1 | 62000 | H-10 | R-1 | 79000 | 100 | 0.45 | H-1 | 70 | E-1 | 50 | 15 | 0.41 | 0.007 | A |
| Example 2-5 | C-5 | R-1 | 62000 | H-10 | R-1 | 55000 | 100 | 0.45 | H-2 | 70 | E-1 | 50 | 15 | 0.31 | 0.003 | A |
| Example 2-6 | C-6 | R-1 | 62000 | H-10 | R-1 | 56000 | 100 | 0.45 | H-3 | 70 | E-1 | 50 | 15 | 0.32 | 0.002 | A |
| Example 2-7 | C-7 | R-1 | 62000 | H-10 | R-1 | 61000 | 100 | 0.45 | H-4 | 70 | E-1 | 50 | 15 | 0.40 | 0.003 | A |
| Example 2-8 | C-8 | R-1 | 62000 | H-10 | R-1 | 51000 | 100 | 0.45 | H-5 | 70 | E-1 | 50 | 15 | 0.43 | 0.005 | A |
| Example 2-9 | C-9 | R-1 | 62000 | H-10 | R-1 | 66000 | 100 | 0.45 | H-6 | 70 | E-1 | 50 | 15 | 0.36 | 0.007 | A |
| Example 2-10 | C-10 | R-1 | 62000 | H-10 | R-1 | 69000 | 100 | 0.45 | H-7 | 70 | E-1 | 50 | 15 | 0.31 | 0.000 | A |
| Example 2-11 | C-12 | R-1 | 62000 | H-10 | R-1 | 53000 | 100 | 0.45 | H-8 | 70 | E-1 | 50 | 15 | 0.40 | 0.007 | A |
| Example 2-12 | C-12 | R-1 | 62000 | H-10 | R-1 | 44000 | 100 | 0.45 | H-9 | 70 | E-1 | 50 | 15 | 0.39 | 0.006 | A |
| Example 2-13 | C-13 | R-1 | 62000 | H-10 | R-1 | 62000 | 100 | 0.45 | H-10 | 70 | E-1 | 50 | 15 | 0.35 | 0.004 | A |
| Example 2-14 | C-14 | R-1 | 62000 | H-10 | R-2 | 64200 | 100 | 0.45 | H-10 | 70 | E-1 | 50 | 15 | 0.42 | 0.005 | A |
| Example 2-15 | C-15 | R-1 | 62000 | H-10 | R-3 | 54500 | 100 | 0.45 | H-10 | 70 | E-1 | 50 | 15 | 0.45 | 0.005 | A |

TABLE 16

| | Positively | | | | | | | | | | | | | | | |
|---|---|---|---|---|---|---|---|---|---|---|---|---|---|---|---|---|
| | chargeable | | | | | | | | | | | | | | | |
| | multi- | Charge transport layer Charge generating layer | | | | | | | | | | | | Scratch | | |
| | layer | | | | | | | | | | | | Film | resist- | | |
| | photo- | Resin | | | Resin | | | | HTM | | ETM | | thick- | ance | | |
| | sensitive | | Molecular | | | Molecular | Amount | | | Amount | | Amount | ness | depth | Fogging | |
| | member | Type | weight | HTM | Type | weight | [part] | Ratio | Type | [part] | Type | [part] | [μm] | [μm] | FD | Grade |
| Example 2-16 | C-16 | R-1 | 62000 | H-10 | R-4 | 52700 | 100 | 0.45 | H-10 | 70 | E-1 | 50 | 15 | 0.47 | 0.004 | A |
| Example 2-17 | C-17 | R-1 | 62000 | H-10 | R-5 | 62300 | 100 | 0.45 | H-10 | 70 | E-1 | 50 | 15 | 0.38 | 0.003 | A |
| Example 2-18 | C-18 | R-1 | 62000 | H-10 | R-6 | 58000 | 100 | 0.45 | H-10 | 70 | E-1 | 50 | 15 | 0.40 | 0.005 | A |
| Example 2-19 | C-19 | R-1 | 62000 | H-10 | R-7 | 54300 | 100 | 0.45 | H-10 | 70 | E-1 | 50 | 15 | 0.41 | 0.006 | A |
| Example 2-20 | C-20 | R-1 | 62000 | H-10 | R-1 | 35200 | 100 | 0.45 | H-11 | 70 | E-1 | 50 | 13 | 0.87 | 0.031 | C |
| Example 2-21 | C-21 | R-1 | 62000 | H-10 | R-1 | 24000 | 100 | 0.45 | H-1 | 70 | E-1 | 50 | 15 | 0.33 | 0.040 | C |
| Example 2-22 | C-22 | R-1 | 62000 | H-10 | R-1 | 83000 | 100 | 0.45 | H-1 | 70 | E-1 | 50 | 15 | 0.35 | 0.018 | B |
| Example 2-23 | C-23 | R-1 | 52000 | H-10 | R-1 | 52000 | 90 | 0.42 | H-10 | 80 | E-1 | 40 | 30 | 0.36 | 0.003 | A |
| Example 2-24 | C-24 | R-1 | 52000 | H-10 | R-1 | 52000 | 68 | 0.36 | H-10 | 80 | E-1 | 40 | 30 | 0.40 | 0.006 | A |
| Example 2-25 | C-25 | R-1 | 52000 | H-10 | R-1 | 52000 | 116 | 0.49 | H-10 | 80 | E-1 | 40 | 30 | 0.17 | 0.002 | A |
| Example 2-26 | C-26 | R-1 | 52000 | H-10 | R-1 | 52000 | 90 | 0.42 | H-1 | 80 | E-1 | 40 | 30 | 0.31 | 0.006 | A |
| Example 2-27 | C-27 | R-1 | 52000 | H-10 | R-1 | 52000 | 90 | 0.42 | H-2 | 80 | E-1 | 40 | 30 | 0.34 | 0.002 | A |
| Example 2-28 | C-28 | R-1 | 52000 | H-10 | R-1 | 52000 | 90 | 0.42 | H-3 | 80 | E-1 | 40 | 30 | 0.35 | 0.003 | A |
| Example 2-29 | C-29 | R-1 | 52000 | H-10 | R-1 | 52000 | 90 | 0.42 | H-4 | 80 | E-1 | 40 | 30 | 0.37 | 0.002 | A |
| Example 2-30 | C-30 | R-1 | 52000 | H-10 | R-1 | 52000 | 90 | 0.42 | H-5 | 80 | E-1 | 40 | 30 | 0.40 | 0.005 | A |

TABLE 17

| | Positively | | | | | | | | | | | | | | | |
|---|---|---|---|---|---|---|---|---|---|---|---|---|---|---|---|---|
| | chargeable | | | | | | | | | | | | | | | |
| | multi- | | | | Charge generating layer | | | | | | | | | Scratch | | |
| | layer | Charge transport layer | | | | | | | | | | | Film | resist- | | |
| | photo- | Resin | | | Resin | | | | HTM | | ETM | | thick- | ance | | |
| | sensitive | | Molecular | | | Molecular | Amount | | | Amount | | Amount | ness | depth | Fogging | |
| | member | Type | weight | HTM | Type | weight | [part] | Ratio | Type | [part] | Type | [part] | [μm] | [μm] | FD | Grade |
| Example 2-31 | C-31 | R-1 | 52000 | H-10 | R-1 | 52000 | 90 | 0.42 | H-6 | 80 | E-1 | 40 | 30 | 0.36 | 0.007 | A |
| Example 2-32 | C-32 | R-1 | 52000 | H-10 | R-1 | 52000 | 90 | 0.42 | H-7 | 80 | E-1 | 40 | 30 | 0.32 | 0.008 | A |
| Example 2-33 | C-33 | R-1 | 52000 | H-10 | R-1 | 52000 | 90 | 0.42 | H-8 | 80 | E-1 | 40 | 30 | 0.38 | 0.008 | A |
| Example 2-34 | C-34 | R-1 | 52000 | H-10 | R-1 | 52000 | 90 | 0 42 | H-9 | 80 | E-1 | 40 | 30 | 0.34 | 0.007 | A |
| Example 2-35 | C-35 | R-1 | 52000 | H-10 | R-1 | 52000 | 90 | 0.42 | H-10 | 80 | E-2 | 40 | 30 | 0.32 | 0.004 | A |
| Example 2-36 | C-36 | R-1 | 52000 | H-10 | R-1 | 52000 | 90 | 0.42 | H-10 | 80 | E-3 | 40 | 30 | 0.29 | 0.008 | A |
| Example 2-37 | C-37 | R-1 | 52000 | H-10 | R-1 | 52000 | 90 | 0.42 | H-10 | 80 | E-4 | 40 | 30 | 0.34 | 0.007 | A |
| Example 2-38 | C-38 | R-1 | 52000 | H-10 | R-1 | 52000 | 90 | 0.42 | H-10 | 80 | E-5 | 40 | 30 | 0.39 | 0.007 | A |
| Example 2-39 | C-39 | R-1 | 52000 | H-10 | R-1 | 52000 | 90 | 0.42 | H-10 | 80 | E-6 | 40 | 30 | 0.40 | 0.005 | A |
| Example 2-40 | C-40 | R-1 | 52000 | H-10 | R-1 | 52000 | 90 | 0.42 | H-10 | 80 | E-7 | 40 | 30 | 0.22 | 0.003 | A |
| Example 2-41 | C-41 | R-1 | 52000 | H-10 | R-1 | 52000 | 90 | 0.42 | H-10 | 80 | E-8 | 40 | 30 | 0.33 | 0.006 | A |
| Example 2-42 | C-42 | R-1 | 52000 | H-10 | R-2 | 64200 | 90 | 0.42 | H-10 | 80 | E-1 | 40 | 30 | 0.41 | 0.007 | A |
| Example 2-43 | C-43 | R-1 | 52000 | H-10 | R-3 | 54500 | 90 | 0.42 | H-10 | 80 | E-1 | 40 | 30 | 0.30 | 0.008 | A |
| Example 2-44 | C-44 | R-1 | 52000 | H-10 | R-4 | 52700 | 90 | 0.42 | H-10 | 80 | E-1 | 40 | 30 | 0.28 | 0.003 | A |
| Example 2-45 | C-45 | R-1 | 52000 | H-10 | R-5 | 62300 | 90 | 0.42 | H-10 | 80 | E-1 | 40 | 30 | 0.44 | 0.009 | A |

TABLE 18

| | Positively | | | | | | | | | | | | | | | |
|---|---|---|---|---|---|---|---|---|---|---|---|---|---|---|---|---|
| | chargeable | | | | | | | | | | | | | | | |
| | multi- | | | | Charge generating layer | | | | | | | | | Scratch | | |
| | layer | Charge transport layer | | | | | | | | | | | Film | resist- | | |
| | photo- | Resin | | | Resin | | | | HTM | | ETM | | thick- | ance | | |
| | sensitive | | Molecular | | | Molecular | Amount | | | Amount | | Amount | ness | depth | Fogging | |
| | member | Type | weight | HTM | Type | weight | [part] | Ratio | type | [part] | Type | [part] | [μm] | [μm] | FD | Grade |
| Example 2-46 | C-46 | R-1 | 52000 | H-10 | R-6 | 58000 | 90 | 0.42 | H-10 | 80 | E-1 | 40 | 30 | 0.37 | 0.008 | A |
| Example 2-47 | C-47 | R-1 | 52000 | H-10 | R-7 | 54300 | 90 | 0.42 | H-10 | 80 | E-1 | 40 | 30 | 0.38 | 0.007 | A |
| Example 2-48 | C-48 | R-1 | 52000 | H-10 | R-1 | 52000 | 90 | 0.42 | H-10 | 80 | E-9 | 40 | 30 | 0.35 | 0.005 | A |
| Example 2-49 | C-49 | R-1 | 52000 | H-10 | R-1 | 52000 | 90 | 0.42 | H-11 | 80 | E-1 | 40 | 15 | 0.74 | 0.043 | C |
| Example 2-50 | C-50 | R-1 | 52000 | H-10 | R-1 | 52000 | 60 | 0.33 | H-10 | 80 | E-1 | 40 | 15 | 0.50 | 0.019 | B |
| Example 2-51 | C-51 | R-1 | 52000 | H-10 | R-1 | 52000 | 125 | 0.51 | H-10 | 80 | E-1 | 40 | 15 | 0.10 | 0.015 | B |
| Example 2-52 | C-52 | R-1 | 51000 | H-10 | R-1 | 51000 | 100 | 0.45 | H-1 | 70 | E-1 | 50 | 15 | 0.38 | 0.008 | A |
| Example 2-53 | C-53 | R-1 | 51000 | H-10 | R-1 | 51000 | 100 | 0.45 | H-1 | 70 | E-2 | 50 | 15 | 0.37 | 0.008 | A |
| Example 2-54 | C-54 | R-1 | 51000 | H-10 | R-1 | 51000 | 100 | 0.45 | H-1 | 70 | E-3 | 50 | 15 | 0.38 | 0.007 | A |
| Example 2-55 | C-55 | R-1 | 51000 | H-10 | R-1 | 51000 | 100 | 0.45 | H-1 | 70 | E-4 | 50 | 15 | 0.40 | 0.008 | A |
| Example 2-56 | C-56 | R-1 | 51000 | H-10 | R-1 | 51000 | 100 | 0.45 | H-1 | 70 | E-5 | 50 | 15 | 0.44 | 0.009 | A |
| Example 2-57 | C-57 | R-1 | 51000 | H-10 | R-1 | 51000 | 100 | 0.45 | H-1 | 70 | E-6 | 50 | 15 | 0.37 | 0.007 | A |
| Example 2-58 | C-58 | R-1 | 51000 | H-10 | R-1 | 51000 | 100 | 0.45 | H-1 | 70 | E-7 | 50 | 15 | 0.41 | 0.008 | A |
| Example 2-59 | C-59 | R-1 | 51000 | H-10 | R-1 | 51000 | 100 | 0.45 | H-1 | 70 | E-8 | 50 | 15 | 0.33 | 0.004 | A |
| Example 2-60 | C-60 | R-1 | 51000 | H-10 | R-1 | 51000 | 100 | 0.45 | H-2 | 70 | E-1 | 50 | 15 | 0.32 | 0.003 | A |

TABLE 19

| | Positively | | | | | | | | | | | | | | | |
|---|---|---|---|---|---|---|---|---|---|---|---|---|---|---|---|---|
| | chargeable | | | | | | | | | | | | | | | |
| | multi- | | | | Charge generating layer | | | | | | | | | Scratch | | |
| | layer | Charge transport layer | | | | | | | | | | | Film | resist- | | |
| | photo- | Resin | | | Resin | | | | HTM | | ETM | | thick- | ance | | |
| | sensitive | | Molecular | | | Molecular | Amount | | | Amount | | Amount | ness | depth | Fogging | |
| | member | Type | weight | HTM | Type | weight | [part] | Ratio | Type | [part] | Type | [part] | [μm] | [μm] | FD | Grade |
| Example 2-61 | C-61 | R-1 | 51000 | H-10 | R-1 | 51000 | 100 | 0.45 | H-3 | 70 | E-1 | 50 | 15 | 0.40 | 0.007 | A |
| Example 2-62 | C-62 | R-1 | 51000 | H-10 | R-1 | 51000 | 100 | 0.45 | H-4 | 70 | E-1 | 50 | 15 | 0.45 | 0.007 | A |
| Example 2-63 | C-63 | R-1 | 51000 | H-10 | R-1 | 51000 | 100 | 0.45 | H-5 | 70 | E-1 | 50 | 15 | 0.35 | 0.007 | A |
| Example 2-64 | C-64 | R-1 | 51000 | H-10 | R-1 | 51000 | 100 | 0.45 | H-6 | 70 | E-1 | 50 | 15 | 0.31 | 0.003 | A |
| Example 2-65 | C-65 | R-1 | 51000 | H-10 | R-1 | 51000 | 100 | 0.45 | H-7 | 70 | E-1 | 50 | 15 | 0.40 | 0.005 | A |
| Example 2-66 | C-66 | R-1 | 51000 | H-10 | R-1 | 51000 | 100 | 0.45 | H-8 | 70 | E-1 | 50 | 15 | 0.41 | 0.004 | A |
| Example 2-67 | C-67 | R-1 | 51000 | H-10 | R-1 | 51000 | 100 | 0.45 | H-9 | 70 | E-1 | 50 | 15 | 0.36 | 0.004 | A |
| Example 2-68 | C-68 | R-1 | 51000 | H-10 | R-2 | 64200 | 100 | 0.45 | H-1 | 70 | E-1 | 50 | 15 | 0.47 | 0.005 | A |
| Example 2-69 | C-69 | R-1 | 51000 | H-10 | R-3 | 54500 | 100 | 0.45 | H-1 | 70 | E-1 | 50 | 15 | 0.38 | 0.003 | A |
| Example 2-70 | C-70 | R-1 | 51000 | H-10 | R-4 | 52700 | 100 | 0.45 | H-1 | 70 | E-1 | 50 | 15 | 0.40 | 0.007 | A |
| Example 2-71 | C-71 | R-1 | 51000 | H-10 | R-5 | 62300 | 100 | 0.45 | H-1 | 70 | E-1 | 50 | 15 | 0.49 | 0.008 | A |
| Example 2-72 | C-72 | R-1 | 51000 | H-10 | R-6 | 58000 | 100 | 0.45 | H-1 | 70 | E-1 | 50 | 15 | 0.43 | 0.007 | A |
| Example 2-73 | C-73 | R-1 | 51000 | H-10 | R-7 | 54300 | 100 | 0.45 | H-1 | 70 | E-1 | 50 | 15 | 0.42 | 0.006 | A |
| Example 2-74 | C-74 | R-1 | 51000 | H-10 | R-1 | 51000 | 100 | 0.45 | H-1 | 70 | E-9 | 50 | 15 | 0.41 | 0.005 | A |
| Example 2-75 | C-75 | R-1 | 51000 | H-10 | R-1 | 51000 | 100 | 0.45 | H-10 | 70 | E-1 | 50 | 15 | 0.35 | 0.004 | A |

TABLE 20

| | Posi- | | | | | | | | | | | | | | | |
|---|---|---|---|---|---|---|---|---|---|---|---|---|---|---|---|---|
| | tively | | | | | | | | | | | | | | | |
| | charge- | | | | | | | | | | | | | | | |
| | able | | | | | | | | | | | | | | | |
| | multi- | | | | Charge generating layer | | | | | | | | | Scratch | | |
| | layer | Charge transport layer | | | | | | | | | | | Film | resist- | | |
| | photo- | Resin | | | Resin | | | | HTM | | ETM | | thick- | ance | | |
| | sensitive | | Molecular | | | Molecular | Amount | | | Amount | | Amount | ness | depth | Fogging | |
| | member | Type | weight | HTM | Type | weight | [part] | Ratio | Type | [part] | Type | [part] | [μm] | [μm] | FD | Grade |
| Comparative Example 2-1 | D-1 | R-1 | 62000 | H-10 | R-8 | 65000 | 100 | 0.45 | H-2 | 70 | E-1 | 50 | 15 | 1.54 | 0.104 | D |
| Comparative Example 2-2 | D-2 | R-1 | 62000 | H-10 | R-9 | 52000 | 100 | 0.45 | H-2 | 70 | E-1 | 50 | 15 | 1.18 | 0.082 | D |
| Comparative Example 2-3 | D-3 | R-1 | 62000 | H-10 | R-10 | 58000 | 100 | 0.45 | H-2 | 70 | E-1 | 50 | 15 | 1.03 | 0.070 | D |
| Comparative Example 2-4 | D-4 | R-1 | 62000 | H-10 | R-11 | 51000 | 100 | 0.45 | H-2 | 70 | E-1 | 50 | 15 | 0.97 | 0.048 | D |
| Comparative Example 2-5 | D-5 | R-1 | 51000 | H-10 | R-8 | 65000 | 100 | 0.45 | H-2 | 70 | E-4 | 50 | 15 | 1.54 | 0.109 | D |
| Comparative Example 2-6 | D-6 | R-1 | 51000 | H-10 | R-9 | 52000 | 100 | 0.45 | H-2 | 70 | E-4 | 50 | 15 | 1.20 | 0.083 | D |
| Comparative Example 2-7 | D-7 | R-1 | 51000 | H-10 | R-10 | 58000 | 100 | 0.45 | H-2 | 70 | E-4 | 50 | 15 | 1.09 | 0.074 | D |
| Comparative Example 2-8 | D-5 | R-1 | 51000 | H-10 | R-11 | 51000 | 100 | 0.45 | H-2 | 70 | E-4 | 50 | 15 | 0.97 | 0.043 | D |
| Comparative Example 2-9 | D-9 | R-1 | 52000 | H-10 | R-8 | 65000 | 90 | 0.42 | H-10 | 80 | E-1 | 40 | 15 | 1.63 | 0.105 | D |
| Comparative Example 2-10 | D-10 | R-1 | 52000 | H-10 | R-9 | 52000 | 90 | 0.42 | H-10 | 80 | E-1 | 40 | 15 | 1.23 | 0.081 | D |
| Comparative Example 2-11 | D-11 | R-1 | 52000 | H-10 | R-10 | 58000 | 90 | 0.42 | H-10 | 80 | E-1 | 40 | 15 | 0.06 | 0.660 | D |
| Comparative Example 2-12 | D-12 | R-1 | 52000 | H-10 | R-11 | 51000 | 90 | 0.42 | H-10 | 80 | E-1 | 40 | 15 | 0.97 | 0.065 | D |

TABLE 21

| | Posi- tively | | | | | | | | | | | | | | | |
|---|---|---|---|---|---|---|---|---|---|---|---|---|---|---|---|---|
| | charge- able | | | | | | | | | | | | | | | |
| | muiti- | | | | Charge generating layer | | | | | | | | | Scratch | | |
| | layer | Charge transport layer | | | | | | | | | | | Film | resist- | | |
| | photo- | Resin | | | Resin | | | | HTM | | ETM | | thick- | ance | | |
| | sensitive | | Molecular | | | Molecular | Amount | | | Amount | | Amount | ness | depth | Fogging | |
| | member | Type | weight | HTM | Type | weight | [part] | Ratio | Type | [part] | Type | [part] | [μm] | [μm] | FD | Grade |
| Comparative Example 2-13 | D-13 | R-1 | 62000 | H-10 | R-12 | 58600 | 100 | 0.45 | H-10 | 70 | E-1 | 50 | Application liquid preparation disabled | | | |
| Comparative Example 2-14 | D-14 | R-1 | 62000 | H-10 | R-13 | 57200 | 100 | 0.45 | H-10 | 70 | E-1 | 50 | 15 | 0.61 | 0.048 | D |
| Comparative Example 2-15 | D-15 | R-1 | 62000 | H-10 | R-14 | 56600 | 100 | 0.45 | H-10 | 70 | E-1 | 50 | Application liquid preparation disabled | | | |
| Comparative Example 2-16 | D-16 | R-1 | 62000 | H-10 | R-15 | 61000 | 100 | 0.45 | H-10 | 70 | E-1 | 50 | 15 | 0.60 | 0.051 | D |
| Comparative Example 2-17 | D-17 | R-1 | 62009 | H-10 | R-16 | Un- measurable | 100 | 0.45 | H-10 | 70 | E-1 | 50 | Application liquid preparation disabled | | | |
| Comparative Example 2-18 | D-18 | R-1 | 62090 | H-10 | R-17 | 49900 | 100 | 0.45 | H-10 | 70 | E-1 | 50 | 15 | 1.02 | 0.074 | D |
| Comparative Example 2-19 | D-19 | R-1 | 62000 | H-10 | R-18 | 50800 | 100 | 0.45 | H-10 | 70 | E-1 | 50 | 15 | 1.24 | 0.089 | D |
| Comparative Example 2-20 | D-20 | R-1 | 62090 | H-10 | R-19 | 52100 | 100 | 0.45 | H-10 | 70 | E-1 | 50 | 15 | 9 93 | 0.055 | D |
| Comparative Example 2-21 | D-21 | R-1 | 62000 | H-10 | R-20 | 53500 | 100 | 0.45 | H-10 | 70 | E-1 | 50 | 15 | 0.95 | 0.052 | D |
| Comparative Example 2-22 | D-22 | R-1 | 62000 | H-10 | R-21 | Un- measurable | 100 | 0.45 | H-10 | 70 | E-1 | 50 | Application liquid preparation disabled | | | |
| Comparative Example 2-23 | D-23 | R-1 | 62090 | H-10 | R-22 | 48100 | 100 | 0.45 | H-10 | 70 | E-1 | 50 | 15 | 1.11 | 0.071 | D |
| Comparative Example 2-24 | D-24 | R-1 | 62909 | H-10 | R-23 | 56900 | 100 | 0.45 | H-10 | 70 | E-1 | 50 | 15 | 1.01 | 0.055 | D |

| | | | | | | | | | | | | | |
|---|---|---|---|---|---|---|---|---|---|---|---|---|---|
| Comparative Example 2-25 | D-25 | R-1 | 62090 | H-10 | R-24 | 42300 | 100 | 0.45 | H-10 | 70 | E-1 | 50 | Application liquid preparation disabled |

TABLE 22

| | Positively | | | Positively | |
|---|---|---|---|---|---|
| | chargeable | | | chargeable | |
| | multi-layer | Strain | | multi-layer | Strain |
| | photosensitive | at break | | photosensitive | at break |
| | member | [%] | | member | [%] |
| Example 2-1 | C-1 | 10.3 | Example 2-21 | C-21 | 7.4 |
| Example 2-2 | C-2 | 14.8 | Example 2-22 | C-22 | 22.8 |
| Example 2-3 | C-3 | 18.2 | Comparative | D-1 | 8.1 |
| | | | Example 2-1 | | |
| Example 2-4 | C-4 | 20.8 | Comparative | D-2 | 9.4 |
| | | | Example 2-2 | | |
| Example 2-5 | C-5 | 13.9 | Comparative | D-3 | 10.7 |
| | | | Example 2-3 | | |
| Example 2-6 | C-6 | 15.6 | Comparative | D-4 | 12.7 |
| | | | Example 2-4 | | |
| Example 2-7 | C-7 | 16.8 | Comparative | D-13 | Application |
| | | | Example 2-13 | | liquid |
| | | | | | preparation |
| | | | | | disabled |
| Example 2-8 | C-8 | 14.2 | Comparative | D-14 | 4.2 |
| | | | Example 2-14 | | |
| Example 2-9 | C-9 | 16.5 | Comparative | D-15 | Application |
| | | | Example 2-15 | | liquid |
| | | | | | preparation |
| | | | | | disabled |
| Example 2-10 | C-10 | 19.0 | Comparative | D-16 | 4.3 |
| | | | Example 2-16 | | |
| Example 2-11 | C-11 | 15.0 | Comparative | D-17 | Application |
| | | | Example 2-17 | | liquid |
| | | | | | preparation |
| | | | | | disabled |
| Example 2-12 | C-12 | 12.4 | Comparative | D-18 | 6.7 |
| | | | Example 2-18 | | |
| Example 2-13 | C-13 | 17.0 | Comparative | D-19 | 5.7 |
| | | | Example 2-19 | | |
| Example 2-14 | C-14 | 17.4 | Comparative | D-20 | 7.4 |
| | | | Example 2-20 | | |
| Example 2-15 | C-15 | 14.7 | Comparative | D-21 | 7.3 |
| | | | Example 2-21 | | |
| Example 2-16 | C-16 | 14.0 | Comparative | D-22 | Application |
| | | | Example 2-22 | | liquid |
| | | | | | preparation |
| | | | | | disabled |
| Example 2-17 | C-17 | 17.0 | Comparative | D-23 | 6.2 |
| | | | Example 2-23 | | |
| Example 2-18 | C-18 | 16.0 | Comparative | D-24 | 6.8 |
| | | | Example 2-24 | | |
| Example 2-19 | C-19 | 15.1 | Comparative | D-25 | Application |
| | | | | | liquid |
| | | | | | preparation |
| | | | | | disabled |
| Example 2-20 | C-20 | 10.4 | Example 2-25 | | |

TABLE 23

| | Positively | | | Positively | |
|---|---|---|---|---|---|
| | chargeable | | | chargeable | |
| | multi-layer | | | multi-layer | |
| | photosensitive | Hardness | | photosensitive | Hardness |
| | member | [HV] | | member | [HV] |
| Example 2-75 | C-75 | 23.0 | Example 2-72 | C-72 | 20.2 |
| Example 2-52 | C-52 | 20.1 | Example 2-73 | C-73 | 20.4 |
| Example 2-53 | C-53 | 20.0 | Example 2-74 | C-74 | 20.1 |
| Example 2-54 | C-54 | 20.2 | Comparative | D-5 | 11.2 |
| | | | Example 2-5 | | |
| Example 2-55 | C-55 | 19.2 | Comparative | D-6 | 13.5 |
| | | | Example 2-6 | | |
| Example 2-56 | C-56 | 19.1 | Comparative | D-7 | 14.6 |
| | | | Example 2-7 | | |
| Example 2-57 | C-57 | 20.0 | Comparative | D-8 | 15.9 |
| | | | Example 2-8 | | |
| Example 2-58 | C-58 | 19.3 | Comparative | D-13 | Application |
| | | | Example 2-13 | | liquid |
| | | | | | preparation |
| | | | | | disabled |
| Example 2-59 | C-59 | 22.1 | Comparative | D-14 | 18.1 |
| | | | Example 2-14 | | |
| Example 2-60 | C-60 | 22.0 | Comparative | D-15 | Application |
| | | | Example 2-15 | | liquid |
| | | | | | preparation |
| | | | | | disabled |
| Example 2-61 | C-61 | 19.2 | Comparative | D-16 | 18.0 |
| | | | Example 2-16 | | |
| Example 2-62 | C-62 | 19.1 | Comparative | D-17 | Application |
| | | | Example 2-17 | | liquid |
| | | | | | preparation |
| | | | | | disabled |
| Example 2-63 | C-63 | 20.9 | Comparative | D-18 | 13.4 |
| | | | Example 2-18 | | |
| Example 2-64 | C-64 | 23.4 | Comparative | D-19 | 10.6 |
| | | | Example 2-19 | | |
| Example 2-65 | C-65 | 19.5 | Comparative | D-20 | 14.2 |
| | | | Example 2-20 | | |
| Example 2-66 | C-66 | 19.4 | Comparative | D-21 | 14.2 |
| | | | Example 2-21 | | |
| Example 2-67 | C-67 | 20.3 | Comparative | D-22 | Application |
| | | | Example 2-22 | | liquid |
| | | | | | preparation |
| | | | | | disabled |
| Example 2-68 | C-68 | 22.0 | Comparative | D-23 | 13.1 |
| | | | Example 2-23 | | |
| Example 2-69 | C-69 | 23.4 | Comparative | D-24 | 13.2 |
| | | | Example 2-24 | | |
| Example 2-70 | C-70 | 20.1 | Comparative | D-25 | Application |
| | | | Example 2-25 | | liquid |
| | | | | | preparation |
| | | | | | disabled |
| Example 2-71 | C-71 | 19.7 | | | |

TABLE 24

| | Positively | | | Positively | |
|---|---|---|---|---|---|
| | chargeable | | | chargeable | |
| | multi-layer | Abrasion | | multi-layer | Abrasion |
| | photosensitive | amount | | photosensitive | amount |
| | member | [μm] | | member | [μm] |
| Example 2-1 | C-1 | 2.1 | Comparative | D-1 | 9.5 |
| | | | Example 2-1 | | |
| Example 2-2 | C-2 | 1.9 | Comparative | D-2 | 8.2 |
| | | | Example 2-2 | | |
| Example 2-3 | C-3 | 1.6 | Comparative | D-3 | 7.0 |
| | | | Example 2-3 | | |
| Example 2-4 | C-4 | 1.3 | Comparative | D-4 | 5.7 |
| | | | Example 2-4 | | |
| Example 2-5 | C-5 | 1.6 | Comparative | D-13 | Application |
| | | | Example 2-13 | | liquid |
| | | | | | preparation |
| | | | | | disabled |
| Example 2-6 | C-6 | 1.5 | Comparative | D-14 | 4.4 |
| | | | Example 2-14 | | |
| Example 2-7 | C-7 | 1.8 | Comparative | D-15 | Application |
| | | | Example 2-15 | | liquid |
| | | | | | preparation |
| | | | | | disabled |
| Example 2-8 | C-8 | 2.3 | Comparative | D-16 | 4.5 |
| | | | Example 2-16 | | |
| Example 2-9 | C-9 | 1.5 | Comparative | D-17 | Application |
| | | | Example 2-17 | | liquid |
| | | | | | preparation |
| | | | | | disabled |
| Example 2-10 | C-10 | 1.3 | Comparative | D-18 | 9.7 |
| | | | Example 2-18 | | |
| Example 2-11 | C-11 | 2.0 | Comparative | D-19 | 11.2 |
| | | | Example 2-19 | | |
| Example 2-12 | C-12 | 2.2 | Comparative | D-20 | 8.4 |
| | | | Example 2-20 | | |
| Example 2-13 | C-13 | 2.4 | Comparative | D-21 | 8.4 |
| | | | Example 2-21 | | |
| Example 2-14 | C-14 | 2.2 | Comparative | D-22 | Application |
| | | | Example 2-22 | | liquid |
| | | | | | preparation |
| | | | | | disabled |
| Example 2-15 | C-15 | 2.4 | Comparative | D-23 | 10.2 |
| | | | Example 2-23 | | |
| Example 2-16 | C-16 | 2.3 | Comparative | D-24 | 9.2 |
| | | | Example 2-24 | | |
| Example 2-17 | C-17 | 1.6 | Comparative | D-25 | Application |
| | | | Example 2-25 | | liquid |
| | | | | | preparation |
| | | | | | disabled |
| Example 2-18 | C-18 | 1.8 | | | |
| Example 2-19 | C-19 | 1.9 | | | |
| Example 2-20 | C-20 | 5.8 | | | |
| Example 2-21 | C-21 | 4.7 | | | |
| Example 2-22 | C-22 | 0.8 | | | |

TABLE 25

| | Positively | | | Positively | |
|---|---|---|---|---|---|
| | chargeable | | | chargeable | |
| | multi-layer | | | multi-layer | |
| | photosensitive | V_{L} | | photosensitive | V_{L} |
| | member | [+V] | | member | [+V] |
| Example 2-23 | C-23 | 109 | Comparative | D-9 | 105 |
| | | | Example 2-9 | | |
| Example 2-24 | C-24 | 89 | Comparative | D-30 | 131 |
| | | | Example 2-10 | | |
| Example 2-25 | C-25 | 122 | Comparative | D-11 | 110 |
| | | | Example 2-11 | | |
| Example 2-26 | C-26 | 110 | Comparative | D-12 | 131 |
| | | | Example 2-12 | | |
| Example 2-27 | C-27 | 111 | Comparative | D-13 | Application |
| | | | Example 2-13 | | liquid |
| | | | | | preparation |
| | | | | | disabled |
| Example 2-28 | C-28 | 118 | Comparative | D-14 | 121 |
| | | | Example 2-14 | | |
| Example 2-29 | C-29 | 120 | Comparative | D-15 | Application |
| | | | Example 2-15 | | liquid |
| | | | | | preparation |
| | | | | | disabled |
| Example 2-30 | C-30 | 112 | Comparative | D-16 | 118 |
| | | | Example 2-16 | | |
| Example 2-31 | C-31 | 109 | Comparative | D-17 | Application |
| | | | Example 2-17 | | liquid |
| | | | | | preparation |
| | | | | | disabled |
| Example 2-32 | C-32 | 111 | Comparative | D-18 | 119 |
| | | | Example 2-18 | | |
| Example 2-33 | C-33 | 117 | Comparative | D-19 | 121 |
| | | | Example 2-19 | | |
| Example 2-34 | C-34 | 119 | Comparative | D-20 | 133 |
| | | | Example 2-20 | | |
| Example 2-35 | C-35 | 112 | Comparative | D-21 | 122 |
| | | | Example 2-21 | | |
| Example 2-36 | C-36 | 120 | Comparative | D-22 | Application |
| | | | Example 2-22 | | liquid |
| | | | | | preparation |
| | | | | | disabled |
| Example 2-37 | C-37 | 123 | Comparative | D-23 | 125 |
| | | | Example 2-23 | | |
| Example 2-38 | C-38 | 117 | Comparative | D-24 | 115 |
| | | | Example 2-24 | | |
| Example 2-39 | C-39 | 117 | Comparative | D-25 | Application |
| | | | Example 2-25 | | liquid |
| | | | | | preparation |
| | | | | | disabled |
| Example 2-40 | C-40 | 125 | | | |
| Example 2-41 | C-41 | 105 | | | |
| Example 2-42 | C-42 | 111 | | | |
| Example 2-43 | C-43 | 112 | | | |
| Example 2-44 | C-44 | 111 | | | |
| Example 2-45 | C-45 | 110 | | | |
| Example 2-46 | C-46 | 109 | | | |
| Example 2-47 | C-47 | 113 | | | |
| Example 2-48 | C-48 | 115 | | | |
| Example 2-49 | C-49 | 131 | | | |
| Example 2-50 | C-50 | 89 | | | |
| Example 2-51 | C-51 | 133 | | | |

As can be understood from formulas (R-8) to (R-11), the resins (R-8) to (R-11) were not resins encompassed in the polyarylate resin (PA). As can be understood from Table 3, the resins (R-12) to (R-24) were not resins encompassed in the polyarylate resin (PA). Therefore, the resins (R-12), (R-14), (R-16), (R-21), and (R-24) did not dissolved in a solvent for preparing an application liquid for single-layer photosensitive layer formation to disable preparation of the application liquid for single-layer photosensitive layer formation, thereby disabling formation of a photosensitive layer (specifically, a single-layer photosensitive layer) as shown in Table 10. As also shown in Tables 9 and 10, anti-fogging property was poor in the single-layer photosensitive members (B-1) to (B-12), (B-14), (B-16), (B-18) to (B-21), (B-23), and (B-24) each including a single-layer photosensitive layer containing any of the resins (R-8) to (R-11), (R-13), (R-15), (R-17) to (R-20), (R-22), and (R-23). As shown in Table 21, the resins (R-12), (R-14), (R-16), (R-21), and (R-24) did not dissolved in a solvent for preparing an application liquid for charge generating layer formation to disable preparation of the application liquid for charge generating layer formation, thereby disabling formation of a photosensitive layer (specifically, a charge generating layer). As shown in Tables 20 and 21, anti-fogging property was poor in the positively chargeable multi-layer photosensitive members (D-1) to (D-12), (D-14), (D-16), (D-18) to (D-21), (D-23), and (D-24) each including a charge generating layer containing any of the resins (R-8) to (R-11), (R-13), (R-15), (R-17) to (R-20), (R-22), and (R-23).

By contrast, as can be understood from Table 3, the resins (R-1) to (R-7) were resins encompassed in the polyarylate resin (PA). Therefore, as shown in Tables 4 to 8, anti-fogging property was good in the single-layer photosensitive members (A-1) to (A-70) each including a single-layer photosensitive layer containing any of the resins (R-1) to (R-7). Furthermore, as shown in Tables 15 to 19, anti-fogging property was good in the positively chargeable multi-layer photosensitive members (C-1) to (C-75) each including a charge generating layer containing any of the resins (R-1) to (R-7).

As shown in Table 11, the single-layer photosensitive layer of the single-layer photosensitive member (A-21) had a strain at break of less than 7.5%. As shown in Table 13, the single-layer photosensitive members (A-1) to (A-20) and (A-22) each had an abrasion amount less than the abrasion amount of the single-layer photosensitive member (A-21). As shown in Table 22, the charge generating layer of the positively chargeable multi-layer photosensitive member (C-21) had a strain at break of less than 7.5%. As shown in Table 22, the single-layer photosensitive members (C-1) to (C-20) and (C-22) each had an abrasion amount less than the abrasion amount of the single-layer photosensitive member (A-21). Therefore, it can be determined that a photosensitive member including a first photosensitive layer (single-layer photosensitive layer or charge generating layer) with a strain at break of at least 7.5% is excellent in abrasion resistance in addition to anti-fogging property.

As shown in Table 11, the single-layer photosensitive layer of the single-layer photosensitive member (A-22) had a strain at break of greater than 21.0%. As shown in Table 5, anti-fogging property of the single-layer photosensitive member (A-22) was graded B. As shown in Table 22, the charge generating layer of the positively chargeable multi-layer photosensitive member (C-22) had a strain at break of greater than 21.0%. As shown in Table 16, anti-fogging property of the positively chargeable multi-layer photosensitive member (C-22) was graded B. It can be determined that anti-fogging property of a photosensitive member including the first photosensitive layer (the single-layer photosensitive layer or the charge generating layer) with a strain at break of no greater than 21.0% can be further improved over the grade B.

As shown in Table 12, the single-layer photosensitive members (A-14) to (A-19), (A-52) to (A-67), and (A-70) each had a Vickers hardness of at least 19.0 HV. The single-layer photosensitive members (B-5) to (B-8). (B-14), (B-16), (B-18) to (B-21), (B-23), and (B-24) each had a Vickers hardness of less than 19.0 HV. As shown in Tables 4 to 10, the single-layer photosensitive members (A-14) to (A-19), (A-52) to (A-67), and (A-70) were more excellent in anti-fogging property than the single-layer photosensitive members (B-5) to (B-8), (B-14), (B-16), (B-18) to (B-21), (B-23), and (B-24). As shown in Table 23, the positively chargeable multi-layer photosensitive members (C-52) to (C-75) each had a Vickers hardness of at least 19.0 HV. The positively chargeable multi-layer photosensitive members (D-5) to (D-8), (D-14), (D-16), (D-18) to (D-21), (D-23), and (D-24) each had a Vickers hardness of less than 19.0 HV. As shown in Tables 15 to 21, the positively chargeable multi-layer photosensitive members (C-52) to (C-75) were more excellent in anti-fogging property than the positively chargeable multi-layer photosensitive members (D-5) to (D-8), (D-14), (D-16), (D-18) to (D-21), (D-23), and (D-24). Therefore, it is determined that anti-fogging property of a photosensitive member is further improved by the first photosensitive layer (the single-layer photosensitive layer and the charge generating layer) having a Vickers hardness of at least 19.0 HV.

As shown in Table 7, the single-layer photosensitive member (A-49) contained the hole transport material (H-li) encompassed in formula (25) as the hole transport material (SL). As shown in Table 14, the single-layer photosensitive member (A-49) had a post-exposure potential of greater than +130 V. As shown in Tables 5 to 7, the single-layer photosensitive members (A-23) to (A-48) and (A-50) each contained a hole transport material encompassed in formula (20), (21), (22), (23), or (24). As shown in Table 14, the single-layer photosensitive members (A-23) to (A-48) and (A-50) each had a post-exposure potential of no greater than +130 V. As shown in Table 18, the positively chargeable multi-layer photosensitive member (C-49) contained the hole transport material (H-li) encompassed in formula (25) as the hole transport material (CG). As shown in Table 25, the positively chargeable multi-layer photosensitive member (C-49) had a post-exposure potential of greater than +130 V. As shown in Tables 16 to 18, the positively chargeable multi-layer photosensitive members (C-23) to (C-48) and (C-50) each contained a hole transport material encompassed in formula (20), (21), (22), (23), or (24). As shown in Table 25, the positively chargeable multi-layer photosensitive members (C-23) to (C-48) and (C-50) each had a post-exposure potential of no greater than +130 V. Therefore, it is determined that sensitivity characteristics of a photosensitive member are improved in addition to anti-fogging property of the photosensitive member by including the first photosensitive layer (the single-layer photosensitive layer or the charge generating layer) containing the hole transport material (20), (21), (22), (23), or (24).

As shown in Table 7, the ratio of the mass of the binder resin (SL) of the single-layer photosensitive member (A-51) to the mass of the single-layer photosensitive layer was greater than 0.50. As shown in Table 14, the single-layer photosensitive member (A-51) had a post-exposure potential of greater than +130 V. As shown in Tables 5 to 7, the ratio of the mass of the binder resin (SL) of each of the single-layer photosensitive members (A-23) to (A-48) and (A-50) to the mass of the corresponding single-layer photosensitive layer was no greater than 0.50. As shown in Table 14, the single-layer photosensitive members (A-23) to (A-48) and (A-50) each had a post-exposure potential of no greater than +130 V. As shown in Table 18, the ratio of the mass of the binder resin (CG) of the positively chargeable multi-layer photosensitive member (C-51) to the mass of the corresponding charge generating layer was greater than 0.50. As shown in Table 25, the positively chargeable multi-layer photosensitive member (C-51) had a post-exposure potential of greater than +130 V. As shown in Tables 16 to 18, the ratio of the mass of the binder resin (CG) of each of the positively chargeable multi-layer photosensitive members (C-23) to (C-48) and (C-50) to the mass of the corresponding charge generating layer was no greater than 0.50. As shown in Table 25, the positively chargeable multi-layer photosensitive members (C-23) to (C-48) and (C-50) each had a post-exposure potential of no greater than +130 V. Therefore, it is determined that sensitivity characteristics of the photosensitive member are improved in addition to anti-fogging property of the photosensitive member by setting the ratio of the mass of the binder resin (specifically, the binder resin (SL) or (CG)) thereof to the mass of the first photosensitive layer (specifically, the single-layer photosensitive layer or the charge generating layer) thereof to no greater than 0.50.

From the above, it was demonstrated that the photosensitive member of the present disclosure encompassing the single-layer photosensitive members (A-1) to (A-70) and the positively chargeable multi-layer photosensitive members (C-1) to (C-75) can include a favorably formed photosensitive layer and is excellent in anti-fogging property. Furthermore, the process cartridge and the image forming apparatus of the present disclosure, each of which includes a photosensitive member such as above, can form an image with less fogging on a recording medium.

What is claimed is:

1. An electrophotographic photosensitive member comprising:
a conductive substrate; and an at-least-one-layer photosensitive layer, wherein
the at-least-one-layer photosensitive layer includes a specific photosensitive layer disposed on an outermost side of the at-least-one-layer photosensitive layer,
the specific photosensitive layer contains a charge generating material, a binder resin, an electron transport material, and a hole transport material,
the binder resin includes a polyarylate resin,
the polyarylate resin includes repeating units represented by formulas (1), (2), (3), and (4),
a third percentage is greater than 0% and less than 50%, the third percentage being a percentage of the number of repeats of the repeating unit represented by the formula (3) relative to a total of the number of repeats of the repeating unit represented by the formula (1) and the number of repeats of the repeating unit represented by the formula (3),
a fourth percentage is at least 35% and less than 70%, the fourth percentage being a percentage of the number of repeats of the repeating unit represented by the formula (4) relative to a total of the number of repeats of the repeating unit represented by the formula (2) and the number of repeats of the repeating unit represented by the formula (4), and
the electron transport material includes a compound represented by formula (11), (12), (13), (14), (15), (16), or (17), 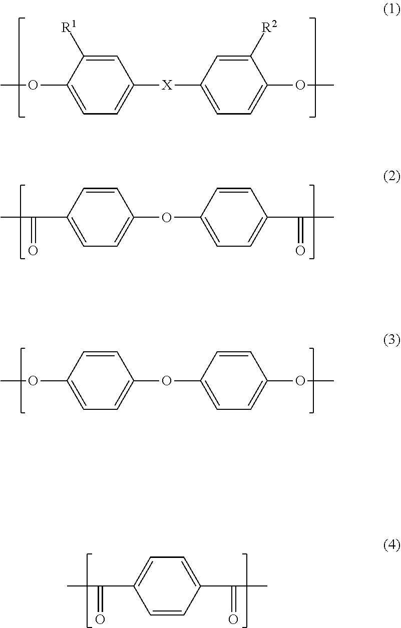
where in the formula (1),
R¹ and R² each represent a methyl group and X represents a divalent group represented by formula (X1), or
R¹ and R² each represent a hydrogen atom and X represents a divalent group represented by formula (X2), 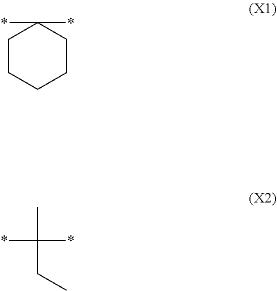
in the formulas (X1) and (X2), * represents a bond, 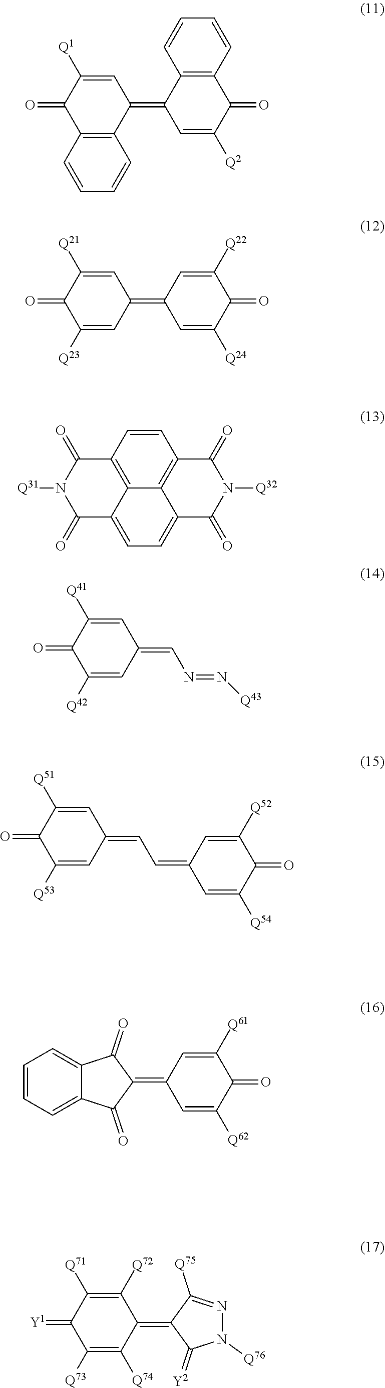
Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁵¹, Q⁵², Q⁵³, and Q⁵⁴ in the formula (15), Q⁶¹ and Q⁶² in the formula (16), and Q⁷¹, Q⁷², Q⁷³, Q⁷⁴, Q⁷⁵, and Q⁷⁶ in the formula (17) each represent, independently of one another, a hydrogen atom, a halogen atom, a cyano group, an alkyl group with a carbon number of at least 1 and no greater than 6, an alkenyl group with a carbon number of at least 2 and no greater than 6, an alkoxy group with a carbon number of at least 1 and no greater than 6, or an aryl group with a carbon number of at least 6 and no greater than 14 optionally substituted with at least one substituent selected from the group consisting of a halogen atom and an alkyl group with a carbon number of at least 1 and no greater than 6, and
in the formula (17), Y¹ and Y² each represent, independently of one another, an oxygen atom or a sulfur atom.

2. The electrophotographic photosensitive member according to claim 1, wherein
the polyarylate resin has a viscosity average molecular weight of at least 35,000 and no greater than 80,000.

3. The electrophotographic photosensitive member according to claim 1, wherein
a ratio of a mass of the binder resin to a mass of the specific photosensitive layer is at least 0.35 and no greater than 0.50.

4. The electrophotographic photosensitive member according to claim 1, wherein
the specific photosensitive layer has a scratch resistance depth of no greater than 0.50 μm.

5. The electrophotographic photosensitive member according to claim 1, wherein
the specific photosensitive layer has a strain at break of at least 7.5% and no greater than 21.0%.

6. The electrophotographic photosensitive member according to claim 1, wherein
the specific photosensitive layer has a Vickers hardness of at least 19.0 HV.

7. The electrophotographic photosensitive member according to claim 1, wherein
in the formula (1), R¹ and R² each represent a methyl group and X represents a divalent group represented by the formula (X1).

8. The electrophotographic photosensitive member according to claim 1, wherein
in the formula (1), R¹ and R² each represent a methyl group and X represents a divalent group represented by the formula (X1), and
the fourth percentage is at least 40% and less than 70%.

9. The electrophotographic photosensitive member according to claim 1, wherein
in the formula (1), R¹ and R² each represent a methyl group and X represents a divalent group represented by the formula (X1), and
the third percentage is at least 30% and less than 50%.

10. The electrophotographic photosensitive member according to claim 1, wherein
in the formula (1), R¹ and R² each represent a methyl group and X represents a divalent group represented by the formula (X1), and
the polyarylate resin further includes an end group with a halogen atom.

11. The electrophotographic photosensitive member according to claim 1, wherein
in the formula (1), R¹ and R² each represent a hydrogen atom and X represents a divalent group represented by the formula (X2), and
the fourth percentage is at least 35% and no greater than 45%.

12. The electrophotographic photosensitive member according to claim 1, wherein
a first percentage is a percentage of the number of repeats of the repeating unit represented by the formula (1) relative to the total of the number of repeats of the repeating unit represented by the formula (1) and the number of repeats of the repeating unit represented by the formula (3),
a second percentage is a percentage of the number of repeats of the repeating unit represented by the formula (2) relative to the total of the number of repeats of the repeating unit represented by the formula (2) and the number of repeats of the repeating unit represented by the formula (4),
a value of the first percentage is different from those of the second percentage and the fourth percentage, and
a value of the third percentage is different from those of the second percentage and the fourth percentage.

13. The electrophotographic photosensitive member according to claim 1, wherein
the third percentage is greater than 30% and less than 50%.

14. The electrophotographic photosensitive member according to claim 1, wherein
the polyarylate resin does not include a repeating unit represented by formula (5):

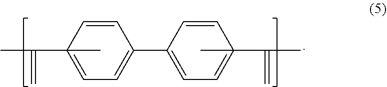

15. The electrophotographic photosensitive member according to claim 1, wherein
the electron transport material is a compound represented by formula (E-1), (E-2), (E-3), (E-4), (E-5), (E-6), (E-7), (E-8), or (E-9):

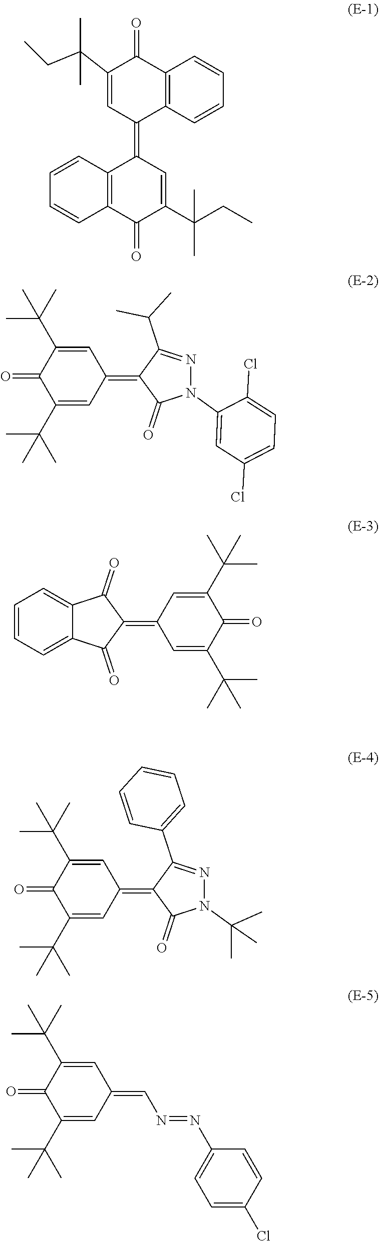

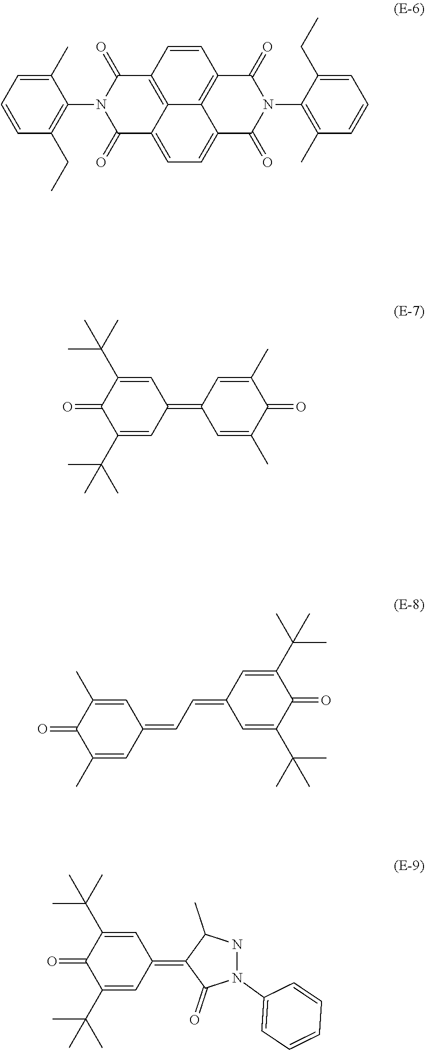 [SMILES: CCc1cccc(C)c1N1C(=O)c2ccc3c4c(ccc(c24)C1=O)C(=O)N(c1c(C)cccc1CC)C3=O ; CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O ; CC1NN(c2ccccc2)C(=O)C1=C1C=C(C(C)(C)C)C(=O)C(C(C)(C)C)=C1]

16. The electrophotographic photosensitive member according to claim 1, wherein
the hole transport material includes a compound represented by formula (20), (21), (22), (23), (24), or (25): 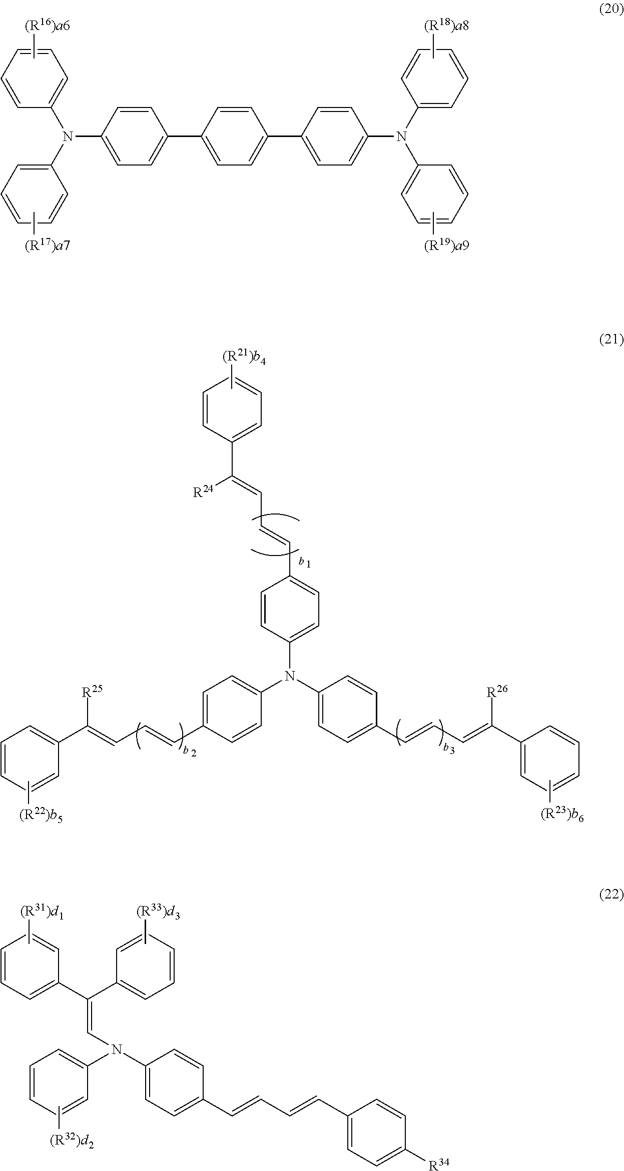 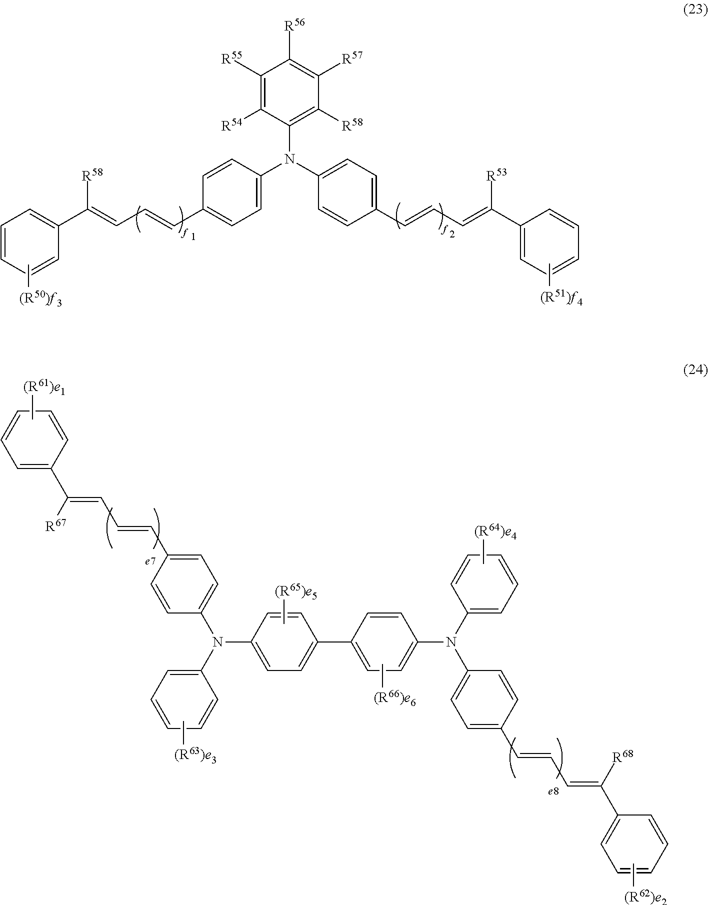 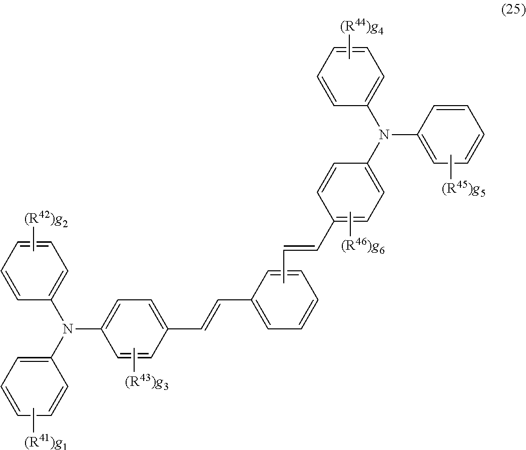
where in the formula (20), R¹⁶, R¹⁷, R¹⁸, and R¹⁹ each represent, independently of one another, an alkyl group with a carbon number of at least 1 and no greater than 6, and a6, a7, a8, and a9 each represent, independently of one another, an integer of at least 0 and no greater than 5,
in the formula (21), R²¹, R²², and R²³ each represent, independently of one another, an alkyl group with a carbon number of at least 1 and no greater than 6, R²⁴, R²⁵, and R²⁶ each represent, independently of one another, a hydrogen atom, an alkyl group with a carbon number of at least 1 and no greater than 6, or an aryl group with a carbon number of at least 6 and no greater than 14, b₁, b₂, and b₃ each represent, independently of one another, 0 or 1, and b₄, b₅, and b₆ each represent, independently of one another, an integer of at least 0 and no greater than 5,
in the formula (22), R³¹, R³², and R³³ each represent, independently of one another, an alkyl group with a carbon number of at least 1 and no greater than 6, R³⁴ represents a hydrogen atom or an alkyl group with a carbon number of at least 1 and no greater than 6, and d₁, d₂, and d₃ each represent, independently of one another, an integer of at least 0 and no greater than 5,
in the formula (23), R⁵⁰ and R⁵¹ each represent, independently of one another, a phenyl group, an alkyl group with a carbon number of at least 1 and no greater than 6, or an alkoxy group with a carbon number of at least 1 and no greater than 6, R⁵², R⁵³, R⁵⁴, R⁵⁵, R⁵⁶, R⁵⁷, and R⁵⁸ each represent, independently of one another, a hydrogen atom, an alkyl group with a carbon number of at least 1 and no greater than 6, an alkoxy group with a carbon number of at least 1 and no greater than 6, or a phenyl group optionally substituted with an alkyl group with a carbon number of at least 1 and no greater than 6, f₁ and f₂ each represent, independently of one another, an integer of at least 0 and no greater than 2, and f₃ and f₄ each represent, independently of one another, an integer of at least 0 and no greater than 5,
in the formula (24), R⁶¹, R⁶², R⁶³, R⁶⁴, R⁶⁵, and R⁶⁶ each represent, independently of one another, a phenyl group or an alkyl group with a carbon number of at least 1 and no greater than 8, R⁶⁷ and R⁶⁸ each represent, independently of one another, a hydrogen atom, a phenyl group, or an alkyl group with a carbon number of at least 1 and no greater than 8, e1, e2, e3, and e4 each represent, independently of one another, an integer of at least 0 and no greater than 5, e5 and e6 each represent, independently of one another, an integer of at least 0 and no greater than 4, and e7 and e8 each represent, independently of one another, 0 or 1, and
in the formula (25), R⁴¹, R⁴², R⁴³, R⁴⁴, R⁴⁵, and R⁴⁶ each represent, independently of one another, a phenyl group, an alkyl group with a carbon number of at least 1 and no greater than 8, or an alkoxy group with a carbon number of at least 1 and no greater than 8, g1, g2, g4, and g5 each represent, independently of one another, an integer of at least 0 and no greater than 5, and g3 and g6 each represent, independently of one another, an integer of at least 0 and no greater than 4.

17. The electrophotographic photosensitive member according to claim 16, wherein
the hole transport material includes the compound represented by the formula (20), (21), (22), (23) or (24).

18. The electrophotographic photosensitive member according to claim 1, wherein
the hole transport material includes a compound represented by formula (H-1), (H-2), (H-3), (H-4), (H-5), (H-6), (H-7), (H-8), (H-9), (H-10), or (H-11):

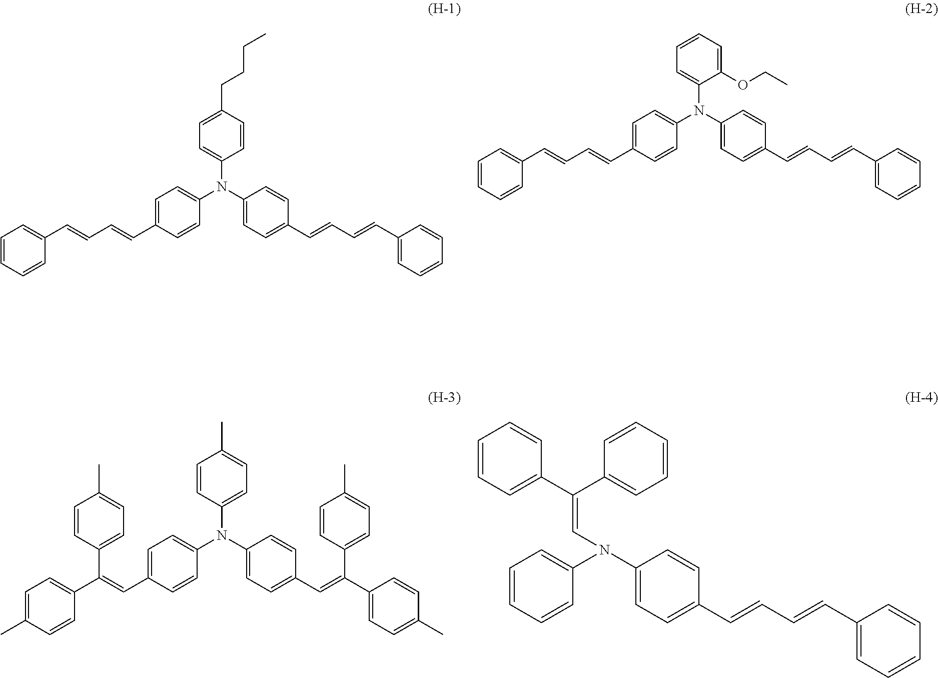

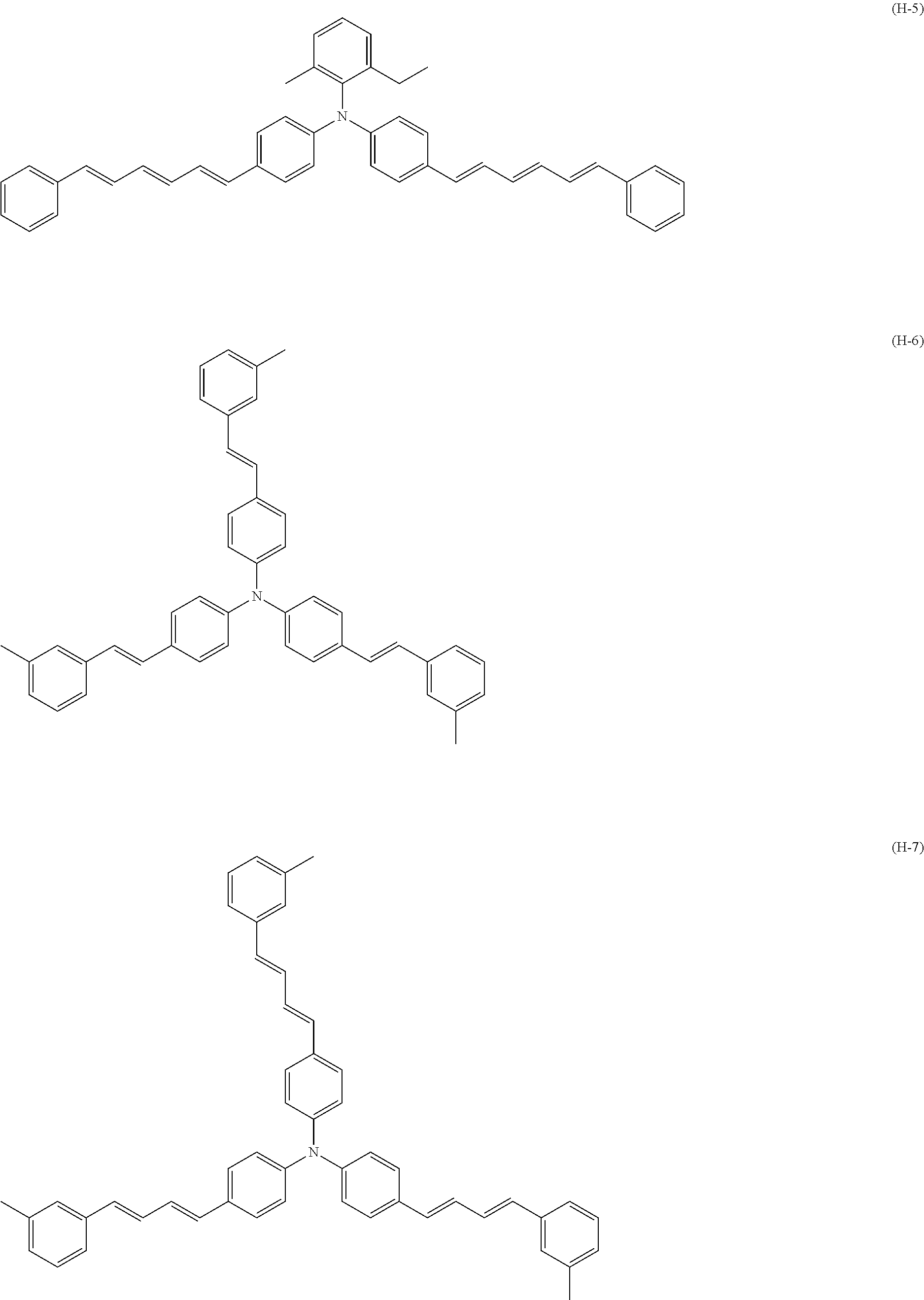 [SMILES: CCc1cccc(C)c1N(c1ccc(/C=C/C=C/C=C/c2ccccc2)cc1)c1ccc(/C=C/C=C/C=C/c2ccccc2)cc1 ; Cc1cccc(/C=C/c2ccc(N(c3ccc(/C=C/c4cccc(C)c4)cc3)c3ccc(/C=C/c4cccc(C)c4)cc3)cc2)c1 ; Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1]

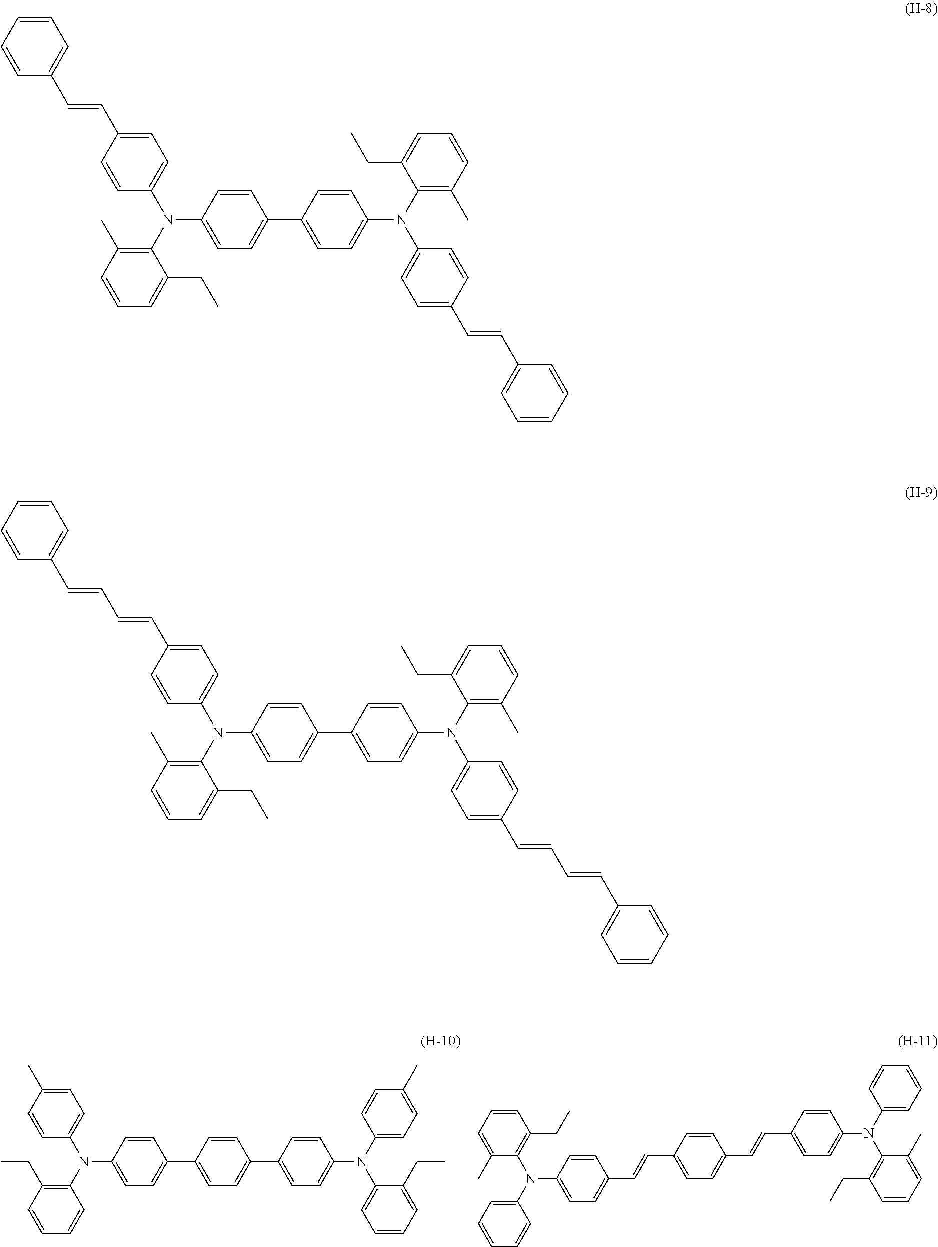

19. A process cartridge comprising:
at least one selected from the group consisting of a charger, a light exposure device, a development device, and a transfer device; and
the electrophotographic photosensitive member according to claim 1.

20. An image forming apparatus comprising:
an image bearing member;
a charger configured to charge a surface of the image bearing member to a positive polarity;
an exposure device configured to expose the charged surface of the image bearing member to light to form an electrostatic latent image on the surface of the image bearing member;
a development device configured to develop the electrostatic latent image into a toner image by supplying toner to the surface of the image bearing member; and
a transfer device configured to transfer the toner image from the image bearing member to a transfer target, wherein
the image bearing member is the electrophotographic photosensitive member according to claim 1.
